(19) United States
(12) Patent Application Publication
(10) Pub. No.: US 2008/0126812 A1
(43) Pub. Date: May 29, 2008

(54) Integrated Architecture for the Unified Processing of Visual Media

(76) Inventors: Sherjil Ahmed, Irvine, CA (US); Mohammad Usman, Mission Viejo, CA (US)

Correspondence Address: PATENTMETRIX, 14252 CULVER DR. BOX 914, IRVINE, CA, 92604, US

(21) Appl. No.: 11/813,519

(22) PCT Filed: Jan. 9, 2006
(86) PCT No.: PCT/US06/00622

§ 371 Date: Nov. 14, 2007

Related U.S. Application Data
(60) Provisional application No. 60/642,602, filed on Jan. 10, 2005.

(51) Int. Cl. H04L 9/32; G06F 9/46

(52) U.S. Cl. 713/189; 718/102

(57) ABSTRACT

The present invention is directed toward a system on chip architecture having scalable, distributed processing and memory capabilities through a plurality of processing layers. One application of the present invention is in a novel media processing device, designed to enable the processing and communication of video and graphics using a single integrated processing chip for all visual media.

### FIELD OF THE INVENTION

The present invention relates generally to a system on chip architecture and, more specifically, to a scalable system on chip architecture having distributed processing units and memory banks in a plurality of processing layers. The present invention is also directed to methods and systems for encoding and decoding audio, video, text, and graphics and devices which use such novel encoding and decoding schemes.

### BACKGROUND OF THE INVENTION

Media processing and communication devices comprise hardware and software systems that utilize interdependent processes to enable the processing and transmission of analog and digital signals substantially seamlessly across and between circuit switched and packet switched networks. As an example, a voice over packet gateway enables the transmission of human voice from a conventional public switched network to a packet switched network, possibly traveling simultaneously over a single packet network line with both fax information and modem data, and back again. Benefits of unifying communication of different media across different networks include cost savings and the delivery of new and/or improved communication services such as web-enabled call centers for improved customer support and more efficient personal productivity tools.

Such media over packet communication devices (e.g. Media Gateways) require substantial, scalable processing power with sophisticated software controls and applications to enable the effective transmission of data from circuit switched to packet switched networks and back again. Exemplary products utilize at least one communications processor, such as Texas Instrument's 48 channel digital signal processor (DSP) chip, to deploy a software architecture, such as the system provided by Telogy, which, in combination, offer features such as adaptive voice activity detection, adaptive comfort noise generation, adaptive jitter buffer, industry standard codecs, echo cancellation, tone detection and generation, network management support, and packetization.

In addition to there being benefits to the unification of communication of different media across different networks, there is a benefit to unifying the processing of certain media, such as text, graphics, and video (collectively “Visual Media”), within a given processing device. Currently, media gateways, communication devices, any form of computing device, such as a notebook computer, laptop computer, DVD player or recorder, set-top box, television, satellite receiver, desktop personal computer, digital camera, video camera, mobile phone, or personal data assistant, or any form of output peripheral, such as a display, monitor, television screen, or projector (individually referred to as a “Media Processing Device”) can only process Visual Media using separate processing systems. Separate input/output (I/O) units exist in each Media Processing Device for video and graphics/text. These separate ports require varied communication links for different data. Consequently, a single Media Processing Device may have different I/O and associated processing systems to handle graphics/text, on the one hand, and video, on the other hand.

Referring to FIG. 24, a block diagram of a portion of a conventional media processing compression/decompression system 2400 is depicted. The system at the transmission end comprises a media source present in, or integrated within a Media Processing Device 2401, plurality of preprocessing units 2402, 2403, 2404, video encoder 2405, graphics encoder 2406, audio encoder 2407, multiplexer 2408 and control unit 2409. The Media Processing Device 2401 captures the multimedia data in digitized frames (or converts it to digital form from an analog source) and passes it on to the preprocessing units 2402, 2403, 2404 where it is processed and subsequently transmitted to the video encoder 2405, graphics encoder 2406 and audio encoder 2407 for encoding. The encoders are further connected to the multiplexer 2408 with a control circuit 2409 attached to the multiplexer to enable the functionality of the multiplexer 2408. The multiplexer 2408 combines the encoded data from video 2405, graphics 2406 and audio encoder 2407 to form a single data stream 2420. This allows multiple data streams to be carried from one place to another as a single stream 2420 over a physical or a MAC layer of any appropriate network 2410.

At the receiving end, the system comprises of demultiplexer 2411, video decoder 2413, graphics decoder 2414, audio decoder 2415 and a plurality of post processing units 2416, 2417, and 2418. The data present on the network is received by the demultiplexer 2411 that resolves the high data rate streams into original lower rate streams which is converted back to the original multiple streams. The multiple streams are transmitted to different decoders i.e. video decoder 2413, graphics decoder 2414 and audio decoder 2415. The respective decoders decompresses the compressed video, graphics and audio data in accordance with appropriate decompression algorithm, and supplies them to the post processing units that prepares the data for output as video, graphics and audio or further processing.

Exemplary processors are disclosed in U.S. Pat. No. 6,226,735, 6,122,719, 6,108,760, 5,956,518, and 5,915,123. The patents are directed to a hybrid digital signal processor (DSP)/RISC chip that has an adaptive instruction set, making it possible to reconfigure the interconnect and the function of a series of basic building blocks, like multipliers and arithmetic logic units (ALUs), on a cycle-by-cycle basis. This provides an instruction set architecture that can be dynamically customized to match the particular requirements of the running applications and, therefore, create a custom path for that particular instruction for that particular cycle. According to the inventors, rather than separate the resources for instruction storage and distribution from the resources for data storage and computation, and dedicate silicon resources to each of these resources at fabrication time, these resources can be unified. Once unified, traditional instruction and control resources can be decomposed along with computing resources and can be deployed in an application specific manner. Chip capacity can be selectively deployed to dynamically support active computation or control reuse of computational resources depending on the needs of the application and the available hardware resources. This, theoretically, results in improved performance.

Despite the aforementioned prior art, an improved method and system for enabling the communication of media across different networks is needed. Specifically, it would be preferred if a single processing system could be used to process graphics, text, and video information. It would further be preferred for all Media Processing Devices to have incorporated therein this single processing approach to enable a more cost-effective and efficient processing system. Further, an approach is needed that can provide comprehensive compression decompression system using single interface. More specifically, a system on chip architecture is needed that can be efficiently scaled to meet new processing requirements and is sufficiently distributed to enable high processing throughputs and increased production yields.

### SUMMARY OF THE INVENTION

The present invention is directed toward a system on chip architecture having scalable, distributed processing and memory capabilities through a plurality of processing layers. In a preferred embodiment, a distributed processing layer processor (DPLP) comprises a plurality of processing layers each in communication with a processing layer controller and central direct memory access controller via communication data buses and processing layer interfaces. Within each processing layer, a plurality of pipelined processing units (PUs) are in communication with a plurality of program memories and data memories. Preferably, each PU should be capable of accessing at least one program memory and one data memory. The processing layer controller manages the scheduling of tasks and distribution of processing tasks to each processing layer. The DMA controller is a multi-channel DMA unit for handling the data transfers between the local memory buffer PUs and external memories, such as the SDRAM. Within each processing layer, there are a plurality of pipelined PUs specially designed for conducting a defined set of processing tasks. In that regard, the PUs are not general purpose processors and can not be used to conduct any processing task. Additionally, within each processing layer is a set of distributed memory banks that enable the local storage of instruction sets, processed information and other data required to conduct an assigned processing task.

One application of the present invention is in a media gateway that is designed to enable the communication of media across circuit switched and packet switched networks. The hardware system architecture of the said novel gateway is comprised of a plurality of DPLPs, referred to as Media Engines, that are interconnected with a Host Processor which, in turn, is in communication with interfaces to networks, preferably an asynchronous transfer mode (ATM) physical device or gigabit media independent interface (GMII) physical device. Each of the PUs within the processing layers of the Media Engines are specially designed to perform a class of media processing specific tasks, such as line echo cancellation, encoding or decoding data, or tone signaling.

A second application of the present invention is in a novel media processing device, designed to enable the processing and communication of video and graphics using a single integrated processing chip for all Visual Media. The media processor for the processing of media based upon instructions, comprising: a plurality of processing layers wherein each processing layer has at least one processing unit, at least one program memory, and at least one data memory, each of said processing unit, program memory, and data memory being in communication with one another; at least one processing unit in at least one of said processing layers designed to perform motion estimation functions on received data; at least one processing unit in at least one of said processing layers designed to perform to perform encoding or decoding functions on received data; and a task scheduler capable of receiving a plurality of tasks from a source and distributing said tasks to the processing layers.

### BRIEF DESCRIPTION OF THE DRAWINGS

These and other features and advantages of the present invention will be appreciated as they become better understood by reference to the following Detailed Description when considered in connection with the accompanying drawings, wherein:

FIG. 1 is a block diagram of an embodiment of the distributed processing layer processor;

FIG. 2a is a block diagram of a first embodiment of a hardware system architecture for a media gateway;

FIG. 2b is a block diagram of a second embodiment of a hardware system architecture for a media gateway;

FIG. 3 is a diagram of a packet having a header and user data;

FIG. 4 is a block diagram of a third embodiment of a hardware system architecture for a media gateway;

FIG. 5 is a block diagram of one logical division of the software system of the present invention;

FIG. 6 is a block diagram of a first physical implementation of the software system of FIG. 5;

FIG. 7 is a block diagram of a second physical implementation of the software system of FIG. 5;

FIG. 8 is a block diagram of a third physical implementation of the software system of FIG. 5;

FIG. 9 is a block diagram of a first embodiment of the media engine component of the hardware system of the present invention;

FIG. 10 is a block diagram of a preferred embodiment of the media engine component of the hardware system of the present invention;

FIG. 10a is a block diagram representation of a preferred architecture for the media layer component of the media engine of FIG. 10;

FIG. 11 is a block diagram representation of a first preferred processing unit;

FIG. 12 is a time-based schematic of the pipeline processing conducted by the first preferred processing unit;

FIG. 13 is a block diagram representation of a second preferred processing unit;

FIG. 13a is a time-based schematic of the pipeline processing conducted by the second preferred processing unit;

FIG. 14 is a block diagram representation of a preferred embodiment of the packet processor component of the hardware system of the present invention;

FIG. 15 is a schematic representation of one embodiment of the plurality of network interfaces in the packet processor component of the hardware system of the present invention;

FIG. 16 is a block diagram of a plurality of PCI interfaces used to facilitate control and signaling functions for the packet processor component of the hardware system of the present invention;

FIG. 17 is a first exemplary flow diagram of data communicated between components of the software system of the present invention;

FIG. 17a is a second exemplary flow diagram of data communicated between components of the software system of the present invention;

FIG. 18 is a schematic diagram of preferred components comprising the media processing subsystem of the software system of the present invention;

FIG. 19 is a schematic diagram of preferred components comprising the packetization processing subsystem of the software system of the present invention;

FIG. 20 is a schematic diagram of preferred components comprising the signaling subsystem of the software system of the present invention;

FIG. 21 is a schematic diagram of preferred components comprising the signaling processing subsystem of the software system of the present invention;

FIG. 22 is a block diagram of a host application operative on a physical DSP;

FIG. 23 is a block diagram of a host application operative on a virtual DSP;

FIG. 24 is a block diagram of a conventional media processing system;

FIG. 25 is a block diagram of a media processing system of the present invention;

FIG. 26 is a block diagram of an exemplary integrated chip architecture applicable for the unified processing of video, text, and graphic data;

FIG. 27 is a block diagram depicting exemplary inputs and outputs of a novel device of the present invention;

FIG. 28 is a block diagram of a prior art depiction of a pixel surrounded by other pixels;

FIGS. 29a, 29b, and 29c depict a novel process of performing error concealment.

FIG. 30 is a block diagram of an embodiment of the media processor of the present invention;

FIG. 31 is a block diagram of another embodiment of the media processor of the present invention;

FIG. 32 is a block diagram of another embodiment of the media processor of the present invention;

FIG. 33 is a flowchart depicting one embodiment of a plurality of states achieved during the compression of video in an exemplary chip architecture;

FIG. 34 is a block diagram of one embodiment of the LZQ algorithm;

FIG. 35 is a block diagram of a key frame difference encoder of one embodiment of the LZQ algorithm;

FIG. 36 is a block diagram of a key frame difference decoder block of one embodiment of the present invention;

FIG. 37 is a block diagram of a modified LZQ algorithm

FIG. 38 is a block diagram of a key line difference block used in an exemplary embodiment of the invention;

FIG. 39 is a block diagram of one embodiment of the compression/decompression architecture of the present invention;

FIG. 40 is a block diagram of one embodiment of the video processor of the present invention;

FIG. 41 is a block diagram of one embodiment of the motion estimation processor of the present invention;

FIG. 42 is a diagram of one embodiment of an array of processing elements of the abovementioned motion estimation processor;

FIG. 43 is a block diagram of one embodiment of the DCT/IDCT processor of the present invention;

FIG. 44 is a block diagram of one embodiment of the post processor of the present invention; and

FIG. 45 is a block diagram of one embodiment of the software stack of the present invention.

### DETAILED DESCRIPTION OF THE INVENTION

The present invention is a system on chip architecture having scalable, distributed processing and memory capabilities through a plurality of processing layers. One embodiment of the present invention is a novel Media Processing Device, designed to enable the processing and communication of media using a single integrated processing unity for all Visual Media. The present invention will presently be described with reference to the aforementioned drawings. Headers will be used for purposes of clarity and are not meant to limit or otherwise restrict the disclosures made herein. Where arrows are utilized in the drawings, it would be appreciated by one of ordinary skill in the art that the arrows represent the interconnection of elements and/or components via buses or any other type of communication channel.

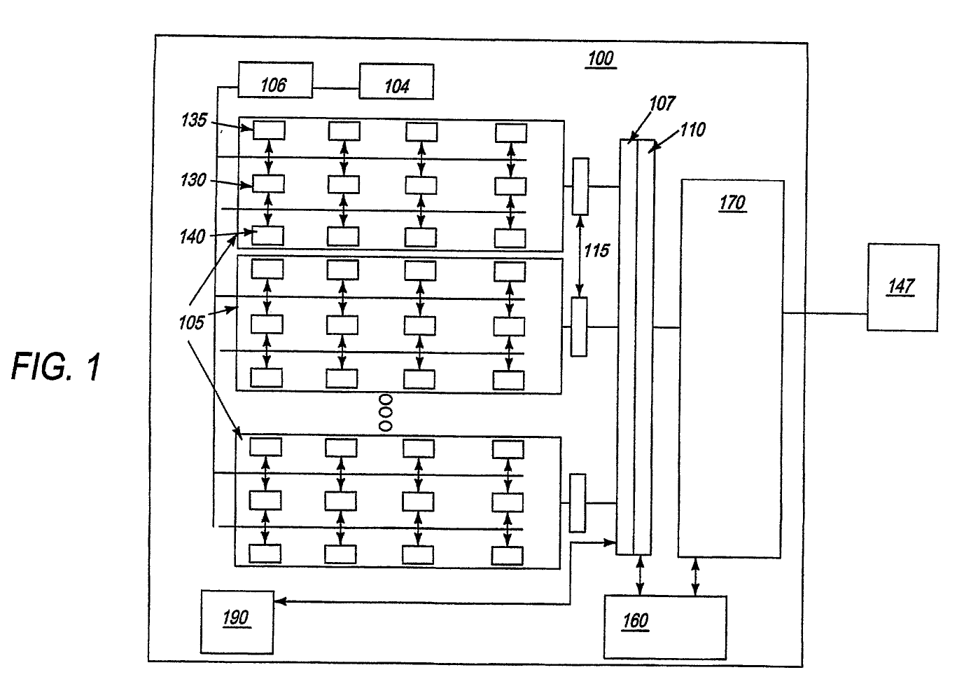

Referring to FIG. 1, a block diagram of an exemplary distributed processing layer processor (DPLP) 100 is shown. The DPLP 100 comprises a plurality of processing layers 105 each in communication with each other via communication data buses and in communication with a processing layer controller 107 and central direct memory access (DMA) controller 110 via communication data buses and processing layer interfaces 115. Each processing layer 105 is in communication with a CPU interface 106 which, in turn, is in communication with a CPU 104. Within each processing layer 105, a plurality of pipelined processing units (PUs) 130 are in communication with a plurality of program memories 135 and data memories 140, via communication data buses. Preferably, each program memory 135 and data memory 140 can be accessed by at least one PU 130 via data buses. Each of the PUs 130, program memories 135, and data memories 140 is in communication with an external memory 147 via communication data buses.

In a preferred embodiment, the processing layer controller 107 manages the scheduling of tasks and distribution of processing tasks to each processing layer 105. The processing layer controller 107 arbitrates data and program code transfer requests to and from the program memories 135 and data memories 140 in a round robin fashion. On the basis of this arbitration, the processing layer controller 107 fills the data pathways that define how units directly access memory, namely the DMA channels [not shown]. The processing layer controller 107 is capable of performing instruction decoding to route an instruction according to its dataflow and keep track of the request states for all PUs 130, such as the state of a read-in request, a write-back request and an instruction forwarding. The processing layer controller 107 is further capable of conducting interface related functions, such as programming DMA channels, starting signal generation, maintaining page states for PUs 130 in each processing layer 105, decoding of scheduler instructions, and managing the movement of data from and into the task queues of each PU 130. By performing the aforementioned functions, the processing layer controller 107 substantially eliminates the need for associating complex state machines with the PUs 130 present in each processing layer 105.

The DMA controller 110 is a multi-channel DMA unit for handling the data transfers between the local memory buffer PUs and external memories, such as the SDRAM. Each processing layer 105 has independent DMA channels allocated for transferring data to and from the PU local memory buffers. Preferably, there is an arbitration process, such as a single level of round robin arbitration, between the channels within the DMA to access the external memory. The DMA controller 110 provides hardware support for round robin request arbitration across the PUs 130 and processing layers 105. Each DMA channel functions independently of one another. In an exemplary operation, it is preferred to conduct transfers between local PU memories and external memories by utilizing the address of the local memory, address of the external memory, size of the transfer, direction of the transfer, namely whether the DMA channel is transferring data to the local memory from the external memory or vice-versa, and how many transfers are required for each PU 130. The DMA controller 110 is preferably further capable of arbitrating priority for program code fetch requests, conducting link list traversal and DMA channel information generation, and performing DMA channel prefetch and done signal generation.

The processing layer controller 107 and DMA controller 110 are in communication with a plurality of communication interfaces 160, 190 through which control information and data transmission occurs. Preferably the DPLP 100 includes an external memory interface (such as a SDRAM interface) 170 that is in communication with the processing layer controller 107 and DMA controller 110 and is in communication with an external memory 147.

Within each processing layer 105, there are a plurality of pipelined PUs 130 specially designed for conducting a defined set of processing tasks. In that regard, the PUs are not general purpose processors and can not be used to conduct any processing task. A survey and analysis of specific processing tasks yielded certain functional unit commonalities that, when combined, yield a specialized PU capable of optimally processing the universe of those specialized processing tasks. The instruction set architecture of each PU yields compact code. Increased code density results in a decrease in required memory and, consequently, a decrease in required area, power, and memory traffic.

It is preferred that, within each processing layer, the PUs 130 operate on tasks scheduled by the processing layer controller 107 through a first-in, first-out (FIFO) task queue [not shown]. The pipeline architecture improves performance. Pipelining is an implementation technique whereby multiple instructions are overlapped in execution. In a computer pipeline, each step in the pipeline completes a part of an instruction. Like an assembly line, different steps are completing different parts of different instructions in parallel. Each of these steps is called a pipe stage or a data segment. The stages are connected on to the next to form a pipe. Within a processor, instructions enter the pipe at one end, progress through the stages, and exit at the other end. The throughput of an instruction pipeline is determined by how often an instruction exits the pipeline.

Additionally, within each processing layer 105 is a set of distributed memory banks 140 that enable the local storage of instruction sets, processed information and other data required to conduct an assigned processing task. By having memories 140 distributed within discrete processing layers 105, the DPLP 100 remains flexible and, in production, delivers high yields. Conventionally, certain DSP chips are not produced with more than 9 megabytes of memory on a single chip because as memory blocks increase, the probability of bad wafers (due to corrupted memory blocks) also increases. In the present invention, the DPLP 100 can be produced with 12 megabytes or more of memory by incorporating redundant processing layers 105. The ability to incorporate redundant processing layers 105 enables the production of chips with larger amounts of memory because, if a set of memory blocks are bad, rather than throw the entire chip away, the discrete processing layers within which the corrupted memory units are found can be set aside and the other processing layers may be used instead. The scalable nature of the multiple processing layers allows for redundancy and, consequently, higher production yields.

While the layered architecture of the present invention is not limited to a specific number of processing layers, certain practical limitations may restrict the number of processing layers that can be incorporated into a single DPLP. One of ordinary skill in the art would appreciate how to determine the processing limitations imposed by external conditions, such as traffic and bandwidth constraints on the system, that restrict the feasible number of processing layers.

### Exemplary Application

The present invention can be used to enable the operation of a novel media gateway. The hardware system architecture of the said novel gateway is comprised of a plurality of DPLPs, referred to as Media Engines, that are in communication with a data bus and interconnected with a Host Processor or a Packet Engine which, in turn, is in communication with interfaces to networks, preferably an asynchronous transfer mode (ATM) physical device or gigabit media independent interface (GMII) physical device.

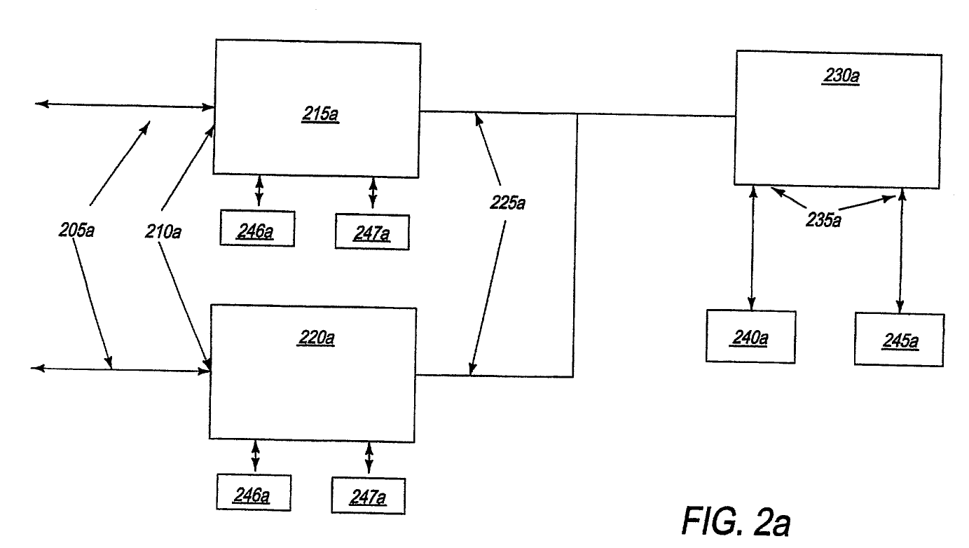

Referring to FIG. 2a, a first embodiment of the top-level hardware system architecture is shown. A data bus 205a is connected to interfaces 210a existent on a first novel Media Engine Type I 215a and on a second novel Media Engine Type I 220a. The first novel Media Engine Type I 215a and second novel Media Engine Type I 220a are connected through a second set of communication buses 225a to a novel Packet Engine 230a which, in turn, is connected through interfaces 235a to outputs 240a, 245a. Preferably, each of the Media Engines Type I 215a, 220a is in communication with a SRAM 246a and SDRAM 247a.

It is preferred that the data bus 205a be a time-division multiplex (TDM) bus. A TDM bus is a pathway for the transmission of a number of separate voice, fax, modem, video, and/or other data signals simultaneously over a single communication medium. The separate signals are transmitted by interleaving a portion of each signal with each other, thereby enabling one communications channel to handle multiple separate transmissions and avoiding having to dedicate a separate communication channel to each transmission. Existing networks use TDM to transmit data from one communication device to another. It is further preferred that the interfaces 210a existent on the first novel Media Engine Type I 215a and second novel Media Engine Type I 220a comply with H.100, a hardware specification that details the necessary information to implement a CT bus interface at the physical layer for the PCI computer chassis card slot, independent of software specifications. The CT bus defines a single isochronous communications bus across certain PC chassis card slots and allows for the relatively fluid inter-operation of components. It is appreciated that interfaces abiding by different hardware specifications could be used to receive signals from the data bus 205a.

As described below, each of the two novel Media Engines Type I 215a, 220a can support a plurality of channels for processing media, such as voice. The specific number of channels supported is dependent upon the features required, such as the extent of echo cancellation, and type of codec supported. For codecs having relatively low processing power requirements, such as G.711, each Media Engine Type I 215a, 220a can support the processing of around 256 voice channels or more. Each Media Engine Type I 215a, 220a is in communication with the Packet Engine 230a through a communication bus 225a, preferably a peripheral component interconnect (PCI) communication bus. A PCI communication bus serves to deliver control information and data transfers between the Media Engine Type I chip 215a, 220a and the Packet Engine chip_230a. Because Media Engine Type I 215a, 220a was designed to support the processing of lower data volumes, relative to Media Engine Type II described below, a single PCI communication bus can effectively support the transfer of both control and data between the designated chips. It is appreciated, however, that where data traffic becomes too great, the PCI communication bus must be supplemented with a second inter-chip communication bus.

The Packet Engine 230a receives processed data from each of the two Media Engines Type I 215a, 220a via the communication bus 225a. While theoretically able to connect to a plurality of Media Engines Type I, it is preferred that, for this embodiment, the Packet Engine 230a be in communication with up to two Media Engines Type I 215a, 220a. As will be further described below, the Packet Engine 230a provides cell and packet encapsulation for data channels, at or around 2016 channels in a preferred embodiment, quality of service functions for traffic management, tagging for differentiated services and multi-protocol label switching, and the ability to bridge cell and packet networks. While it is preferred to use the Packet Engine 230a, it can be replaced with a different host processor, provided that the host processor is capable of performing the above-described functions of the Packet Engine 230a.

The Packet Engine 230a is in communication with an ATM physical device 240a and GMII physical device 245a. The ATM physical device 240a is capable of receiving processed and packetized data, as passed from the Media Engines Type I 215a, 220a through the Packet Engine 230a, and transmitting it through a network operating on an asynchronous transfer mode (an ATM network). As would be appreciated by one of ordinary skill in the art, an ATM network automatically adjusts the network capacity to meet the system needs and can handle voice, modem, fax, video and other data signals. Each ATM data cell, or packet, consists of five octets of header field plus 48 octets for user data. The header contains data that identifies the related cell, a logical address that identifies the routing, header error correction bits, plus bits for priority handling and network management functions. An ATM network is a wideband, low delay, connection-oriented, packet-like switching and multiplexing network that allows for relatively flexible use of the transmission bandwidth. The GMII physical device 245a operates under a standard for the receipt and transmission of a certain amount of data, irrespective of the media types involved.

The embodiment shown in FIG. 2a can deliver voice processing up to Optical Carrier Level 1 (OC-1). OC-1 is designated at 51.840 million bits per second and provides for the direct electrical-to-optical mapping of the synchronous transport signal (STS-1) with frame synchronous scrambling. Higher optical carrier levels are direct multiples of OC-1, namely OC-3 is three times the rate of OC-1. As shown below, other configurations of the present invention could be used to support voice processing at OC-12.

Referring now to FIG. 2b, an embodiment supporting data rates up to OC-3 is shown, referred to herein as an OC-3 Tile 200b. A data bus 205b is connected to interfaces 210b existent on a first novel Media Engine Type II 215b and on a second novel Media Engine Type II 220b. The first novel Media Engine Type II 215b and second novel Media Engine Type II 220b are connected through a second set of communication buses 225b, 227b to a novel Packet Engine 230b which, in turn, is connected through interfaces 260b, 265b to outputs 240b, 245b and through interface 250b to a Host Processor 255b.

As previously discussed, it is preferred that the data bus 205b be a time-division multiplex (TDM) bus and that the interfaces 210b existent on the first novel Media Engine Type II 215b and second novel Media Engine Type II 220b comply with the H.100 a hardware specification. It is again appreciated that interfaces abiding by different hardware specifications could be used to receive signals from the data bus 205b.

Each of the two novel Media Engines Type II 215b, 220b can support a plurality of channels for processing media, such as voice. The specific number of channels supported is dependent upon the features required, such as the extent of echo cancellation, and type of codec implemented. For codecs having relatively low processing power requirements, such as G.711, and where the extent of echo cancellation required is 128 milliseconds, each Media Engine Type II can support the processing of approximately 2016 channels of voice. With two Media Engines Type II providing the processing power, this configuration is capable of supporting data rates of OC-3. Where the Media Engines Type II 215b, 220b are implementing a codec requiring higher processing power, such as G.729A, the number of supported channels decreases. As an example, the number of supported channels decreases from 2016 per Media Engine Type II when supporting G.711 to approximately 672 to 1024 channels when supporting G.729A. To match OC-3, an additional Media Engine Type II can be connected to the Packet Engine 230b via the common communication buses 225b, 227b.

Each Media Engine Type II 215b, 220b is in communication with the Packet Engine 230b through communication buses 225b, 227b, preferably a peripheral component interconnect (PCI) communication bus 225b and a UTOPIA II/POS II communication bus 227b. As previously mentioned, where data traffic volumes exceed a certain threshold, the PCI communication bus 225b must be supplemented with a second communication bus 227b. Preferably, the second communication bus 227b is a UTOPIA II/POS-II bus and serves as the data path between Media Engines Type II 215b, 220b and the Packet Engine 230b. A POS (Packet over SONET) bus represents a high-speed means for transmitting data through a direct connection, allowing the passing of data in its native format without the addition of any significant level of overhead in the form of signaling and control information. UTOPIA (Universal Test and Operations Interface for ATM) refers to an electrical interface between the transmission convergence and physical medium dependent sublayers of the physical layer and acts as the interface for devices connecting to an ATM network.

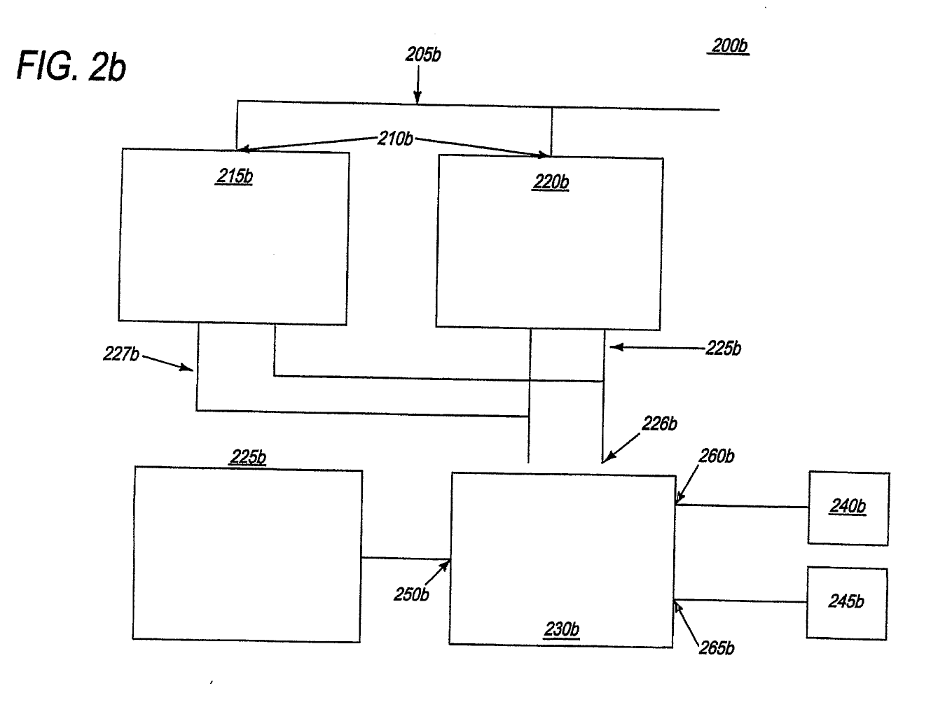

The physical interface is configured to operate in POS-II mode which allows for variable size data frame transfers. Each packet is transferred using POS-II control signals to explicitly define the start and end of a packet. As shown in FIG. 3, each packet 300 contains a header 305 with a plurality of information fields and user data 310. Preferably, each header 305 contains information fields including packet type 315 (e.g., RTP, raw encoded voice, AAL2), packet length 320 (total length of the packet including information fields), and channel identification 325 (identifies the physical channel, namely the TDM slot for which the packet is intended or from which the packet came). When dealing with encoded data transfers between a Media Engine Type II 215b, 220b and Packet Engine 230b, it is further preferred to include coder/decoder type 330, sequence number 335, and voice activity detection decision 340 in the header 305.

The Packet Engine 230b is in communication with the Host Processor 255b through a PCI target interface 250b. The Packet Engine 230b preferably includes a PCI to PCI bridge [not shown] between the PCI interface 226b to the PCI communication bus 225b and the PCI target interface 250b. The PCI to PCI bridge serves as a link for communicating messages between the Host Processor 255b and two Media Engines Type II 215b, 220b.

The novel Packet Engine 230b receives processed data from each of the two Media Engines Type II 215b, 220b via the communication buses 225b, 227b. While theoretically able to connect to a plurality of Media Engines Type II, it is preferred that the Packet Engine 230b be in communication with no more than three Media Engines Type II 215b, 220b [only two are shown in FIG. 2b]. As with the previously described embodiment, Packet Engine 230b provides cell and packet encapsulation for data channels, up to 2048 channels when implementing a G.711 codec, quality of service functions for traffic management, tagging for differentiated services and multi-protocol label switching, and the ability to bridge cell and packet networks. The Packet Engine 230b is in communication with an ATM physical device 240b and GMII physical device 245b through a UTOPIA II/POS II compatible interface 260b and GMII compatible interface respectively 265b. In addition to the GMII interface 265b in the physical layer, referred to herein as the PHY GMII interface, the Packet Engine 230b also preferably has another GMII interface [not shown] in the MAC layer of the network, referred to herein as the MAC GMII interface. MAC is a media specific access control protocol defining the lower half of the data link layer that defines topology dependent access control protocols for industry standard local area network specifications.

As will be further discussed, the Packet Engine 230b is designed to enable ATM-IP internetworking. Telecommunication service providers have built independent networks operating on an ATM or IP protocol basis. Enabling ATM-IP internetworking permits service providers to support the delivery of substantially all digital services across a single networking infrastructure, thereby reducing the complexities introduced by having multiple technologies/protocols operative throughout a service provider's entire network. The Packet Engine 230b is therefore designed to enable a common network infrastructure by providing for the internetworking between ATM modes and IP modes.

More specifically, the novel Packet Engine 230b supports the internetworking of ATM AALs (ATM Adaptation Layers) to specific IP protocols. Divided into a convergence sublayer and segmentation/reassembly sublayer, AAL accomplishes conversion from the higher layer, native data format and service specifications into the ATM layer. From the data originating source, the process includes segmentation of the original and larger set of data into the size and format of an ATM cell, which comprises 48 octets of data payload and 5 octets of overhead. On the receiving side, the AAL accomplishes reassembly of the data. AAL-1 functions in support of Class A traffic which is connection-oriented Constant Bit Rate (CBR), time-dependent traffic, such as uncompressed, digitized voice and video, and which is stream-oriented and relatively intolerant of delay. AAL-2 functions in support of Class B traffic which is connection-oriented Variable Bit Rate (VBR) isochronous traffic requiring relatively precise timing between source and sink, such as compressed voice and video. AAL-5 functions in support of Class C traffic which is Variable Bit Rate (VBR) delay-tolerant connection-oriented data traffic requiring relatively minimal sequencing or error detection support, such as signaling and control data.

These ATM AALs are internetworked with protocols operative in an IP network, such as RTP, UDP, TCP and IP. Internet Protocol (IP) describes software that tracks the Internet's addresses for different nodes, routes outgoing messages, and recognizes incoming messages while allowing a data packet to traverse multiple networks from source to destination. Realtime Transport Protocol (RTP) is a standard for streaming realtime multimedia over IP in packets and supports transport of real-time data like, such as interactive video and video over packet switched networks. Transmission Control Protocol (TCP) is a transport layer, connection oriented, end-to-end protocol that provides relatively reliable, sequenced, and unduplicated delivery of bytes to a remote or a local user. User Datagram Protocol (UDP) provides for the exchange of datagrams without acknowledgements or guaranteed delivery and is a transport layer, connectionless mode protocol. In the preferred embodiment represented in FIG. 2b, it is preferred that ATM AAL-1 be internetworked with RTP, UDP, and IP protocols, AAL-2 be internetworked with UDP and IP protocols, and AAL-5 be internetworked with UDP and IP protocols or TCP and IP protocols.

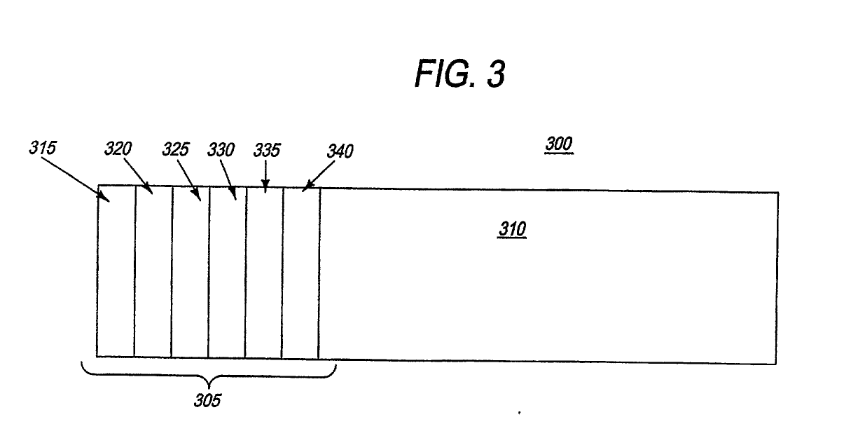

Multiple OC-3 tiles, as presented in FIG. 2b, can be interconnected to form a tile supporting higher data rates. As shown in FIG. 4, four OC-3 tiles 405 can be interconnected, or “daisy chained”, together to form an OC-12 tile 400. Daisy chaining is a method of connecting devices in a series such that signals are passed through the chain from one device to the next. By enabling daisy chaining, the present invention provides for currently unavailable levels of scalability in data volume support and hardware implementation. A Host Processor 455 is connected via communication buses 425, preferably PCI communication buses, to the PCI interface 435 on each of the OC-3 tiles 405. Each OC-3 tile 405 has a TDM interface 460 that operates via a TDM communication bus 465 to receive TDM signals via a TDM interface [not shown]. Each OC-3 tile 405 is further in communication with an ATM physical device 490 through a communication bus 495 connected to the OC-3 tile 405 through a UTOPIA II/POS II interface 470. Data received by an OC-3 tile 405 and not processed, because, for example, the data packet is directed toward a specific packet engine address that was not found in that specific OC-3 tile 405, is sent to the next OC-3 tile 405 in the series via the PHY GMII interface 410 and received by the next OC-3 tile via the MAC GMII interface 413. Enabling daisy chaining eliminates the need for an external aggregator to interface the GMII interfaces on each of the OC-3 tiles in order to enable integration. The final OC-3 tile 405 is in communication with a GMII physical device 417 via the PHY GMII interface 410.

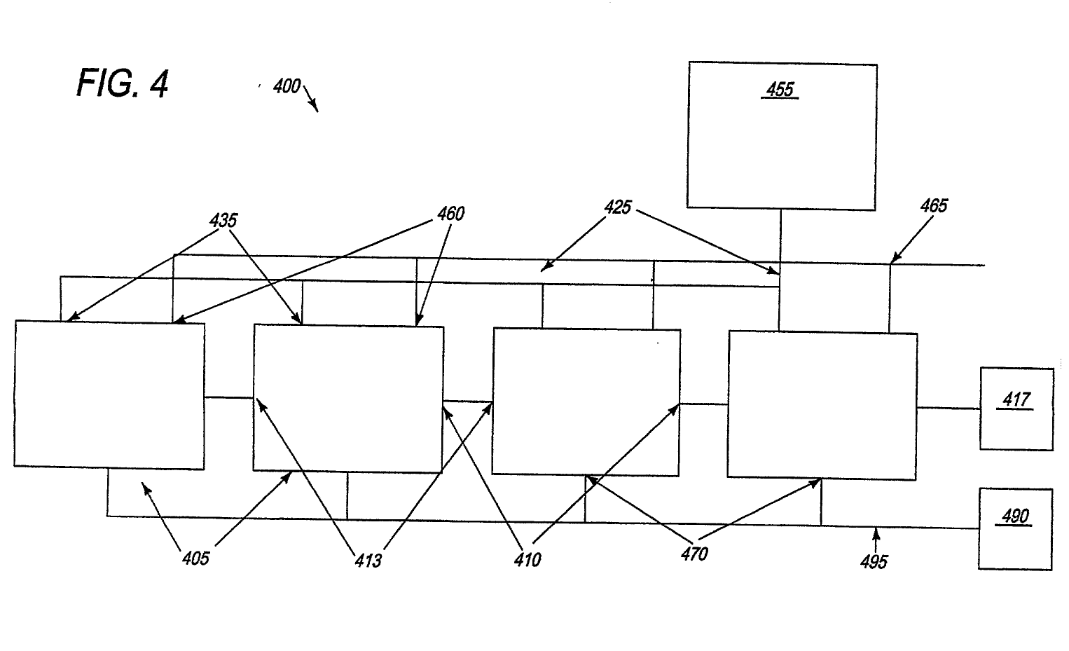

Operating on the above-described hardware architecture embodiments is a plurality of novel, integrated software systems designed to enable media processing, signaling, and packet processing. Referring now to FIG. 5, a logical division of the software system 500 is shown. The software system 500 is divided into three subsystems, a Media Processing Subsystem 505, a Packetization Subsystem 540, and a Signaling/Management Subsystem 570. Each subsystem 505, 540, 570 further comprises a series of modules 520 designed to perform different tasks in order to effectuate the processing and transmission of media. It is preferred that the modules 520 be designed in order to encompass a single core task that is substantially non-divisible. For example, exemplary modules include echo cancellation, codec implementation, scheduling, IP-based packetization, and ATM-based packetization, among others. The nature and functionality of the modules 520 deployed in the present invention will be further described below.

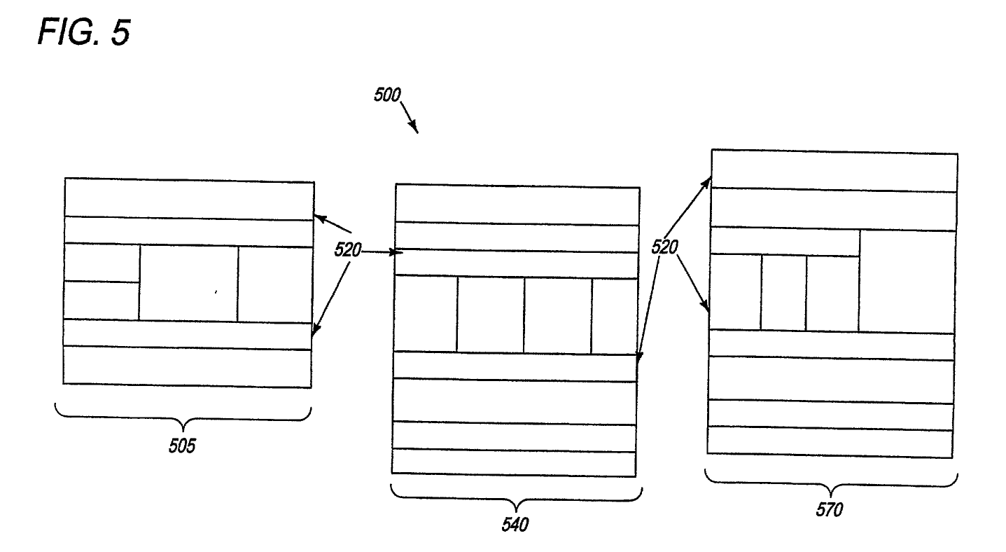

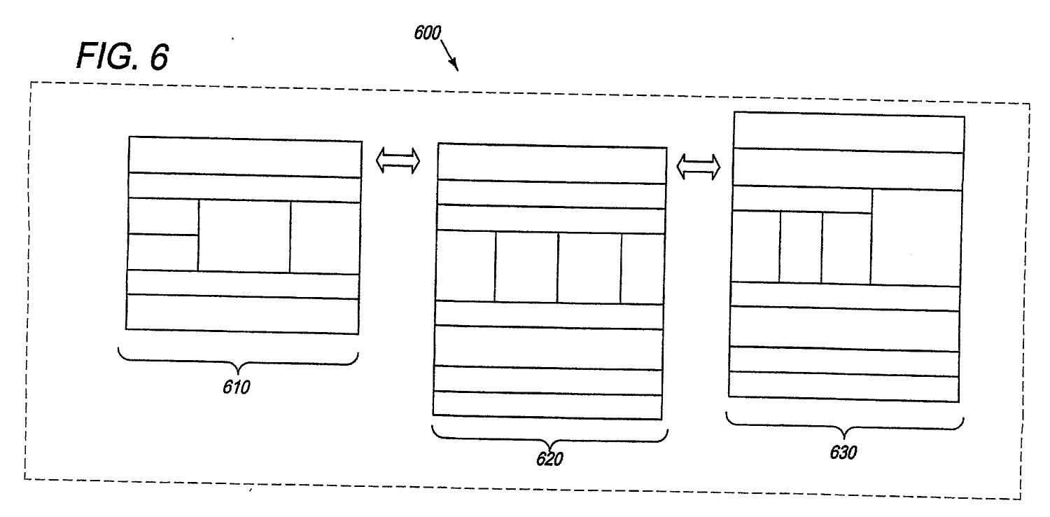

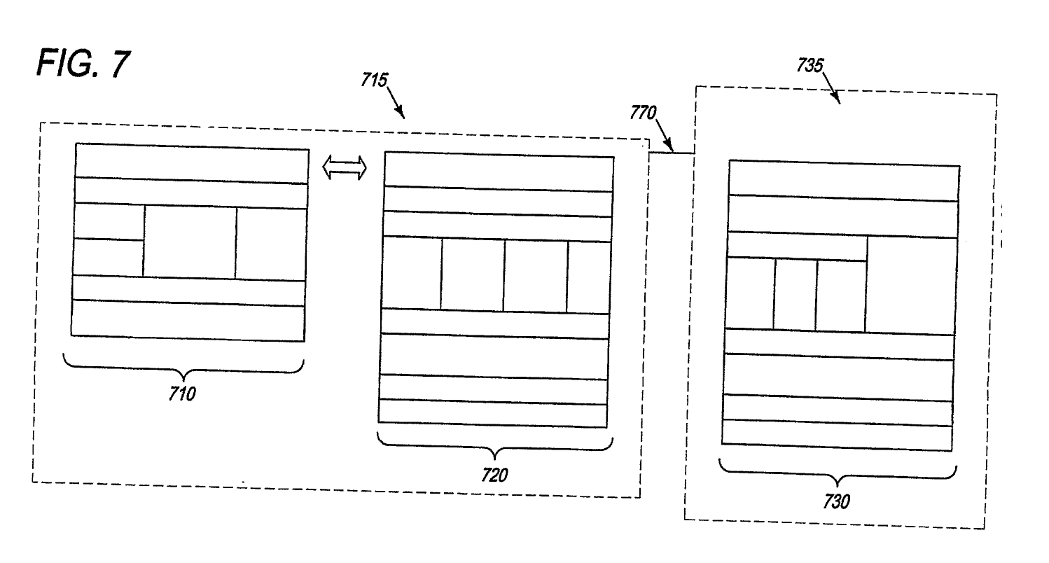

The logical system of FIG. 5 can be physically deployed in a number of ways, depending on processing needs, due, in part, to the novel software architecture, to be described below. As shown in FIG. 6, one physical embodiment of the software system described in FIG. 5 is to be on a single chip 600, where the media processing block 610, packetization block 620, and management block 630 are all operative on the same chip. If processing needs increase, thereby requiring more chip power be dedicated to media processing, the software system can be physically implemented such that the media processing block 710 and packetization block 720 operate on a DSP 715 that is in communication via a data bus 770 with the management block 730 that operates on a separate host processor 735, as depicted in FIG. 7. Similarly, if processing needs further increase, the media processing block 810 and packetization block 820 can be implemented on separate DSPs 860, 865 and communicate via data buses 870 with each other and with the management block 830 that operates on a separate host processor 835, as depicted in FIG. 8. Within each block, the modules can be physically separated onto different processors to enable for a high degree of system scalability.

In a preferred embodiment, four OC-3 tiles are combined onto a single integrated circuit (IC) card wherein each OC-3 tile is configured to perform media processing and packetization tasks. The IC card has four OC-3 tiles in communication via databuses. As previously described, the OC-3 tiles each have three Media Engine II processors in communication via interchip communication buses with a Packet Engine processor. The Packet Engine processor has a MAC and PHY interface by which communications external to the OC-3 tiles are performed. The PHY interface of the first OC-3 tile is in communication with the MAC interface of the second OC-3 tile. Similarly, the PHY interface of the second OC-3 tile is in communication with the MAC interface of the third OC-3 tile and the PHY interface of the third OC-3 tile is in communication with the MAC interface of the fourth OC-3 tile. The MAC interface of the first OC-3 tile is in communication with the PHY interface of a host processor. Operationally, each Media Engine II processor implements the Media Processing Subsystem of the present invention, shown in FIG. 5 as 505. Each Packet Engine processor implements the Packetization Subsystem of the present invention, shown in FIG. 5 as 540. The host processor implements the Management Subsystem, shown in FIG. 5 as 570.

The primary components of the top-level hardware system architecture will now be described in further detail, including Media Engine Type I, Media Engine Type II, and Packet Engine. Additionally, the software architecture, along with specific features, will be further described in detail.

Media Engines

Both Media Engine I and Media Engine II are types of DPLPs and therefore comprise a layered architecture wherein each layer encodes and decodes up to N channels of voice, fax, modem, or other data depending on the layer configuration. Each layer implements a set of pipelined processing units specially designed through substantially optimal hardware and software partitioning to perform specific media processing functions. The processing units are special-purpose digital signal processors that are each optimized to perform a particular signal processing function or a class of functions. By creating processing units that are capable of performing a well-defined class of functions, such as echo cancellation or codec implementation, and placing them in a pipeline structure, the present invention provides a media processing system and method with substantially greater performance than conventional approaches.

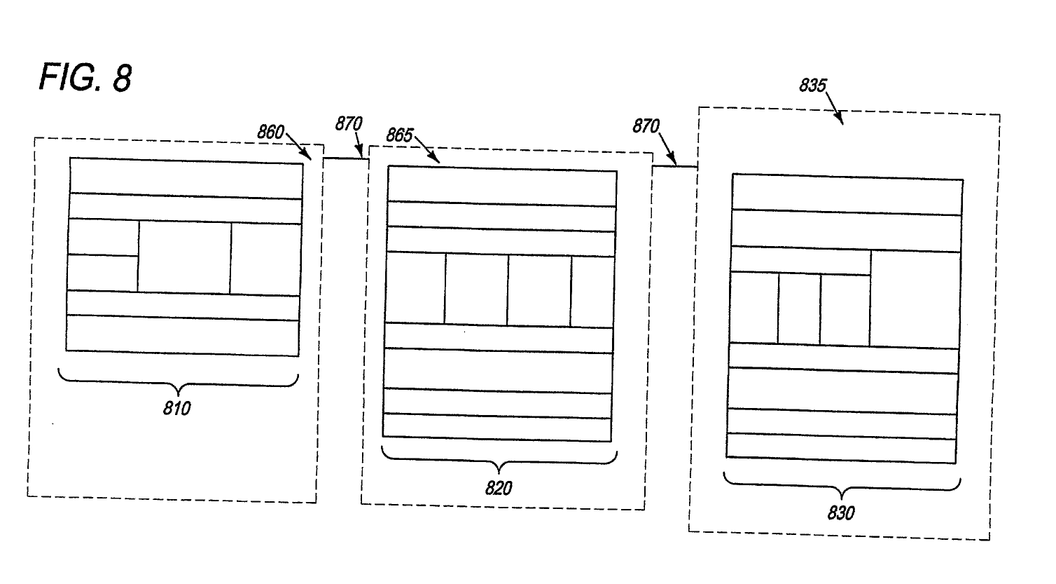

Referring to FIG. 9, a diagram of Media Engine I 900 is shown. Media Engine I 900 comprises a plurality of Media Layers 905 each in communication with a central direct memory access (DMA) controller 910 via communication data buses 920. Using a DMA approach enables the bypassing of a system processing unit to handle the transfer of data between itself and system memory directly. Each Media Layer 905 further comprises an interface to the DMA 925 interconnected with the communication data buses 920. In turn, the DMA interface 925 is in communication with each of a plurality of pipelined processing units (PUs) 930 via communication data buses 920 and a plurality of program and data memories 940, via communication data buses 920, that are situated between the DMA interface 925 and each of the PUs 930. The program and data memories 940 are also in communication with each of the PUs 930 via data buses 920. Preferably, each PU 930 can access at least one program memory and at least one data memory unit 940. Further, it is also preferred to have at least one first-in, first-out (FIFO) task queue [not shown] to receive scheduled tasks and queue them for operation by the PUs 930.

While the layered architecture of the present invention is not limited to a specific number of Media Layers, certain practical limitations may restrict the number of Media Layers that can be stacked into a single Media Engine I. As the number of Media Layers increase, the memory and device input/output bandwidth may increase to such an extent that the memory requirements, pin count, density, and power consumption are adversely affected and become incompatible with application or economic requirements. Those practical limitations, however, do not represent restrictions on the scope and substance of the present invention.

Media Layers 905 are in communication with an interface to the central processing unit 950 (CPU IF) through communication buses 920. The CPU IF 950 transmits and receives control signals and data from an external scheduler 955, the DMA controller 910, a PCI interface (PCI IF) 960, a SRAM interface (SRAM IF) 975, and an interface to an external memory, such as an SDRAM interface (SDRAM IF) 970 through communication buses 920. The PCI IF 960 is preferably used for control signals. The SDRAM IF 970 connects to a synchronized dynamic random access memory module whereby the memory access cycles are synchronized with the CPU clock in order to eliminate wait time associated with memory fetching between random access memory (RAM) and the CPU. In a preferred embodiment, the SDRAM IF 970 that connects the processor with the SDRAM supports 133 MHz synchronous DRAM and asynchronous memory. It supports one bank of SDRAM (64 Mbit/256 Mbit to 256 MB maximum) and 4 asynchronous devices (8/16/32 bit) with a data path of 32 bits and fixed length as well as undefined length block transfers and accommodates back-to-back transfers. Eight transactions may be queued for operation. The SDRAM [not shown] contains the states of the PUs 930. One of ordinary skill in the art would appreciate that, although not preferred, other external memory configurations and types could be selected in place of the SDRAM and, therefore, that another type of memory interface could be used in place of the SDRAM IF 970.

The SDRAM IF 970 is further in communication with the PCI IF 960, DMA controller 910, the CPU IF 950, and, preferably, the SRAM interface (SRAM IF) 975 through communication buses 920. The SRAM [not shown] is a static random access memory that is a form of random access memory that retains data without constant refreshing, offering relatively fast memory access. The SRAM IF 975 is also in communication with a TDM interface (TDM IF) 980, the CPU IF 950, the DMA controller 910, and the PCI IF 960 via data buses 920.

In a preferred embodiment, the TDM IF 980 for the trunk side is preferably H.100/H.110 compatible and the TDM bus 981 operates at 8.192 MHz. Enabling the Media Engine I 900 to provide 8 data signals, therefore delivering a capacity up to 512 full duplex channels, the TDM IF 980 has the following preferred features: a H.100/H.110 compatible slave, frame size can be set to 16 or 20 samples and the scheduler can program the TDM IF 980 to store a specific buffer or frame size, programmable staggering points for the maximum number of channels. Preferably, the TDM IF interrupts the scheduler after every N samples of 8,000 Hz clock with the number N being programmable with possible values of 2, 4, 6, and 8. In a voice application, the TDM IF 980 preferably does not transfer the pulse code modulation (PCM) data to memory on a sample-by-sample basis, but rather buffers 16 or 20 samples, depending on the frame size which the encoders and decoders are using, of a channel and then transfers the voice data for that channel to memory.

The PCI IF 960 is also in communication with the DMA controller 910 via communication buses 920. External connections comprise connections between the TDM IF 980 and a TDM bus 981, between the SRAM IF 975 and a SRAM bus 976, between the SDRAM IF 970 and a SDRAM bus 971, preferably operating at 32 bit @ 133 MHz, and between the PCI IF 960 and a PCI 2.1 Bus 961 also preferably operating at 32 bit @ 133 MHz.

External to Media Engine I, the scheduler 955 maps the channels to the Media Layers 905 for processing. When the scheduler 955 is processing a new channel, it assigns the channel to one of the layers, depending upon processing resources available per layer 905. Each layer 905 handles the processing of a plurality of channels such that the processing is performed in parallel and is divided into fixed frames, or portions of data. The scheduler 955 communicates with each Media Layer 905 through the transmission of data, in the form of tasks, to the FIFO task queues wherein each task is a request to the Media Layer 905 to process a plurality of data portions for a particular channel. It is therefore preferred for the scheduler 955 to initiate the processing of data from a channel by putting a task in a task queue, rather than programming each PU 930 individually. More specifically, it is preferred to have the scheduler 955 initiate the processing of data from a channel by putting a task in the task queue of a particular PU 930 and having the Media Layer's 905 pipeline architecture manage the data flow to subsequent PUs 930.

The scheduler 955 should manage the rate by which each of the channels is processed. In an embodiment where the Media Layer 905 is required to accept the processing of data from M channels and each of the channels uses a frame size of T msec, then it is preferred that the scheduler 955 processes one frame of each of the M channels within each T msec interval. Further, in a preferred embodiment, the scheduling is based upon periodic interrupts, in the form of units of samples, from the TDM IF 980. As an example, if the interrupt period is 2 samples then it is preferred that the TDM IF 980 interrupts the scheduler every time it gathers two new samples of all channels. The scheduler preferably maintains a ‘tick-count’, which is incremented on every interrupt and reset to 0 when time equal to a frame size has passed. The mapping of channels to time slots is preferably not fixed. For example, in voice applications, whenever a call starts on a channel, the scheduler dynamically assigns a layer to a provisioned time slot channel. It is further preferred that the data transfer from a TDM buffer to the memory is aligned with the time slot in which this data is processed, thereby staggering the data transfer for different channels from TDM to memory, and vice-versa, in a manner that is equivalent to the staggering of the processing of different channels. Consequently, it is further preferred that the TDM IF 980 maintains a tick count variable wherein there is some synchronization between the tick counts of TDM and scheduler 955. In the exemplary embodiment described above, the tick count variable is set to zero on every 2 ms or 2.5 ms depending on the buffer size.

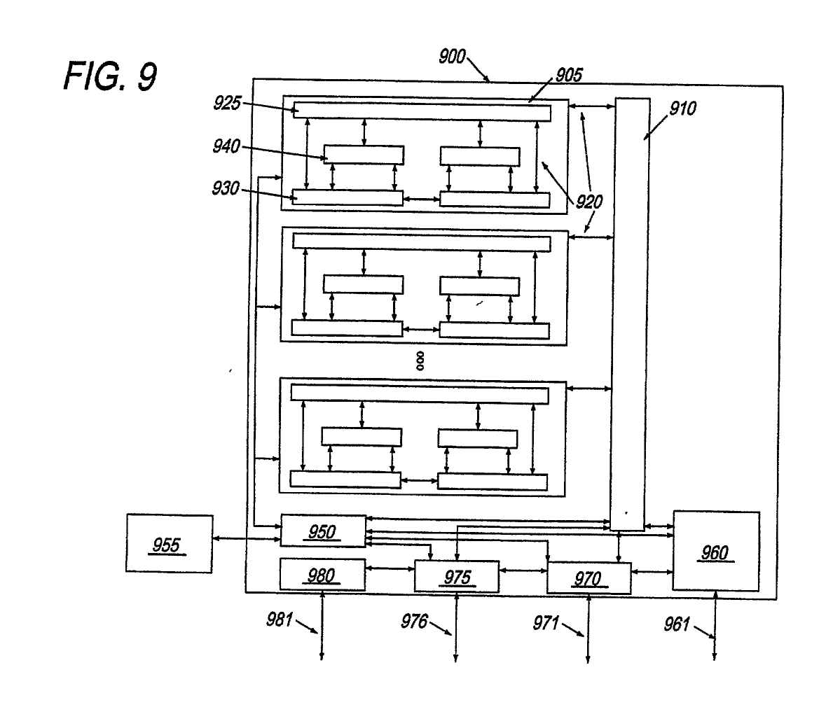

Referring to FIG. 10, a block diagram of Media Engine II 1000 is shown. Media Engine II 1000 comprises a plurality of Media Layers 1005 each in communication with processing layer controller 1007, referred to herein as a Media Layer Controller 1007, and central direct memory access (DMA) controller 1010 via communication data buses and an interface 1015. Each Media Layer 1005 is in communication with a CPU interface 1006 which, in turn, is in communication with a CPU 1004. Within each Media Layer 1005, a plurality of pipelined processing units (PUs) 1030 are in communication with a plurality of program memories 1035 and data memories 1040, via communication data buses. Preferably, each PU 1030 can access at least one program memory 1035 and one data memory 1040. Each of the PUs 1030, program memories 1035, and data memories 1040 is in communication with an external memory 1047 via the Media Layer Controller 1007 and DMA 1010. In a preferred embodiment, each Media Layer 1005 comprises four PUs 1030, each of which is in communication with a single program memory 1035 and data memory 1040, wherein the each of the PUs 1031, 1032, 1033, 1034 is in communication with each of the other PUs 1031, 1032, 1033, 1034 in the Media Layer 1005.

Shown in FIG. 10a, a preferred embodiment of the architecture of the Media Layer Controller, or MLC, is provided. A program memory 1005a, preferably 512×64, operates in conjunction with a controller 1010a and data memory 1015a to deliver data and instructions to a data register file 1017a, preferably 16×32, and address register file 1020a, preferably 4×12. The data register file 1017a and address register file 1020a are in communication with functional units such as an adder/MAC 1025a, logical unit 1027a, and barrel shifter 1030a and with units such as a request arbitration logic unit 1033a and DMA channel bank 1035a.

Referring back to FIG. 10, the MLC 1007 arbitrates data and program code transfer requests to and from the program memories 1035 and data memories 1040 in a round robin fashion. On the basis of this arbitration the MLC 1007 fills the data pathways that define how units directly access memory, namely the DMA channels [not shown]. The MLC 1007 is capable of performing instruction decoding to route an instruction according to its dataflow and keep track of the request states for all PUs 1030, such as the state of a read-in request, a write-back request and an instruction forwarding. The MLC 1007 is further capable of conducting interface related functions, such as programming DMA channels, starting signal generation, maintaining page states for PUs 1030 in each Media Layer 1005, decoding of scheduler instructions, and managing the movement of data from and into the task queues of each PU 1030. By performing the aforementioned functions, the Media Layer Controller 1007 substantially eliminates the need for associating complex state machines with the PUs 1030 present in each Media Layer 1005.

The DMA controller 1010 is a multi-channel DMA unit for handling the data transfers between the local memory buffer PUs and external memories, such as the SDRAM. Preferably, DMA channels are programmed dynamically. More specifically, PUs 1030 generate independent requests, each having an associated priority level, and send them to the MLC 1007 for reading or writing. Based upon the priority request delivered by a particular PU 1030, the MLC 1007 programs the DMA channel accordingly. Preferably, there is also an arbitration process, such as a single level of round robin arbitration, between the channels within the DMA to access the external memory. The DMA Controller 1010 provides hardware support for round robin request arbitration across the PUs 1030 and Media Layers 1005.

In an exemplary operation, it is preferred to conduct transfers between local PU memories and external memories by utilizing the address of the local memory, address of the external memory, size of the transfer, direction of the transfer, namely whether the DMA channel is transferring data to the local memory from the external memory or vice-versa, and how many transfers are required for each PU. In this preferred embodiment, a DMA channel is generated and receives this information from 2, 32 bit registers residing in the DMA. A third register exchanges control information between the DMA and each PU which contains the current status of the DMA transfer. In a preferred embodiment, arbitration is performed among the following requests: 1 structure read, 4 data read and 4 data write requests from each Media Layer, approximately 90 data requests in total, and 4 program code fetch requests from each Media Layer, approximately 40 program code fetch requests in total. The DMA Controller 1010 is preferably further capable of arbitrating priority for program code fetch requests, conducting link list traversal and DMA channel information generation, and performing DMA channel prefetch and done signal generation.

The MLC 1007 and DMA Controller 1010 are in communication with a CPU IF 1006 through communication buses. The PCI IF 1060 is in communication with an external memory interface (such as a SDRAM IF) 1070 and with the CPU IF 1006 via communication buses. The external memory interface 1070 is further in communication with the MLC 1007 and DMA Controller 1010 and a TDM IF 1080 through communication buses. The SDRAM IF 1070 is in communication with a packet processor interface, such as a UTOPIA II/POS compatible interface (U2/POS IF), 1090 via communication data buses. The U2/POS IF 1090 is also preferably in communication with the CPU IF 1006. Although the preferred embodiments of the PCI IF and SDRAM IF are similar to Media Engine I, it is preferred that the TDM IF 1080 have all 32 serial data signals implemented, thereby supporting at least 2048 full duplex channels. External connections comprise connections between the TDM IF 1080 and a TDM bus 1081, between the external memory 1070 and a memory bus 1071, preferably operating at 64 bit @ 133 MHz, between the PCI IF 1060 and a PCI 2.1 Bus 1061 also preferably operating at 32 bit @ 133 MHz, and between the U2/POS IF 1090 and a UTOPIA II/POS connection 1091 preferably operative at 622 megabits per second. In a preferred embodiment, the TDM IF 1080 for the trunk side is preferably H.100/H.110 compatible and the TDM bus 1081 operates at 8.192 MHz, as previously discussed in relation to the Media Engine I.

For both Media Engine I and Media Engine II, within each media layer, the present invention utilizes a plurality of pipelined Pus specially designed for conducting a defined set of processing tasks. In that regard, the PUs are not general purpose processors and can not be used to conduct any processing task. A survey and analysis of specific processing tasks yielded certain functional unit commonalities that, when combined, yield a specialized PU capable of optimally processing the universe of those specialized processing tasks. The instruction set architecture of each PU yields compact code. Increased code density results in a decrease in required memory and, consequently, a decrease in required area, power, and memory traffic.

The pipeline architecture also improves performance. Pipelining is an implementation technique whereby multiple instructions are overlapped in execution. In a computer pipeline, each step in the pipeline completes a part of an instruction. Like an assembly line, different steps are completing different parts of different instructions in parallel. Each of these steps is called a pipe stage or a data segment. The stages are connected on to the next to form a pipe. Within a processor, instructions enter the pipe at one end, progress through the stages, and exit at the other end. The throughput of an instruction pipeline is determined by how often an instruction exits the pipeline.

More specifically, one type of PU (referred to herein as EC PU) has been specially designed to perform, in a pipeline architecture, a plurality of media processing functions, such as echo cancellation (EC), voice activity detection (VAD), and tone signaling (TS) functions. Echo cancellation removes from a signal echoes that may arise as a result of the reflection and/or retransmission of modified input signals back to the originator of the input signals. Commonly, echoes occur when signals that were emitted from a loudspeaker are then received and retransmitted through a microphone (acoustic echo) or when reflections of a far end signal are generated in the course of transmission along hybrids wires (line echo). Although undesirable, echo is tolerable in a telephone system, provided that the time delay in the echo path is relatively short. However, longer echo delays can be distracting or confusing to a far end speaker. Voice activity detection determines whether a meaningful signal or noise is present at the input. Tone signaling comprises the processing of supervisory, address, and alerting signals over a circuit or network by means of tones. Supervising signals monitor the status of a line or circuit to determine if it is busy, idle, or requesting service. Alerting signals indicate the arrival of an incoming call. Addressing signals comprise routing and destination information.

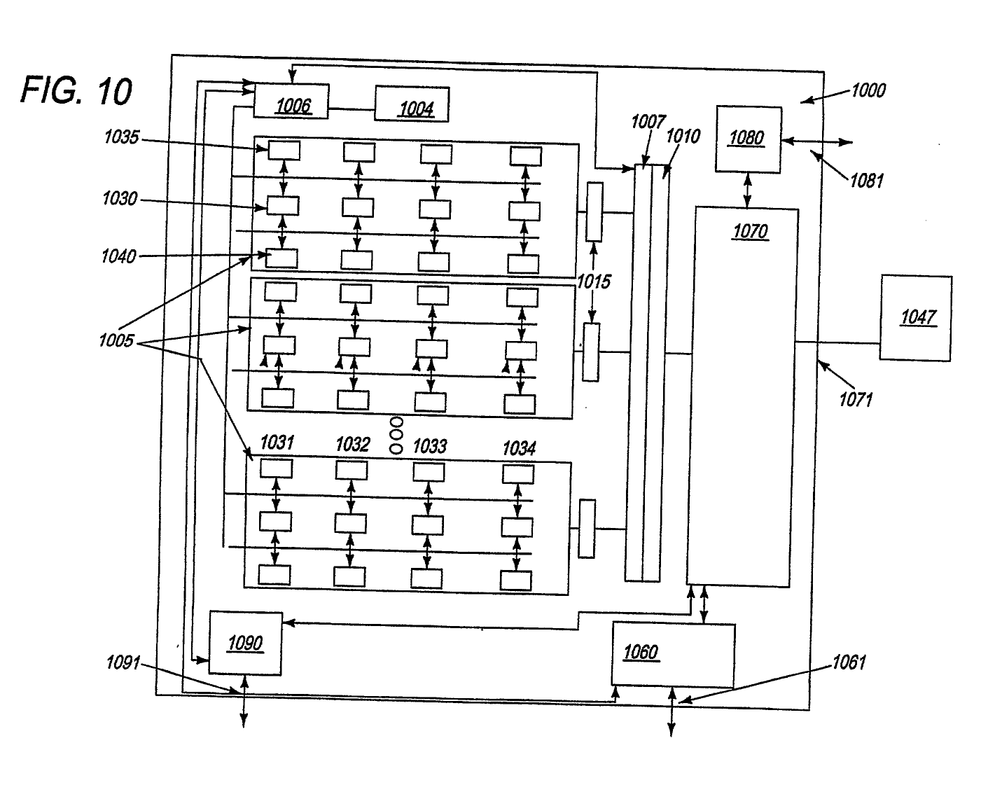

The LEC, VAD, and TS functions can be efficiently executed using a PU having several single-cycle multiply and accumulate (MAC) units operating with an Address Generation Unit and an Instruction Decoder. Each MAC unit includes a compressor, sum and carry registers, an adder, and a saturation and rounding logic unit. In a preferred embodiment, shown in FIG. 11, this PU 1100 comprises a load store architecture with a single Address Generation Unit (AGU) 1105, supporting zero over-head looping and branching with delay slots, and an Instruction Decoder 1106. The plurality of MAC units 1110 operate in parallel on two 16-bit operands and perform the following function:

Acc+=a*b

Guard bits are appended with sum and carry registers to facilitate repeated MAC operations. A scale unit prevents accumulator overflow. Each MAC unit 1110 may be programmed to perform round operations automatically. Additionally, it is preferred to have an addition/subtraction unit [not shown] as a conditional sum adder with both the input operands being 20 bit values and the output operand being a 16-bit value.

Operationally, the EC PU performs tasks in a pipeline fashion. A first pipeline stage comprises an instruction fetch wherein instructions are fetched into an instruction register from program memory. A second pipeline stage comprises an instruction decode and operand fetch wherein an instruction is decoded and stored in a decode register. The hardware loop machine is initialized in this cycle. Operands from the data register files are stored in operand registers. The AGU operates during this cycle. The address is placed on data memory address bus. In the case of a store operation, data is also placed on the data memory data bus. For post increment or decrement instructions, the address is incremented or decremented after being placed on the address bus. The result is written back to address register file. The third pipeline stage, the Execute stage, comprises the operation on the fetched operands by the Addition/Subtraction Unit and MAC units. The status register is updated and the computed result or data loaded from memory is stored in the data/address register files. The states and history information required for the EC PU operations are fetched through a multi-channel DMA interface, as previously shown in each Media Layer. The EC PU configures the DMA controller registers directly. The EC PU loads the DMA chain pointer with the memory location of the head of the chain link.

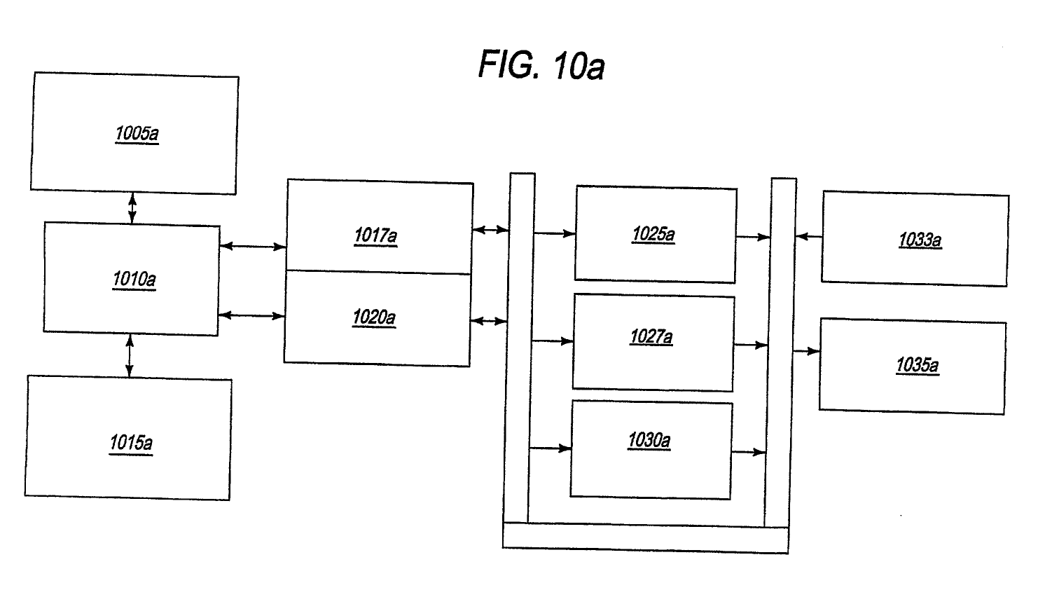

By enabling different data streams to move through the pipelined stages concurrently, the EC PU reduces wait time for processing incoming media, such as voice. Referring to FIG. 12, in time slot 1 1205, an instruction fetch task (IF) is performed for processing data from channel 1 1250. In time slot 2 1206, the IF task is performed for processing data from channel 2 1255 while, concurrently, an instruction decode and operand fetch (IDOF) is performed for processing data from channel 1 1250. In time slot 3 1207, an IF task is performed for processing data from channel 3 1260 while, concurrently, an instruction decode and operand fetch (IDOF) is performed for processing data from channel 2 1255 and an Execute (EX) task is performed for processing data from channel 1 1250. One of ordinary skill in the art would appreciate that, because channels are dynamically generated, the channel numbering may not reflect the actual location and assignment of a task. Channel numbering here is used to simply indicate the concept of pipelining across multiple channels and not to represent actual task locations.

A second type of PU (referred to herein as CODEC PU) has been specially designed to perform, in a pipeline architecture, a plurality of media processing functions, such as encoding and decoding signals in accordance with certain standards and protocols, including standards promoted by the International Telecommunication Union (ITU) such as voice standards, including G.711, G.723.1, G.726, G.728, G.729A/B/E, and data modem standards, including V.17, V.34, and V.90, among others (referred to herein as Codecs), and performing comfort noise generation (CNG) and discontinuous transmission (DTX) functions. The various Codecs are used to encode and decode voice signals with differing degrees of complexity and resulting quality. CNG is the generation of background noise that gives users a sense that the connection is live and not broken. A DTX function is implemented when the frame being received comprises silence, rather than a voice transmission.

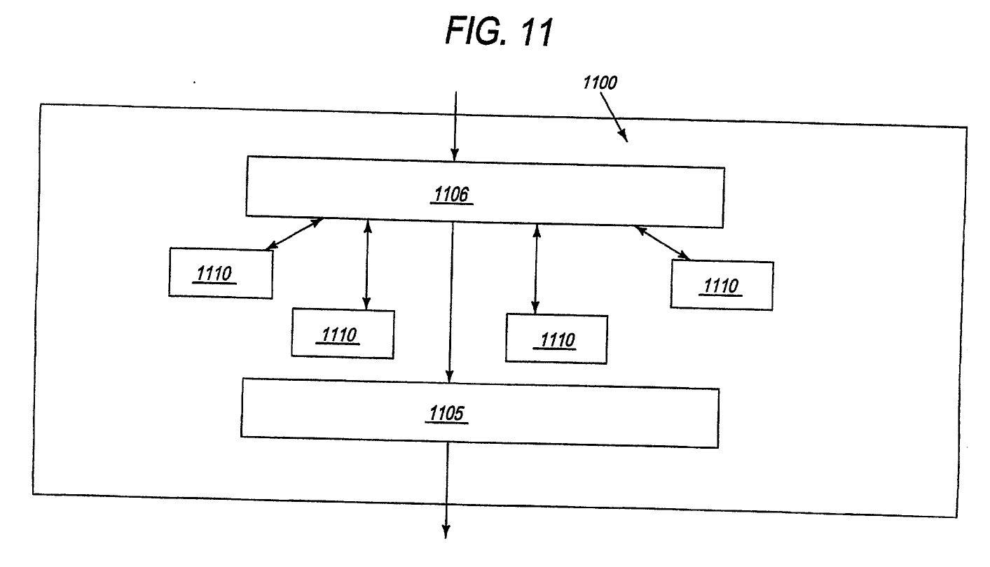

The Codecs, CNG, and DTX functions can be efficiently executed using a PU having an Arithmetic and Logic Unit (ALU), MAC unit, Barrel Shifter, and Normalization Unit. In a preferred embodiment, shown in FIG. 13, the CODEC PU 1300 comprises a load store architecture with a single Address Generation Unit (AGU) 1305, supporting zero over-head looping and zero overhead branching with delay slots, and an Instruction Decoder 1306.

In an exemplary embodiment, each MAC unit 1310 includes a compressor, sum and carry registers, an adder, and a saturation and rounding logic unit. The MAC unit 1310 is implemented as a compressor with feedback into the compression tree for accumulation. One preferred embodiment of a MAC 1310 has a latency of approximately 2 cycles with a throughput of 1 cycle. The MAC 1310 operates on two 17-bit operands, signed or unsigned. The intermediate results are kept in sum and carry registers. Guard bits are appended to the sum and carry registers for repeated MAC operations. The saturation logic converts the Sum and Carry results to 32 bit values. The rounding logic rounds a 32 bit to a 16 bit number. Division logic is also implemented in the MAC unit 1310.

In an exemplary embodiment, the ALU 1320 includes a 32 bit adder and a 32 bit logic circuit capable of performing a plurality of operations, including add, add with carry, subtract, subtract with borrow, negate, AND, OR, XOR, and NOT. One of the inputs to the ALU 1320 has an XOR array, which operates on 32-bit operands. Comprising an absolute unit, a logic unit, and an addition/subtraction unit, the ALU's 1320 absolute unit drives this array. Depending on the output of the absolute unit, the input operand is either XORed with one or zero to perform negation on the input operands.

In an exemplary embodiment, the Barrel Shifter 1330 is placed in series with the ALU 1320 and acts as a pre-shifter to operands requiring a shift operation followed by any ALU operations. One type of preferred Barrel Shifter can perform a maximum of 9-bit left or 26-bit right arithmetic shifts on 16-bit or 32-bit operands. The output of the Barrel Shifter is a 32-bit value, which is accessible to both the inputs of the ALU 1320.

In an exemplary embodiment, the Normalization unit 1340 counts the redundant sign bits in the number. It operates on 2's complement 16-bit numbers. Negative numbers are inverted to compute the redundant sign bits. The number to be normalized is fed into the XOR array. The other input comes from the sign bit of the number. Where the media being processed is voice, it is preferred to have an interface to the EC PU. The EC PU uses VAD to determine whether a frame being received comprises silence or speech. The VAD decision is preferably communicated to the CODEC PU so that it may determine whether to implement a Codec or DTX function.

Operationally, the CODEC PU performs tasks in a pipeline fashion. A first pipeline stage comprises an instruction fetch wherein instructions are fetched into an instruction register from program memory. At the same time, the next program counter value is computed and stored in the program counter. In addition, loop and branch decisions are taken in the same cycle. A second pipeline stage comprises an instruction decode and operand fetch wherein an instruction is decoded and stored in a decode register. The instruction decode, register read and branch decisions happen in the instruction decode stage. In the third pipeline stage, the Execute 1 stage, the Barrel Shifter and the MAC compressor tree complete their computation. Addresses to data memory are also applied in this stage. In the fourth pipeline stage, the Execute 2 stage, the ALU, normalization unit, and the MAC adder complete their computation. Register write-back and address registers are updated at the end of the Execute-2 stage. The states and history information required for the CODEC PU operations are fetched through a multi-channel DMA interface, as previously shown in each Media Layer.

By enabling different data streams to move through the pipelined stages concurrently, the CODEC PU reduces wait time for processing incoming media, such as voice. Referring to FIG. 13a, in time slot 1 1305a, an instruction fetch task (IF) is performed for processing data from channel 1 1350a. In time slot 2 1306a, the IF task is performed for processing data from channel 2 1355a while, concurrently, an instruction decode and operand fetch (IDOF) is performed for processing data from channel 1 1350a. In time slot 3 1307a, an IF task is performed for processing data from channel 3 1360a while, concurrently, an instruction decode and operand fetch (IDOF) is performed for processing data from channel 2 1355a and an Execute 1 (EX1) task is performed for processing data from channel 1 1350a. In time slot 4 1308a, an IF task is performed for processing data from channel 4 1370a while, concurrently, an instruction decode and operand fetch (IDOF) is performed for processing data from channel 3 1360a, an Execute 1 (EX1) task is performed for processing data from channel 2 1355a, and an Execute 2 (EX2) task is performance for processing data from channel 1 1350a. One of ordinary skill in the art would appreciate that, because channels are dynamically generated, the channel numbering may not reflect the actual location and assignment of a task. Channel numbering here is used to simply indicate the concept of pipelining across multiple channels and not to represent actual task locations.

The pipeline architecture of the present invention is not limited to instruction processing within PUs, but also exists on a PU to PU architecture level. As shown in FIG. 13b, multiple PUs may operate on a data set N in a pipeline fashion to complete the processing of a plurality of tasks where each task comprises a plurality of steps. A first PU 1305b may be capable of performing echo cancellation functions, labeled task A. A second PU 1310b may be capable of performing tone signaling functions, labeled task B. A third PU 1315b may be capable of performing a first set of encoding functions, labeled task C. A fourth PU 1320b may be capable of performing a second set of encoding functions, labeled task D. In time slot 1 1350b, the first PU 1305b performs task A1 1380b on data set N. In time slot 2 1355b, the first PU 1305b performs task A2 1381b on data set N and the second PU 1310b performs task B1 1387b on data set N. In time slot 3 1360b, the first PU 1305b performs task A3 1382b on data set N, the second PU 1310b performs task B2 1388b on data set N, and the third PU 1315b performs task C1 1394b on data set N. In time slot 4 1365b, the first PU 1305b performs task A4 1383b on data set N, the second PU 1310b performs task B3 1389b on data set N, the third PU 1315b performs task C2 1395b on data set N, and the fourth PU 1320b performs task D1 1330 on data set N. In time slot 5 1370b, the first PU 1305b performs task A5 1384b on data set N, the second PU 1310b performs task B4 1390b on data set N, the third PU 1315b performs task C3 1396b on data set N, and the fourth PU 1320b performs task D2 1331 on data set N. In time slot 6 1375b, the first PU 1305b performs task A5 1385b on data set N, the second PU 1310b performs task B4 1391b on data set N, the third PU 1315b performs task C3 1397b on data set N, and the fourth PU 1320b performs task D2 1332 on data set N. One of ordinary skill in the art would appreciate how the pipeline processing would further progress.

In this exemplary embodiment, the combination of specialized PUs with a pipeline architecture enables the processing of greater channels on a single media layer. Where each channel implements a G.711 codec and 128 ms of echo tail cancellation with DTMF detection/generation, voice activity detection (VAD), comfort noise generation (CNG), and call discrimination, the media engine layer operates at 1.95 MHz per channel. The resulting channel power consumption is at or about 6 mW per channel using 0.13μ standard cell technology.

Packet Engine

The Packet Engine of the present invention is a communications processor that, in a preferred embodiment, supports the plurality of interfaces and protocols used in media gateway processing systems between circuit-switched networks, packet-based IP networks, and cell-based ATM networks. The Packet Engine comprises a unique architecture capable of providing a plurality of functions for enabling media processing, including, but not limited to, cell and packet encapsulation, quality of service functions for traffic management and tagging for the delivery of other services and multi-protocol label switching, and the ability to bridge cell and packet networks.

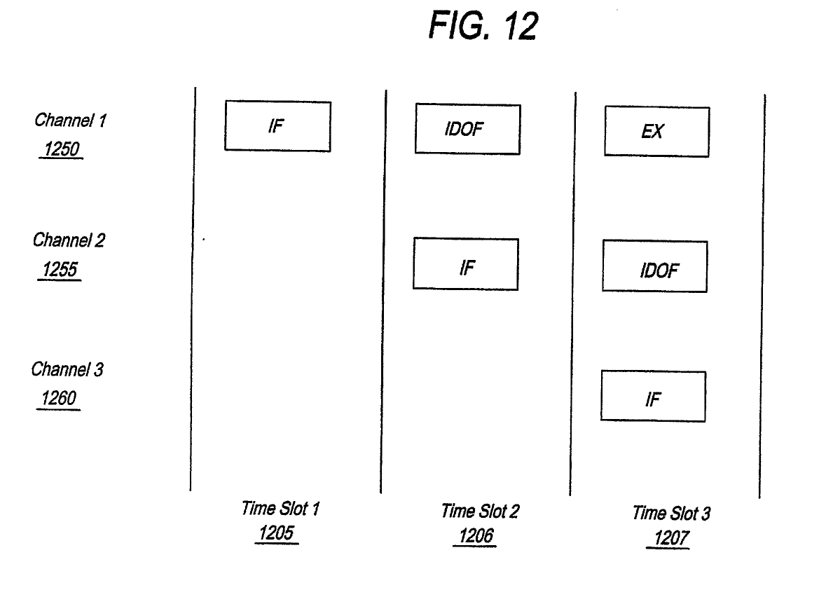

Referring now to FIG. 14, an exemplary architecture of the Packet Engine 1400 is provided. In the embodiment depicted, the Packet Engine 1400 is configured to handle data rate up to and around OC-12. It is appreciated by one of ordinary skill in the art that certain modifications can be made to the fundamental architecture to increase the data handling rates beyond OC-12. The Packet Engine 1400 comprises a plurality of processors 1405, a host processor 1430, an ATM engine 1440, in-bound DMA channel 1450, out-bound DMA channel 1455, a plurality of network interfaces 1460, a plurality of registers 1470, memory 1480, an interface to external memory 1490, and a means to receive control and signaling information 1495.

The processors 1405 comprise an internal cache 1407, central processing unit interface 1409, and data memory 1411. In a preferred embodiment, the processors 1405 comprise 32-bit reduced instruction set computing (RISC) processors with a 16 Kb instruction cache and a 12 Kb local memory. The central processing unit interface 1409 permits the processor 1405 to communicate with other memories internal to, and external to, the Packet Engine 1400. The processors 1405 are preferably capable of handling both in-bound and out-bound communication traffic. In a preferred implementation, generally half of the processors handle in-bound traffic while the other half handle out-bound traffic. The memory 1411 in the processor 1405 is preferably divided into a plurality of banks such that distinct elements of the Packet Engine 1400 can access the memory 1411 independently and without contention, thereby increasing overall throughput. In a preferred embodiment, the memory is divided into three banks, such that the in-bound DMA channel can write to memory bank one, while the processor is processing data from memory bank two, while the out-bound DMA channel is transferring processed packets from memory bank three.

The ATM engine 1440 comprises two primary subcomponents, referred to herein as the ATMRx Engine and the ATMTx Engine. The ATMRx Engine processes an incoming ATM cell header and transfers the cell for corresponding AAL protocol, namely AAL1, AAL2, AAL5, processing in the internal memory or to another cell manager, if external to the system. The ATMTx Engine processes outgoing ATM cells and requests the outbound DMA channel to transfer data to a particular interface, such as the UTOPIAII/POSII interface. Preferably, it has separate blocks of local memory for data exchange. The ATM engine 1440 operates in combination with data memory 1483 to map an AAL channel, namely AAL2, to a corresponding channel on the TDM bus (where the Packet Engine 1400 is connected to a Media Engine) or to a corresponding IP channel identifier where internetworking between IP and ATM systems is required. The internal memory 1480 utilizes an independent block to maintain a plurality of tables for comparing and/or relating channel identifiers with virtual path identifiers (VPI), virtual channel identifiers (VCI), and compatibility identifiers (CID). A VPI is an eight-bit field in the ATM cell header which indicates the virtual path over which the cell should be routed. A VCI is the address or label of a virtual channel comprised of a unique numerical tag, defined by a 16 bit field in the ATM cell header, that identifies a virtual channel over which a stream of cells is to travel during the course of a session between devices. The plurality of tables are preferably updated by the host processor 1430 and are shared by the ATMRx and ATMTx engines.

The host processor 1430 is preferably a RISC processor with an instruction cache 1431. The host processor 1430 communicates with other hardware blocks through a CPU interface 1432 which is capable of managing communications with Media Engines over a bus, such as a PCI bus, and with a host, such as a signaling host through a PCI-PCI bridge. The host processor 1430 is capable of being interrupted by other processors 1405 through their transmission of interrupts which are handled by an interrupt handler 1433 in the CPU interface. It is further preferred that the host processor 1430 be capable of performing the following functions: 1) boot-up processing, including loading code from a flash memory to an external memory and starting execution, initializing interfaces and internal registers, acting as a PCI host, and appropriately configuring them, and setting up inter-processor communications between a signaling host, the packet engine itself, and media engines, 2) DMA configuration, 3) certain network management functions, 4) handling exceptions, such as the resolution of unknown addresses, fragmented packets, or packets with invalid headers, 4) providing intermediate storage of tables during system shutdown, 5) IP stack implementation, and 6) providing a message-based interface for users external to the packet engine and for communicating with the packet engine through the control and signaling means, among others.

In a preferred embodiment, two DMA channels are provided for data exchange between different memory blocks via data buses. Referring to FIG. 14, the in-bound DMA channel 1450 is utilized to handle incoming traffic to the Packet Engine 1400 data processing elements and the out-bound DMA channel 1455 is utilized to handle outgoing traffic to the plurality of network interfaces 1460. The in-bound DMA channel 1450 handles all of the data coming into the Packet Engine 1400.

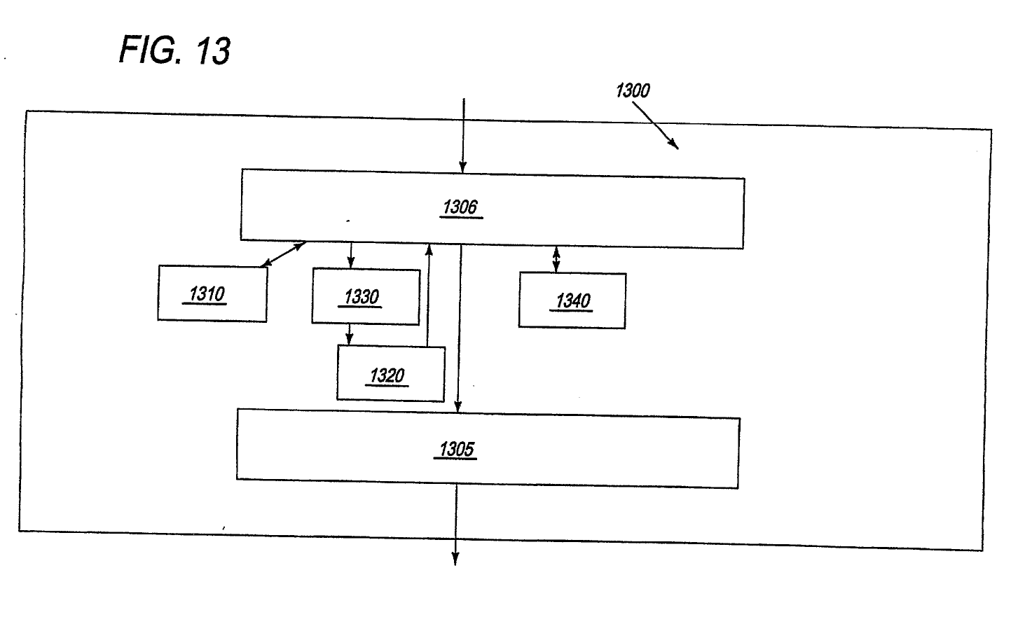

To receive and transmit data to ATM and IP networks, the Packet Engine 1400 has a plurality of network interfaces 1460 that permit the Packet Engine to compatibly communicate over networks. Referring to FIG. 15, in a preferred embodiment, the network interfaces comprise a GMII PHY interface 1562, a GMII MAC interface 1564, and two UTOPIAII/POSII interfaces 1566 in communication with 622 Mbps ATM/SONET connections 1568 to receive and transmit data. For IP-based traffic, the Packet Engine [not shown] supports MAC and emulates PHY layers of the Ethernet interface as specified in IEEE 802.3. The gigabit Ethernet MAC 1570 comprises FIFOs 1503 and a control state machine 1525. The transmit and receive FIFOs 1503 are provided for data exchange between the gigabit Ethernet MAC 1570 and bus channel interface 1505. The bus channel interface 1505 is in communication with the outbound DMA channel 1515 and in-bound DMA channel 1520 through bus channel. When IP data is being received from the GMII MAC interface 1564, the MAC 1570 preferably sends a request to the DMA 1520 for data movement. Upon receiving the request, the DMA 1520 preferably checks the task queue [not shown] in the MAC interface 1564 and transfers the queued packets. In a preferred embodiment, the task queue in the MAC interface is a set of 64 bit registers containing a data structure comprising: length of data, source address, and destination address. Where the DMA 1520 is maintaining the write pointers for the plurality of destinations [not shown], the destination address will not be used. The DMA 1520 will move the data over the bus channel to memories located within the processors and will write the number of tasks at a predefined memory location. After completing writing of all tasks, the DMA 1520 will write the total number of tasks transferred to the memory page. The processor will process the received data and will write a task queue for an outbound channel of the DMA. The outbound DMA channel 1515 will check the number of frames present in the memory locations and, after reading the task queue, will move the data either to a POSII interface of the Media Engine Type I or II or to an external memory location where IP to ATM bridging is being performed.

For ATM only or ATM and IP traffic in combination, the Packet Engine supports two configurable UTOPIAII/POSII interfaces 1566 which provides an interface between the PHY and upper layer for IP/ATM traffic. The UTOPIAII/POSII 1580 comprises FIFOs 1504 and a control state machine 1526. The transmit and receive FIFOs 1504 are provided for data exchange between the UTOPIAII/POSII 1580 and bus channel interface 1506. The bus channel interface 1506 is in communication with the outbound DMA channel 1515 and in-bound DMA channel 1520 through bus channel. The UTOPIA II/POS II interfaces 1566 may be configured in either UTOPIA level II or POS level II modes. When data is received on the UTOPIAII/POSII interface 1566, data will push existing tasks in the task queue forward and request the DMA 1520 to move the data. The DMA 1520 will read the task queue from the UTOPIAII/POSII interface 1566 which contains a data structure comprising: length of data, source address, and type of interface. Depending upon the type of interface, e.g. either POS or UTOPIA, the in-bound DMA channel 1520 will send the data either to the plurality of processors [not shown] or to the ATMRx engine [not shown]. After data is written into the ATMRx memory, it is processed by the ATM engine and passed to the corresponding AAL layer. On the transmit side, data is moved to the internal memory of the ATMTx engine [not shown] by the respective AAL layer. The ATMTx engine inserts the desired ATM header at the beginning of the cell and will request the outbound DMA channel 1515 to move the data to the UTOPIAII/POSII interface 1566 having a task queue with the following data structure: length of data and source address.

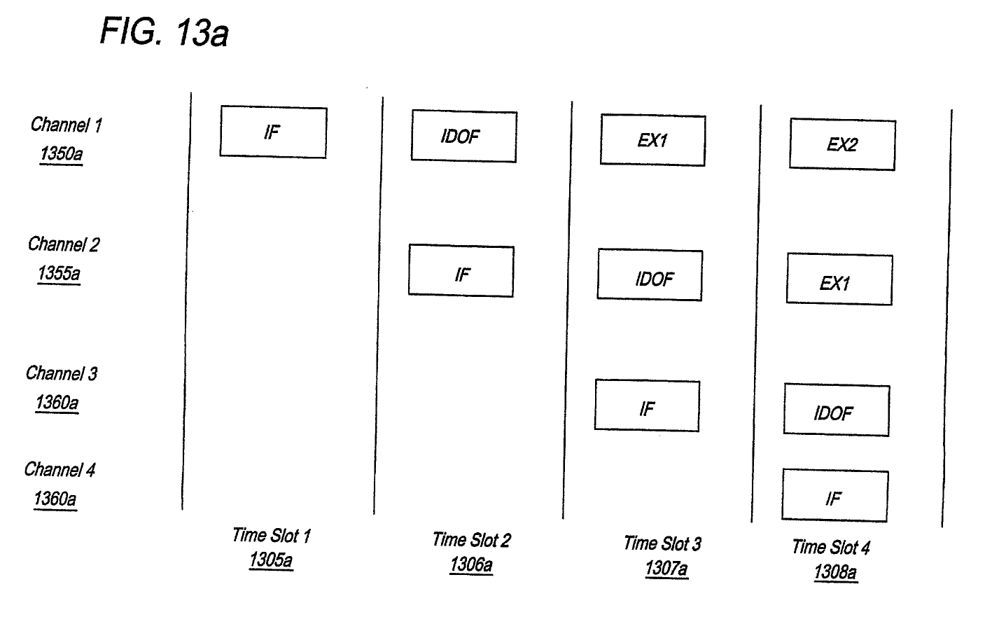

Referring to FIG. 16, to facilitate control and signaling functions, the Packet Engine 1600 has a plurality of PCI interfaces 1605, 1606, referred to in FIG. 14 as 1495. In a preferred embodiment, a signaling host 1610, through an initiator 1612, sends messages to be received by the Packet Engine 1600 to a PCI target 1605 via a communication bus 1617. The PCI target further communicates these messages through a PCI to PCI bridge 1620 to a PCI initiator 1606. The PCI initiator 1606 sends messages through a communication bus 1618 to a plurality of Media Engines 1650, each having a memory 1660 with a memory queue 1665.

Software Architecture

As previously discussed, operating on the above-described hardware architecture embodiments is a plurality of novel, integrated software systems designed to enable media processing, signaling, and packet processing. The novel software architecture enables the logical system, presented in FIG. 5, to be physically deployed in a number of ways, depending on processing needs.

Communication between any two modules, or components, in the software system is facilitated by application program interfaces (APIs) that remain substantially constant and consistent irrespective of whether the software components reside on a hardware element or across multiple hardware elements. This permits the mapping of components onto different processing elements, thereby modifying physical interfaces, without the concurrent modification of the individual components.

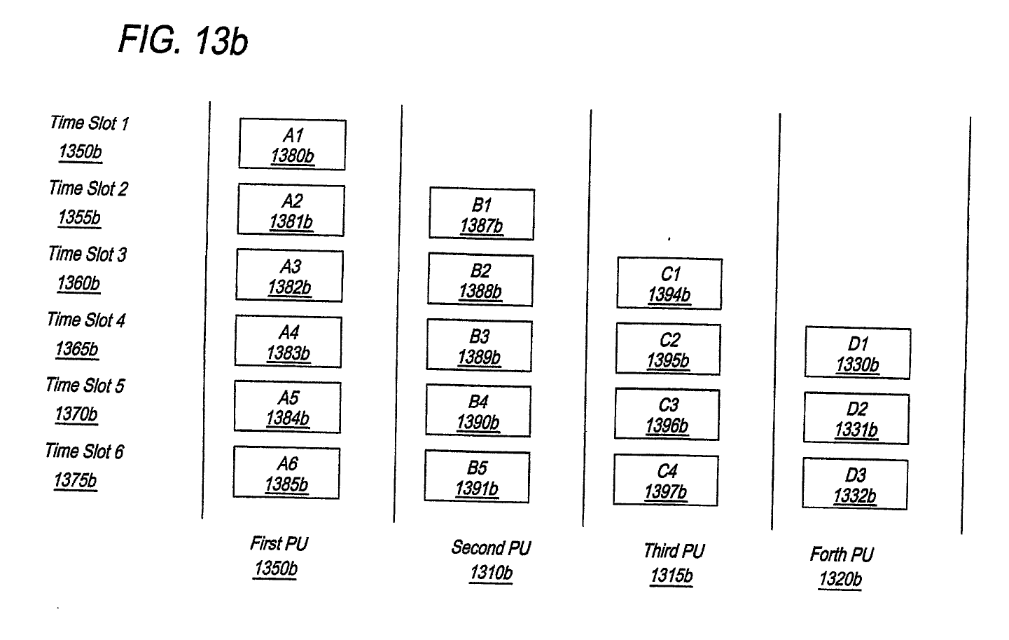

In an exemplary embodiment, shown in FIG. 17, a first component 1705 operates in conjunction with a second component 1710 and a third component 1715 through a first interface 1720 and second interface 1725, respectively. Because all three components 1705, 1710, 1715 are executing on the same physical processor 1700, the first interface 1720 and second interface 1725 perform interfacing tasks through function mapping conducted via the APIs of each of the three components 1705, 1710, 1715. Referring to FIG. 17a, where the first 1705a, second 1710a, and third 1715a components reside on separate hardware elements 1700a, 1701a, 1702a respectively, e.g. separate processors or processing elements, the first interface 1720a and second interface 1725a implement interfacing tasks through queues 1721a, 1726a in shared memory. While the interfaces 1720a, 1725a are no longer limited to function mapping and messaging, the components 1705a, 1710a, 1715a continue to use the same APIs to conduct inter-component communication. The consistent use of a standard API enables the porting of various components to different hardware architectures in a distributed processing environment by relying on modified interfaces or drivers where necessary and without modifications in the components themselves.

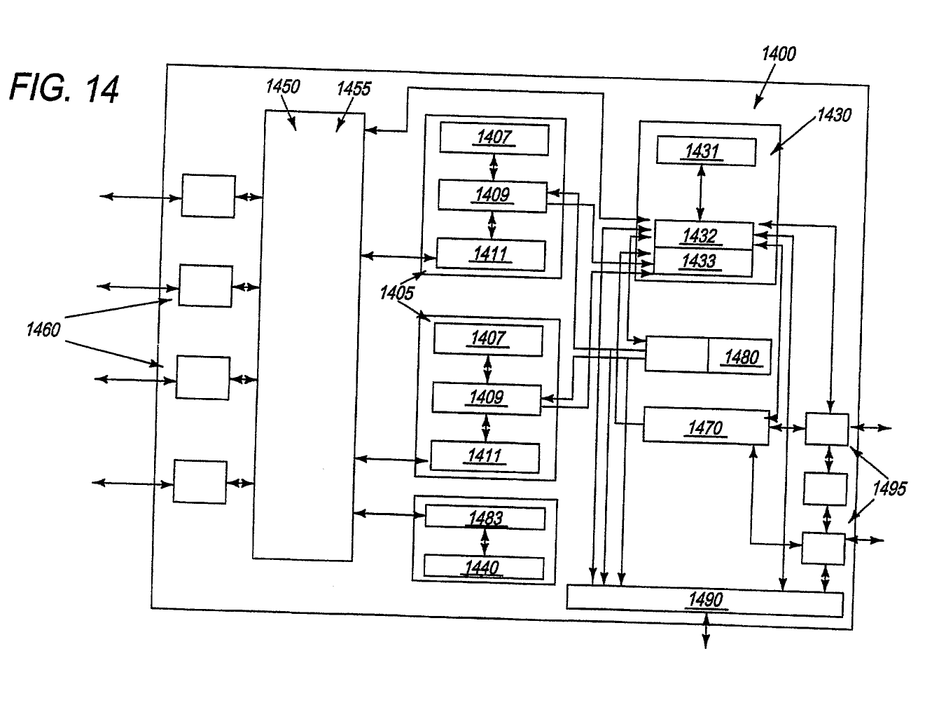

Referring now to FIG. 18, a logical division of the software system 1800 is shown. The software system 1800 is divided into three subsystems, a Media Processing Subsystem 1805, a Packetization Subsystem 1840, and a Signaling/Management Subsystem (hereinafter referred to as the Signaling Subsystem) 1870. The Media Processing Subsystem 1805 sends encoded data to the Packetization Subsystem 1840 for encapsulation and transmission over the network and receives network data from the Packetization Subsystem 1840 to be decoded and played out. The Signaling Subsystem 1870 communicates with the Packetization Subsystem 1840 to get status information such as the number of packets transferred, to monitor the quality of service, control the mode of particular channels, among other functions. The Signaling Subsystem 1870 also communicates with the Packetization Subsystem 1840 to control establishment and destruction of packetization sessions for the origination and termination of calls. Each subsystem 1805, 1840, 1870 further comprises a series of components 1820 designed to perform different tasks in order to effectuate the processing and transmission of media. Each of the components 1820 conducts communications with any other module, subsystem, or system through APIs that remain substantially constant and consistent irrespective of whether the components reside on a hardware element or across multiple hardware elements, as previously discussed.

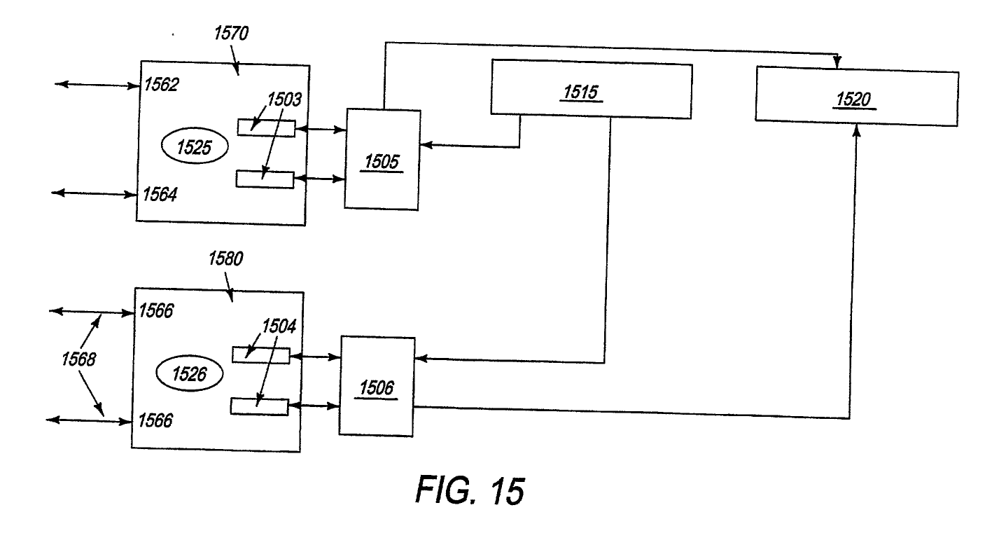

In an exemplary embodiment, shown in FIG. 19, the Media Processing Subsystem 1905 comprises a system API component 1907, media API component 1909, real-time media kernel 1910, and voice processing components, including line echo cancellation component 1911, components dedicated to performing voice activity detection 1913, comfort noise generation 1915, and discontinuous transmission management 1917, a component 1919 dedicated to handling tone signaling functions, such as dual tone (DTMF/MF), call progress, call waiting, and caller identification, and components for media encoding and decoding functions for voice 1927, fax 1929, and other data 1931.

The system API component 1907 should be capable of providing a system wide management and enabling the cohesive interaction of individual components, including establishing communications between external applications and individual components, managing run-time component addition and removal, downloading code from central servers, and accessing the MIBs of components upon request from other components. The media API component 1909 interacts with the real time media kernel 1910 and individual voice processing components. The real time media kernel 1910 allocates media processing resources, monitors resource utilization on each media-processing element, and performs load balancing to substantially maximize density and efficiency.

The voice processing components can be distributed across multiple processing elements. The line echo cancellation component 1911 deploys adaptive filter algorithms to remove from a signal echoes that may arise as a result of the reflection and/or retransmission of modified input signals back to the originator of the input signals. In one preferred embodiment, the line echo cancellation component 1911 has been programmed to implement the following filtration approach: An adaptive finite impulse response (FIR) filter of length N is converged using a convergence process, such as a least means square approach. The adaptive filter generates a filtered output by obtaining individual samples of the far-end signal on a receive path, convolving the samples with the calculated filter coefficients, and then subtracting, at the appropriate time, the resulting echo estimate from the received signal on the transmit channel. With convergence complete, the filter is then converted to an infinite impulse response (IIR) filter using a generalization of the ARMA-Levinson approach. In the course of operation, data is received from an input source and used to adapt the zeroes of the IIR filter using the LMS approach, keeping the poles fixed. The adaptation process generates a set of converged filter coefficients that are then continually applied to the input signal to create a modified signal used to filter the data. The error between the modified signal and actual signal received is monitored and used to further adapt the zeroes of the IIR filter. If the measured error is greater than a pre-determined threshold, convergence is re-initiated by reverting back to the FIR convergence step.

The voice activity detection component 1913 receives incoming data and determines whether voice or another type of signal, i.e. noise, is present in the received data, based upon an analysis of certain data parameters. The comfort noise generation component 1915 operates to send a Silence Insertion Descriptor (SID) containing information that enables a decoder to generate noise corresponding to the background noise received from the transmission. An overlay of audible but non-obtrusive noise has been found to be valuable in helping users discern whether a connection is live or dead. The SID frame is typically small, i.e. approximately 15 bits under the G.729 B codec specification. Preferably, updated SID frames are sent to the decoder whenever there has been sufficient change in the background noise.

The tone signaling component 1919, including recognition of DTMF/MF, call progress, call waiting, and caller identification, operates to intercept tones meant to signal a particular activity or event, such as the conducting of two-stage dialing (in the case of DTMF tones), the retrieval of voice-mail, and the reception of an incoming call (in the case of call waiting), and communicate the nature of that activity or event in an intelligent manner to a receiving device, thereby avoiding the encoding of that tone signal as another element in a voice stream. In one embodiment, the tone-signaling component 1919 is capable of recognizing a plurality of tones and, therefore, when one tone is received, send a plurality of RTP packets that identify the tone, together with other indicators, such as length of the tone. By carrying the occurrence of an identified tone, the RTP packets convey the event associated with the tone to a receiving unit. In a second embodiment, the tone-signaling component 1919 is capable of generating a dynamic RTP profile wherein the RTP profile carries information detailing the nature of the tone, such as the frequency, volume, and duration. By carrying the nature of the tone, the RTP packets convey the tone to the receiving unit and permit the receiving unit to interpret the tone and, consequently, the event or activity associated with it.

Components for the media encoding and decoding functions for voice 1927, fax 1929, and other data 1931, referred to as codecs, are devised in accordance with International Telecommunications Union (ITU) standard specifications, such as G.711 for the encoding and decoding of voice, fax, and other data. An exemplary codec for voice, data, and fax communications is ITU standard G.711, often referred to as pulse code modulation. G.711 is a waveform codec with a sampling rate of 8,000 Hz. Under uniform quantization, signal levels would typically require at least 12 bits per sample, resulting in a bit rate of 96 kbps. Under non-uniform quantization, as is commonly used, signal levels require approximately 8 bits per sample, leading to a 64 kbps rate. Other voice codecs include ITU standards G.723.1, G.726, and G.729 A/B/E, all of which would be known and appreciated by one of ordinary skill in the art. Other ITU standards supported by the fax media processing component 1929 preferably include T.38 and standards falling within V.xx, such as V.17, V.90, and V.34. Exemplary codecs for fax include ITU standard T.4 and T.30. T.4 addresses the formatting of fax images and their transmission from sender to receiver by specifying how the fax machine scans documents, the coding of scanned lines, the modulation scheme used, and the transmission scheme used. Other codecs include ITU standards T.38.

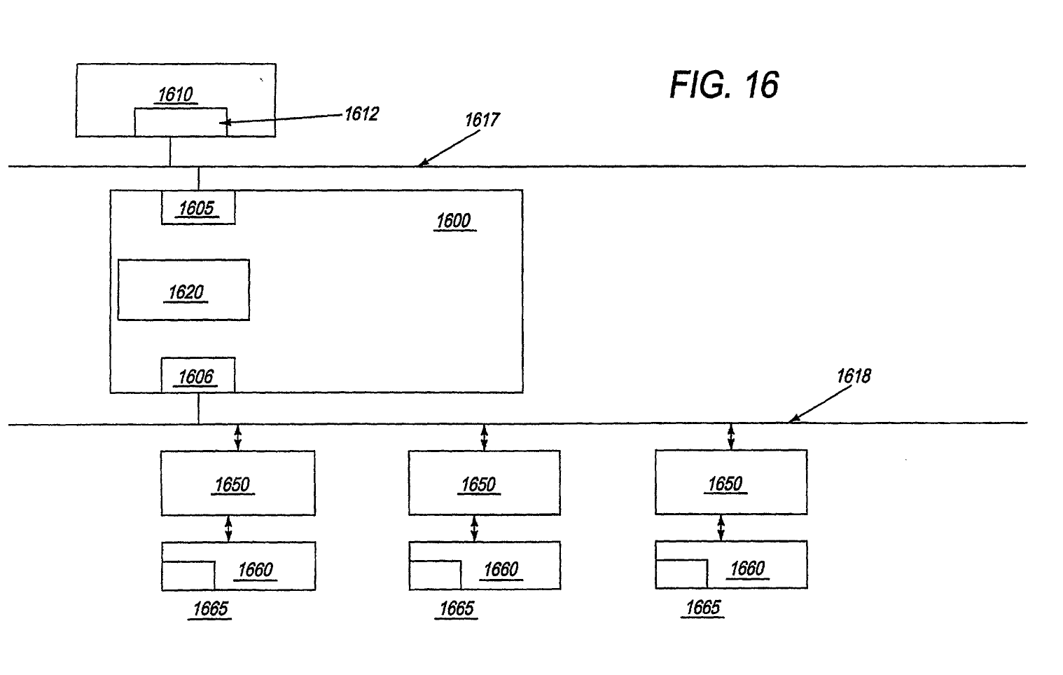

Referring to FIG. 20, in an exemplary embodiment, the Packetization Subsystem 2040 comprises a system API component 2043, packetization API component 2045, POSIX API 2047, real-time operating system (RTOS) 2049, components dedicated to performing such quality of service functions as buffering and traffic management 2050, a component for enabling IP communications 2051, a component for enabling ATM communications 2053, a component for resource-reservation protocol (RSVP) 2055, and a component for multi-protocol label switching (MPLS) 2057. The Packetization Subsystem 2040 facilitates the encapsulation of encoded voice/data into packets for transmission over ATM and IP networks, manages certain quality of service elements, including packet delay, packet loss, and jitter management, and implements trafficshaping to control network traffic. The packetization API component 2045 provides external applications facilitated access to the Packetization Subsystem 2040 by communicating with the Media Processing Subsystem [not shown] and Signaling Subsystem [not shown].

The POSIX API 2047 layer isolated the operating system (OS) from the components and provides the components with a consistent OS API, thereby insuring that components above this layer do not have to be modified if the software is ported to another OS platform. The RTOS 2049 acts as the OS facilitating the implementation of software code into hardware instructions.

The IP communications component 2051 supports packetization for TCP/IP, UDP/IP, and RTP/RTCP protocols. The ATM communications component 2053 supports packetization for AAL1, AAL2, and AAL5 protocols. It is preferred that the RTP/UDP/IP stack be implemented on the RISC processors of the Packet Engine. A portion of the ATM stack is also preferably implemented on the RISC processors with more computationally intensive parts of the ATM stack implemented on the ATM engine.

The component for RSVP 2055 specifies resource-reservation techniques for IP networks. The RSVP protocol enables resources to be reserved for a certain session (or a plurality of sessions) prior to any attempt to exchange media between the participants. Two levels of service are generally enabled, including a guaranteed level which emulates the quality achieved in conventional circuit switched networks, and controlled load which is substantially equal to the level of service achieved in a network under best effort and no-load conditions. In operation, a sending unit issues a PATH message to a receiving unit via a plurality of routers. The PATH message contains a traffic specification (Tspec) that provides details about the data that the sender expects to send, including bandwidth requirement and packet size. Each RSVP-enabled router along the transmission path establishes a path state that includes the previous source address of the PATH message (the prior router). The receiving unit responds with a reservation request (RESV) that includes a flow specification having the Tspec and information regarding the type of reservation service requested, such as controlled-load or guaranteed service. The RESV message travels back, in reverse fashion, to the sending unit along the same router pathway. At each router, the requested resources are allocated, provided such resources are available and the receiver has authority to make the request. The RESV eventually reaches the sending unit with a confirmation that the requisite resources have been reserved.

The component for MPLS 2057 operates to mark traffic at the entrance to a network for the purpose of determining the next router in the path from source to destination. More specifically, the MPLS 2057 component attaches a label containing all of the information a router needs to forward a packet to the packet in front of the IP header. The value of the label is used to look up the next hop in the path and the basis for the forwarding of the packet to the next router. Conventional IP routing operates similarly, except the MPLS process searches for an exact match, not the longest match as in conventional IP routing.

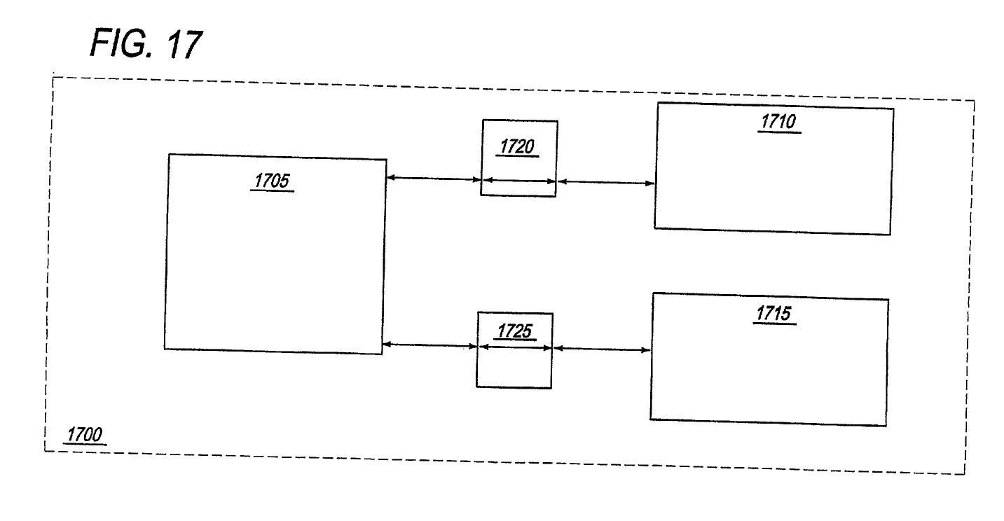

Referring to FIG. 21, in an exemplary embodiment, the Signaling Subsystem 2170 comprises a user application API component 2173, system API component 2175, POSIX API 2177, real-time operating system (RTOS) 2179, a signaling API 2181, components dedicated to performing such signaling functions as signaling stacks for ATM networks 2183 and signaling stacks for IP networks 2185, and a network management component 2187. The signaling API 2181 provides facilitated access to the signaling stacks for ATM networks 2183 and signaling stacks for IP networks 2185. The signaling API 2181 comprises a master gateway and sub-gateways of N number. A single master gateway can have N sub-gateways associated with it. The master gateway performs the demultiplexing of incoming calls arriving from an ATM or IP network and routes the calls to the sub-gateway that has resources available. The sub-gateways maintain the state machines for all active terminations. The sub-gateways can be replicated to handle many terminations. Using this design, the master gateway and sub-gateways can reside on a single processor or across multiple processors, thereby enabling the simultaneous processing of signaling for a large number of terminations and the provision of substantial scalability.

The user application API component 2173 provides a means for external applications to interface with the entire software system, comprising each of the Media Processing Subsystem, Packetization Subsystem, and Signaling Subsystem. The network management component 2187 supports local and remote configuration and network management through the support of simple network management protocol (SNMP). The configuration portion of the network management component 2187 is capable of communicating with any of the other components to conduct configuration and network management tasks and can route remote requests for tasks, such as the addition or removal of specific components.

The signaling stacks for ATM networks 2183 include support for User Network Interface (UNI) for the communication of data using AAL1, AAL2, and AAL5 protocols. User Network Interface comprises specifications for the procedures and protocols between the gateway system, comprising the software system and hardware system, and an ATM network. The signaling stacks for IP networks 2185 include support for a plurality of accepted standards, including media gateway control protocol (MGCP), H.323, session initiation protocol (SIP), H.248, and network-based call signaling (NCS). MGCP specifies a protocol converter, the components of which may be distributed across multiple distinct devices. MGCP enables external control and management of data communications equipment, such as media gateways, operating at the edge of multi-service packet networks. H.323 standards define a set of call control, channel set up, and codec specifications for transmitting real time voice and video over networks that do not necessarily provide a guaranteed level of service, such as packet networks. SIP is an application layer protocol for the establishment, modification, and termination of conferencing and telephony sessions over an IP-based network and has the capability of negotiating features and capabilities of the session at the time the session is established. H.248 provides recommendations underlying the implementation of MGCP.

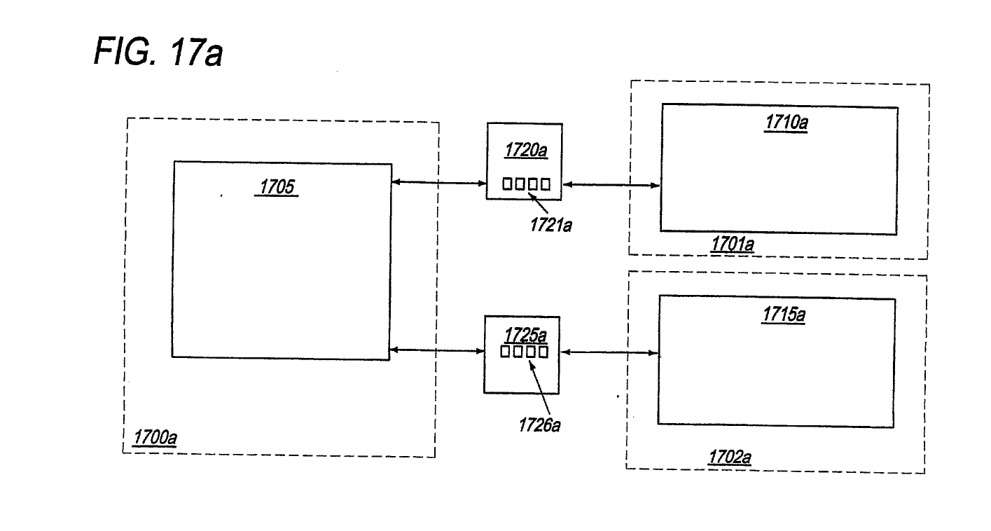

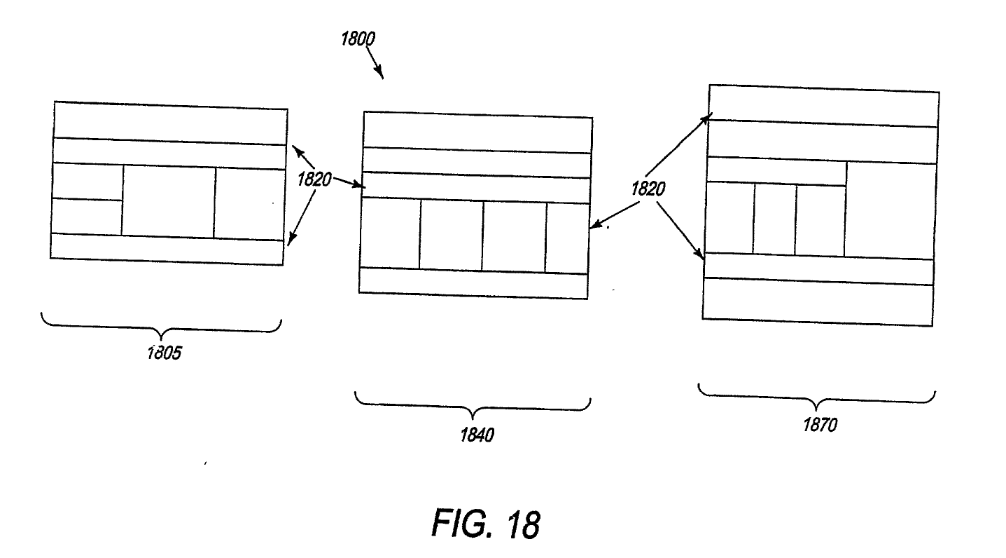

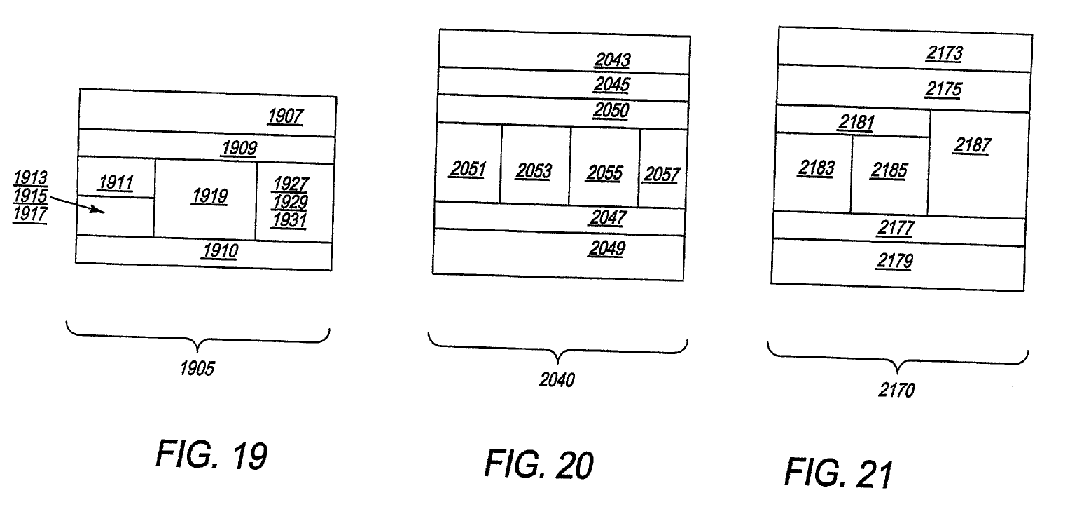

To further enable ease of scalability and implementation, the present software method and system does not require specific knowledge of the processing hardware being utilized. Referring to FIG. 22, in a typical embodiment, a host application 2205 interacts with a DSP 2210 via an interrupt capability 2220 and shared memory 2230. As shown in FIG. 23, the same functionality can be achieved by a simulation execution through the operation of a virtual DSP program 2310 as a separate independent thread on the same processor 2315 as the application code 2320. This simulation run is enabled by a task queue mutex 2330 and a condition variable 2340. The task queue mutex 2330 protects the data shared between the virtual DSP program 2310 and a resource manager [not shown]. The condition variable 2340 allows the application to synchronize with the virtual DSP 2310 in a manner similar to the function of the interrupt 2220 in FIG. 22.

### A Second Exemplary Application

Introduction

Currently, video and audio ports are separate. To connect devices to transmit video, one has to use video cables that are bulky and costly. Moreover, common video cabling, such as VGA and DVI, do not carry audio data. Because VGA is an analog transmission, the length of the cable that can be used, without substantial degradation in the signal, is limited. It would be preferable to use a widely adopted standard, USB and in particular USB 2.0, as a combined audio and video port. The art currently does not provide an integrated chip solution that permits such a use.

The present invention is a system or a chip that supports both video (MPEG2/4, H.264, among others) type of codec as well as a lossless graphics codec. It includes a novel protocol that distinguishes between types of data streams. Specifically, a novel system multiplexer, present at both the encoder side and decoder side, is capable of distinguishing and managing each of the four components in a datastream: video, audio, graphics, and control. The present system is also capable of being real time or non real time, i.e. the encoded stream can be stored for future display or could be streamed over any type of network for real time streaming or non streaming applications. In the present invention, USB interfaces can be used to send standard definition video with audio without compression. Standard definition video with audio, without compression, requires less than 250 Mbps and compressed audio with 248 Kilo bits per second. High definition video can be similarly transmitted using loss-less graphics compression.

Through this innovative approach, a number of applications can be enabled. For example, monitors, projectors, video cameras, set top boxes, computers, digital video recorders, and televisions need only have a USB connector without having any additional requirement for other audio or video ports. Multimedia systems can be improved by integrated graphics or text intensive video with standard video, as opposed to relying on graphic overlays, thereby enabling USB to TV and USB to computer applications and/or Internet Protocol (IP) to TV and IP to computer applications. In the case of using IP communications, the data will be packetized and supported with Quality of Service (QoS) software.

Aside from simplifying and improving connectivity, the present invention enables user applications that, to date, have not been feasible. In one embodiment, the present invention enables the wireless networking of a plurality of devices in the home without requiring a distribution device or router. A device comprising the integrated chip of the present with a wireless transceiver is attached to a port in each of the devices, such as set top box, monitor, hard disk, television, computer, digital video recorder, gaming device (Xbox, Nintendo, Playstation), and is controllable using a control device, such as a remote control, infrared controller, keyboard, or mouse. Video, graphics, and audio can be routed from any one device to any other device using the controller device. The controller device can also be used to input data into any of the networked devices.

Therefore, a single monitor can be networked to a plurality of different devices, including a computer, digital video recorder, set top box, hard disk drive, or other data source. A single projector can be networked to a plurality of different devices, including a computer, digital video recorder, set top box, hard disk drive, or other data source. A single television can be networked to a plurality of different devices, including a computer, set top box, digital video recorder, hard disk drive, or other data source. Additionally, a single controller can be used to control a plurality of televisions, monitors, projectors, computers, digital video recorders, set top boxes, hard disk drives, or other data sources.

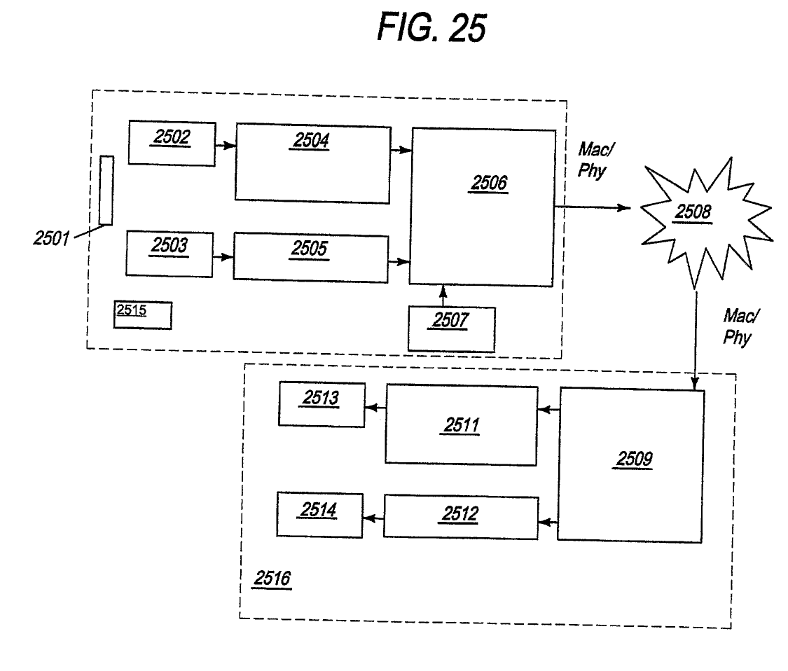

More specifically, referring to FIG. 27, a device 2705 can receive media, including any analog or digital video, graphics or audio media from any source 2701, and control information from any type of controller (infrared, keyboard, mouse) 2703, through any wired or wireless network or direct connection. The device 2705 can then process and transmit the control information from the controller 2703 to the media source 2701 to modify or affect the media being transmitted. The device can also transmit the media to any type of display 2709 or any type of storage device 2709. Each of the elements in FIG. 27 can be local or remote from each other and in data communication via wired or wireless networks or direct connects.

This novel invention therefore enables controllers, media sources, and displays to be completely separate and independent and, further, unites the processing of all media types into a single chip. In one embodiment, a user has a handheld version of device 2705. The device 2705 is a controller that has provides for controller functionality found in at least one of a television remote control, keyboard, or mouse. The device 2705 can combine two, or all three, of television remote control, keyboard, or mouse functionality. The device 2705 includes the integrated chip of the present invention and can optionally include a small screen, data storage, and other functionality conventionally found in a personal data assistant or cellular phone. The device 2705 is in data communication with a user's media source 2701, which can be a computer, set top box, television, digital video recorder, DVD players, or other data source. The user's media source 2701 can be remotely located and accessed via a wireless network. The user's media source 2701 also has the integrated chip of the present invention. The device is also in data communication with a display 2709, which can be any type of monitor, projector or television screen and located in any place, such as a hotel, home, business, airplane, restaurant, or other retail location. The display 2709 also has the integrated chip of the present invention. The user can access any graphic, video or audio information from the media source 2701 and have it displayed on the display 2709. The user can also modify the coding type of the media from the media source 2701 and have it stored in a storage device 2710 which is remotely located and accessible via a wired or wireless network or direct connection. In each of the media source 2701 and display 2709, the integrated chip can either be integrated into the device or externally connected via a port, such as a USB port.

These applications are not limited to the home and can be used in business environments, such as hospitals, for remote monitoring and management of multiple data sources and monitors. The communication network can be any communication protocol. In one application, a security network is established with data from X-ray machines, metal detectors, video cameras, trace detectors, and other data sources controlled by a single controller and transmittable to any networked monitor.

High-Level Architecture

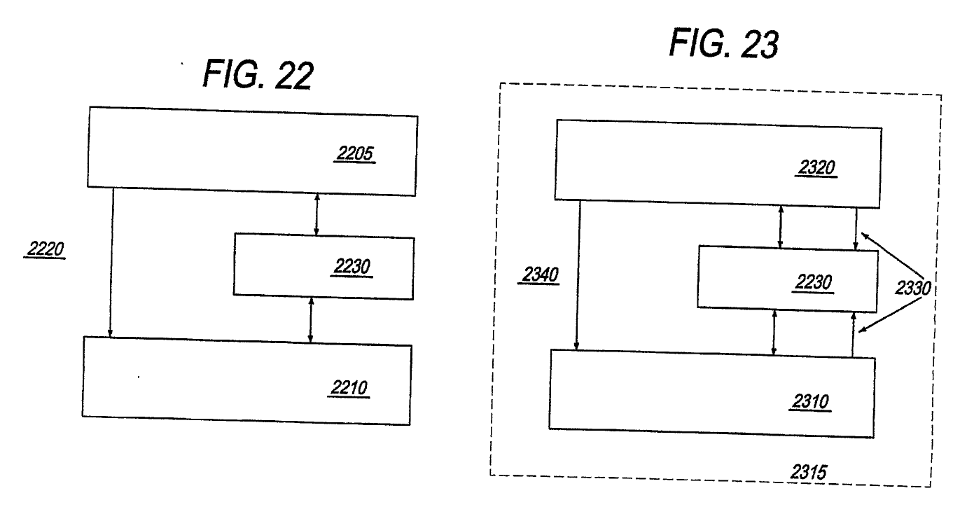

Referring to FIG. 25, a block diagram of a second embodiment 2500 of the present invention is depicted. The system at the transmission end comprises of a media source 2501, such as may be provided by, or integrated within, a Media Processing Device, a plurality of media pre-processing units 2502, 2503, a video and graphics encoder 2504, an audio encoder 2505, a multiplexer 2506 and control unit 2507, collectively integrated into Media Processing Device 2515. The source 2501 transmits graphic, text, video, and/or audio data to the preprocessing units 2502, 303 where it is processed and transferred to the video and graphics encoder 2504 and audio encoder 2505. The video and graphics encoder 2505 and audio encoder 2506 perform the compression or encoding operations on the preprocessed multimedia data. The two encoders 2504, 2505 are further connected to the multiplexer 2506 with a control circuit in data communication thereto to enable the functionality of the multiplexer 2506. The multiplexer 2506 combines the encoded data from video and graphics encoder 2504b and audio encoder 2505 to form a single data stream. This allows multiple data streams to be carried from one place to another over a physical or a MAC layer of any appropriate network 2508.

At the receiving end, the system comprises of demultiplexer 2509, video and graphics decoder 2511, audio decoder 2512 and a plurality of post processing units 2513, 2514, collectively integrated into Media Processing Device 2515. The data present on the network 2508 is received by the demultiplexer 2509 that resolves the high data rate streams into original lower rate streams and converts the data steam into the original multiple streams. The multiple streams are now passed to different decoders i.e. video and graphics decoder 2511 and audio decoder 2512. The respective decoders decompresses the compressed video and graphics and audio data in accordance with appropriate decompression algorithm, preferably LZ77 and supplies them to the post processing units 2513, 2514 that makes the decompressed data ready for display and/or further rendering.

Both Media Processing Devices 2515, 2516 can be hardware modules or software subroutines, but, in the preferred embodiment, the units are incorporated into a single integrated chip. The integrated chip is used as part of a data storage or data transmission system.

Any conventional computer compatible port can be used for the transfer of data with the present integrated system. The integrated chip can be combined with USB port preferably USB 2.0 for faster data transmission. A basic USB connector can therefore be used to transmit all the Visual Media, along with audio, thereby eliminating the need for separate video and graphics interfaces. Standard definition video and high definition video can also be sent over USB without compression or by using loss-less graphic compression.

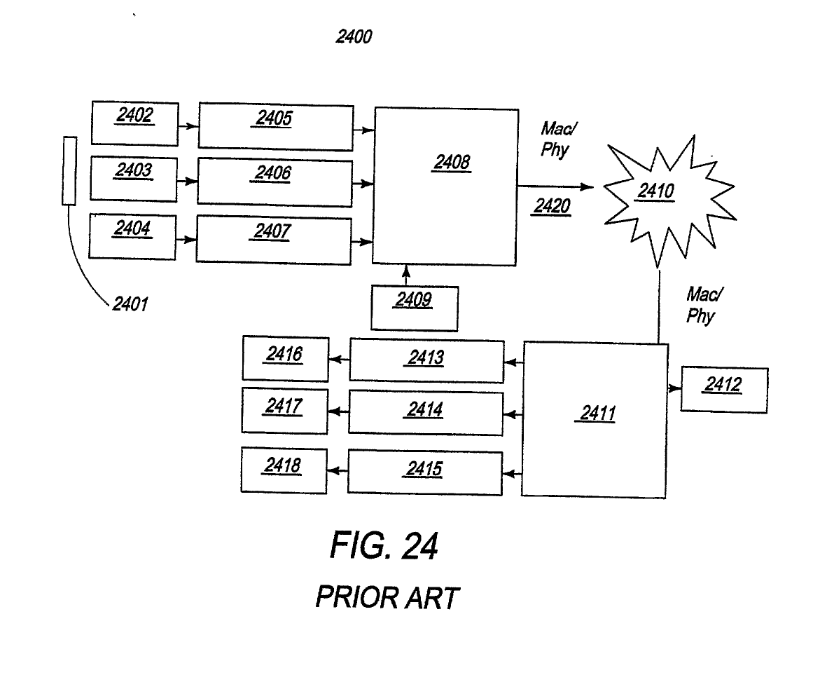

Referring to FIG. 26, the integrated chip 2600 comprises a plurality of processing layers, including a video decoder 2601, video transcoder 2602, graphics codec 2603, audio processor 2604, post processor 2605, and supervisory RISC 2606, and a plurality of interfaces/communication protocols, including audio video input/output (LCD, VGA, TV) 2608, GPIO 2609, IDE (interactive development environment) 2610, Ethernet 2611, USB 2612, and controllers infrared, keyboard, and mouse 2613. The interfaces/communication protocols are placed in data communication with said plurality of processing layers through a non-block cross connect 2607.

The integrated chip 2600 has a number of advantageous features, including SXGA graphics playback, DVD playback, a graphics engine, a video engine, a video post processor, a DDR SDRAM controller, a USB 2.0 interface, a cross connect DMA, audio/video input/output (VGA, LCD, TV), low power, 280 pin BGA, 1600×1200 graphics over IP, remote PC graphics and high definition images, up to 1000× compression, enabled transmission over 802.11, integrated MIPS class CPU, Linux & WinCE support for easy application software integration, security engine for secure data transmission, wired and wireless networking, video & control (keyboard, mouse, remote), and video/graphics post-processor for image enhancement.

Video codecs incorporated herein can include codecs that decode all block-based compression algorithms, such as MPEG-2, MPEG-4, WM-9, H.264, AVS, ARIB, H.261, H.263, among others. It should be appreciated that in addition to the implementation of standards based codecs, the present invention can implement proprietary codecs. In one such application, a low-complexity encoder grabs video frames in a PC, compresses them and transmits them over IP to a processor. The processor operates a decoder that decodes the transmission and displays the PC video on any display, including a projector, monitor or TV. With this low complexity encoder running in the laptop and a processor in communication with a wireless module connected to the TV, people can share PC-based information, such as photos, home movies, DVDs, internet downloaded content, on a large screen TV.

Graphics codecs incorporated herein can include a 1600×1200 graphics encoder and 1600×1200 graphics decoder. Trans-coder enables conversion of any codec to any other codec with high quality using frame rate, frame size, or bit rate conversion. Two simultaneous high definition decodes with picture-in-picture and graphics decode can also be included herein. The present invention further preferably includes programmable audio codec support, such as AC-3, AAC, DTS, Dolby, SRS, MP2, MP3, and wmA. Interfaces can also include 10/100 Ethernet (x2), USB 2.0 (x2), IDE (32-bit PCI, UART, IrDA), DDR, Flash, video, such as VGA, LCD, HDMI (in and out), CVBS (in and out), and S-video (in and out), and audio. Security is also provided using any number of security mechanisms known in the art, including Macrovision 7.1, HDCP, CGMS, and DTCP.

It should be noted that if the video is uncompressed then only a USB port is required at the receiver and an interface to distribute RGB to display and audio to audio decoder. If the video is compressed then a graphics de-compression unit is also required at the receiver. Improved video quality is delivered through post processing techniques such as error concealment, de-blocking, de-interlacing, anti-flicker, scaling, video enhancement, and color space conversion. In particular, video post processing includes intelligent filtering that removes unwanted artifacts, such as jitter.

The novel integrated chip architecture provides for an application-specific distributed datapath, which handles codec calculations, and a centralized microprocessor-based control, which addresses codec-related decisions. The resulting architecture is capable of handling increasing degrees of complexity with respect to coding, higher numbers of codec types, greater amounts of processing requirements per codec, increasing data rate requirements, disparate data quality (noisy, clean), multiple standards, and complex functionality.

The novel architecture can achieve the above described advantages because it has, among other attributes, substantial degrees of processing parallelism. A first level of parallelism comprises a RISC microprocessor that intelligently invokes, or schedules, datapaths to do very specific tasks. A second level of parallelism comprises load switch management functionality that keeps the datapaths fully loaded (to be shown and discussed below). A third level of parallelism comprises the data layers themselves that are sufficiently specialized to perform a specific processing task, such as motion estimation or error concealment (to be shown and discussed below).

Stated differently, in the overall media processor architecture, there are programmable blocks which provide for coarse-grain parallelism (an encode/decode engine that runs the top level control intensive state machine and keeps the programming model very simple), mid-grain parallelism (a media switch that is capable of implementing and scheduling any block DCT based codec for near 100% efficiency) and fine-grain parallelism (the programmable functional units that run the optimized micro-code that run the complex math, i.e. data-path, functions). This unique architecture allows complete programmability at fixed function die size and power.

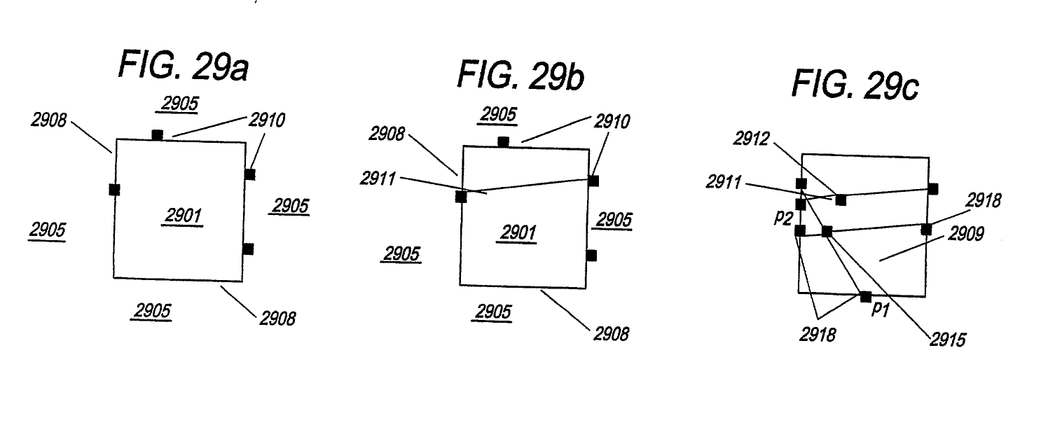

Referring to FIG. 30, another perspective of the integrated chip is provided. The DPLP 3000 comprises a plurality of processing layers 3005 each in communication with each other via communication data buses and in communication with a processing layer controller 3007 and central direct memory access (DMA) controller 3010 via communication data buses and processing layer interfaces 3015. Each processing layer 3005 is in communication with a CPU interface 3006 which, in turn, is in communication with a CPU 3004. Within each processing layer 3005, a plurality of pipelined processing units (PUs) 3030 are in communication with a plurality of program memories 3035 and data memories 3040, via communication data buses. Preferably, each program memory 3035 and data memory 3040 can be accessed by at least one PU 3030 via data buses. Each of the PUs 3030, program memories 3035, and data memories 3040 is in communication with an external memory 3047 via communication data buses.

In a preferred embodiment, the processing layer controller 3007 manages the scheduling of tasks and distribution of processing tasks to each processing layer 3005. The processing layer controller 3007 arbitrates data and program code transfer requests to and from the program memories 3035 and data memories 3040 in a round robin fashion. On the basis of this arbitration, the processing layer controller 3007 fills the data pathways that define how units directly access memory, namely the DMA channels [not shown]. The processing layer controller 3007 is capable of performing instruction decoding to route an instruction according to its dataflow and keep track of the request states for all PUs 3030, such as the state of a read-in request, a write-back request and an instruction forwarding. The processing layer controller 3007 is further capable of conducting interface related functions, such as programming DMA channels, starting signal generation, maintaining page states for PUs 3030 in each processing layer 3005, decoding of scheduler instructions, and managing the movement of data from and into the task queues of each PU 3030. By performing the aforementioned functions, the processing layer controller 3007 substantially eliminates the need for associating complex state machines with the PUs 3030 present in each processing layer 3005.

The DMA controller 3010 is a multi-channel DMA unit for handling the data transfers between the local memory buffer PUs and external memories, such as the SDRAM. Each processing layer 3005 has independent DMA channels allocated for transferring data to and from the PU local memory buffers. Preferably, there is an arbitration process, such as a single level of round robin arbitration, between the channels within the DMA to access the external memory. The DMA controller 3010 provides hardware support for round robin request arbitration across the PUs 3030 and processing layers 3005. Each DMA channel functions independently of one another. In an exemplary operation, it is preferred to conduct transfers between local PU memories and external memories by utilizing the address of the local memory, address of the external memory, size of the transfer, direction of the transfer, namely whether the DMA channel is transferring data to the local memory from the external memory or vice-versa, and how many transfers are required for each PU 3030. The DMA controller 3010 is preferably further capable of arbitrating priority for program code fetch requests, conducting link list traversal and DMA channel information generation, and performing DMA channel prefetch and done signal generation.

The processing layer controller 3007 and DMA controller 3010 are in communication with a plurality of communication interfaces 3060, 3090 through which control information and data transmission occurs. Preferably the DPLP 3000 includes an external memory interface (such as a SDRAM interface) 3070 that is in communication with the processing layer controller 3007 and DMA controller 3010 and is in communication with an external memory 3047.

Within each processing layer 3005, there are a plurality of pipelined PUs 3030 specially designed for conducting a defined set of processing tasks. In that regard, the PUs are not general purpose processors and can not be used to conduct any processing task. A survey and analysis of specific processing tasks yielded certain functional unit commonalities that, when combined, yield a specialized PU capable of optimally processing the universe of those specialized processing tasks. The instruction set architecture of each PU yields compact code. Increased code density results in a decrease in required memory and, consequently, a decrease in required area, power, and memory traffic.

It is preferred that, within each processing layer, the PUs 3030 operate on tasks scheduled by the processing layer controller 3007 through a first-in, first-out (FIFO) task queue [not shown]. The pipeline architecture improves performance. Pipelining is an implementation technique whereby multiple instructions are overlapped in execution. In a computer pipeline, each step in the pipeline completes a part of an instruction. Like an assembly line, different steps are completing different parts of different instructions in parallel. Each of these steps is called a pipe stage or a data segment. The stages are connected on to the next to form a pipe. Within a processor, instructions enter the pipe at one end, progress through the stages, and exit at the other end. The throughput of an instruction pipeline is determined by how often an instruction exits the pipeline.

Additionally, within each processing layer 3005 is a set of distributed memory banks 3040 that enable the local storage of instruction sets, processed information and other data required to conduct an assigned processing task. By having memories 3040 distributed within discrete processing layers 3005, the DPLP 3000 remains flexible and, in production, delivers high yields. Conventionally, certain DSP chips are not produced with more than 9 megabytes of memory on a single chip because as memory blocks increase, the probability of bad wafers (due to corrupted memory blocks) also increases. In the present invention, the DPLP 3000 can be produced with 12 megabytes or more of memory by incorporating redundant processing layers 3005. The ability to incorporate redundant processing layers 3005 enables the product of chips with larger amounts of memory because, if a set of memory blocks are bad, rather than throw the entire chip away, the discrete processing layers within which the corrupted memory units are found can be set aside and the other processing layers may be used instead. The scalable nature of the multiple processing layers allows for redundancy and, consequently, higher production yields.

In one embodiment, the DPLP 3000 comprises a video encode processing layer 105 and a video decode processing layer 105. In another embodiment, the DPLP 3000 comprises a video encode processing layer 105, a graphics processing layer 105, and a video decode processing layer 105. In another embodiment, the DPLP 3000 comprises a video encode processing layer 105, a graphics processing layer 105, a post processing layer 105, and a video decode processing layer 105. In another embodiment, the interfaces 160, 190 comprise DDR, memory, various video inputs, various audio inputs, Ethernet, PCI E, EMAC, PIO, USB, and any other data input known to persons of ordinary skill in the art.

Video Processing Units

In one embodiment, the video processing unit, shown as a layer in FIG. 30, has at least one layer of PUs in data communication with data and program memories. A preferred embodiment has three layers. Each layer has at least one or more of the following individual PUs: motion estimation (ME), discrete cosine transformation (DCT), quantization (QT), inverse discrete cosine transform (IDCT), inverse quantization (IQT), de-blocking filter (DBF), motion compensation (MC), and arithmetic coding (CABAC). It should be appreciated that CABAC is only an example of coding and the present invention can also be performed using VLC coding, CAVLC coding, or any other form of coding. In one embodiment, each layer has all of the aforementioned PUs with two motion estimation PUs. In another embodiment, the video encoding processing unit comprises three layers with each layer having all of the aforementioned PUs with two motion estimation PUs. The aforementioned PUs can be implemented as hardwired units or application specific DSPs. Preferably, the DCT, QT, IDCT, IQT, and DBF are hardwired blocks because these functions do not vary substantially from one standard to another.

In another embodiment, the video decoding processing unit, shown as a layer in FIG. 30, has three layers of PUs in data communication with data and program memories. Each layer has the following PUs: inverse discrete cosine transform (IDCT), inverse quantization (IQT), de-blocking filter (DBF), motion compensation (MC), and arithmetic coding (CABAC). The aforementioned PUs can be implemented as hardwired units or application specific DSPs. Preferably, the IDCT, IQT, and DBF are hardwired blocks because these functions do not vary substantially from one standard to another. The CABAC and MC PUs are dedicated and fully programmable DSPs on which runs specific functions that perform arithmetic coding and motion compensation, respectively.

The ME PU are datapath centric DSPs with VLIW instruction set. The ME PU is capable of performing exhaustive motion search at quarter pixel resolution on one reference frame each. In an embodiment where two ME PUs operate in parallel, the chip can perform a full search on two reference frames with a fixed window size and variable macro block size.

The MC PU is a simplified version of the ME PU that does motion compensation during the reconstruction phase of the encoding process. The output of the MC is stored back to the memory and used as a reference frame for the next frame. The control unit of the MC PU is similar to the ME, but supports only a subset of the instruction set. This is done to reduce the cell count and complexity of the design.

CABAC is another DSP that is capable of doing different types of entropy coding.

In addition to these processing units, each layer has interfaces with which the layer control engine communicates to move data between the external memory and program data memories. In one embodiment, there are four interfaces (ME1 IF, ME2 IF, MC IF, and CABAC IF). Before scheduling any task, the control engine initiates a data fetch by requesting the corresponding interface to arbitrate and transfer data from the external memory to its internal data memory. The requests generated by the interfaces are arbitrated first through a round robin arbiter that issues grants to one of the initiator. The wining interface finally moves the data using main DMA in the direction, which is indicated by the layer control engine.

The layer control engine receives tasks from the DSP, which runs the main encode state machine, on a frame basis. There is a task queue inside the layer control engine. Each time the main DSP schedules a new task, it first looks at the status flags of the queue first. If the full flag is not set, it will push the new task into the queue. The layer control engine, on the other hand, samples the empty flag to determine if there is any task pending in the queue to be processed. If there is one, it will pop from the top of the queue and process it. The task will contain information about the pointers for the reference and the current frames in the external memory. The layer control engine uses this information to compute the pointers for each region of data that is currently being processed. The data that is fetched is usually in chunks to improve the external memory efficiency. Each chunk contains data for multiple macro blocks. The data is moved into one of the two memory banks connected with each engine in a ping-pong fashion. Similarly, the processed data and the reconstructed frame are stored back to the memory using the interface and the DMA in the write-out direction.

In one embodiment, the video processing layer is a video encoding layer. It receives periodic tick interrupts from the video input/output block at 33.33 msec intervals. In response to each interrupt, it invokes the scheduler. When the scheduler is invoked, the following actions are taken:
1. It computes the pointers to the external memory, where the reference and current frames are stored.
2. It determines the parameters that are specific to the type of the CODEC running.
3. Prior to dispatching any instructions, the scheduler determines if the layer control engine has raised its full flag. If not, it will push the task in its queue and wait for the next tick interrupt.

The layer control engine samples the empty flag samples the empty flag to determine if there is any task pending in the queue to be processed. If there is one, it will pop from the top of the queue and process it. The task will contain information about the pointers for the reference and the current frames in the external memory. The layer control engine uses this information to compute the pointers for each region of data that is currently being processed and the data size to be fetched. It saves the corresponding information in its internal data memory. The data that is fetched is usually in chunks to improve the external memory efficiency. It writes the destination and the source address to the ME IF along with the direction bit and the size of the data. It then sets the start bit. Without waiting for the data transfer to finish, it determines the pending data transfer requests for other engines. If it does, it repeats the aforementioned steps for each of them.

Since the ME and MC PUs work at the macro block level, the layer control engine splits up tasks and feeds the data and relevant information to the PUs at that level. The data that is fetched from external memory contains multiple macro blocks. Therefore, the layer control engine has to keep track of the location of the current macro block in the internal data memory. It sets off the PU with the start bit and the pointer to the current macro block after it determines that the data to be processed is present in the data memory. The PU sets the done bit after it completes the processing. The layer control engine reads the done bit and checks for the next current macro block. If it is present, it will schedule the task for the engine; otherwise, it will fetch in the new data first by providing the interface with the right pointers.

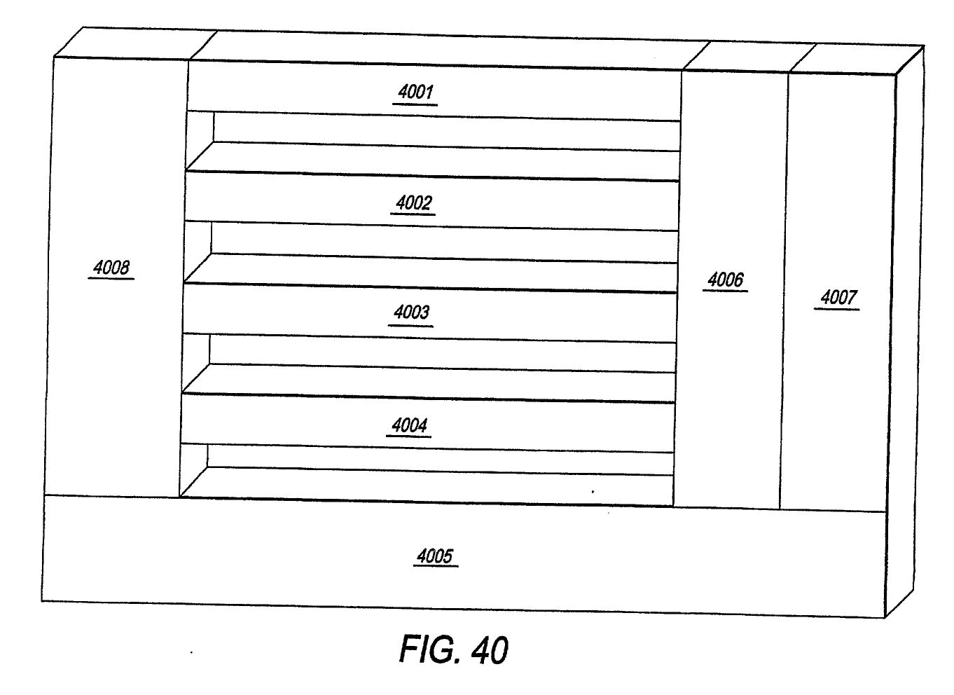

In another embodiment, referring to FIG. 40, a block diagram of a video processing layer of the present invention is depicted. The video processor comprises of Motion Estimation Processor 4001, DCT/IDCT Processor 4002, Coding Processor 4003, Quantization Processor 4004, Memory 4005, Media Switch 4006, DMA 4007 and RSIC Scheduler 4008. Operationally, motion estimation processor 4001 is used to avoid redundant processing of subsampled interpolated data and to reduce the memory traffic. Motion estimation and compensation are temporal compression functions and eliminate the temporal redundancy of the original stream by removing identical pixels in the stream. They are repetitive functions with high computational requirements, and they include intensive reconstructive processing, such as inverse discrete cosine transformation, inverse quantization, and motion compensation.

The DCT/IDCT processor 4002 then performs a two-dimensional DCT on the video and provides the transformed video to the quantization processor 4004 after removing the spatial redundancy of the data by transforming the data into a matrix of DCT coefficients. The DCT matrix values represent intraframes that correspond to reference frames. After discrete cosine transformation, many of the higher frequency components, and substantially all of the highest frequency components approach zero. The higher frequency terms are dropped. The remaining terms are coded by any suitable variable length compression, preferably LZ77 compression. The quantization processor 4004 then divides each value in the transformed input by a quantization step, with the quantization step for each coefficient of the transformed input being selected from a quantization scale. The coding processor 4003 stores the quantization scale and the media switch 4006 handles the task of scheduling and load balancing and it is preferably a micro-coded hardware Real Time Operating System. DMA helps in direct access of the memory and sometimes without the aid of the processor.

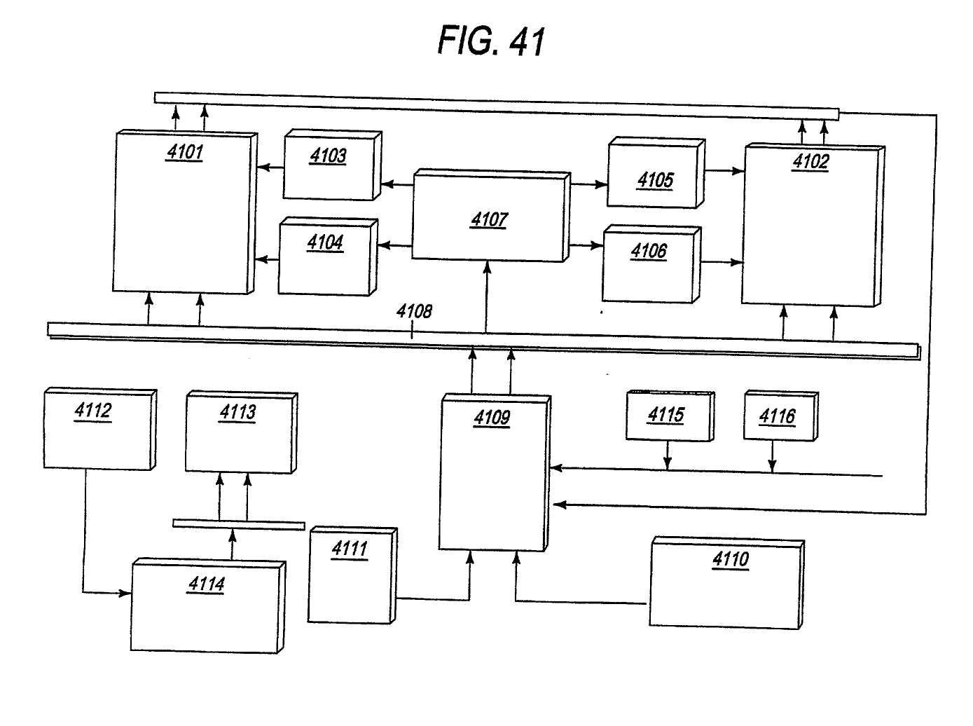

Referring to FIG. 41, a block diagram of the motion estimation processor of the present invention is depicted. The motion estimation processor 4100 comprises of array of processing elements 4101, 4102, data memory 4103, 4104, 4105, 4106, address generation unit (AGU) 4107 and a data bus 4108. The data bus 4108 further connects register file 4109 (16*32), address register 4110 (16*14), data register pointer file 4111, program control 4112, instruction dispatch and control 4113 and program memory 4114. Pre-Shift 4115 and Digital Audio Broadcasting (DAB) 4116 are also connected to the register file 4109. DAB is the standard format on the Internet for quality video.

The arrays of processing elements preferably two, 4101, 4102 exchange data via buses between the register files 4109 and a dedicated data bus 4108 that connects the first array of processing elements 4101, address generation unit 4107, second array of processing element 4101, 4102 and the register file 4109. The program control 4112 organizes the flow of entire program and binds rest of the modules together.

The control unit is preferably implemented as a micro-coded state machine. The program control 4112 along with the program memory 4114 and instruction dispatch and control register 4113 supports multi level nested loop control, branching and subroutine control. The AGU 4107 performs effective address calculations necessary for fetching operands from memory. It can generate and modify two 18-bit addresses in one clock cycle. AGU uses integer arithmetic to compute addresses in parallel with other processor resources to minimize address-generation overhead. The address register file consists of 16*14-bit registers, each of which can be controlled independently to act as temporary data registers or as indirect memory pointers. The value in the register can be modified from the data in the memory; result calculated from address AGU 4107 and constant value from the instruction dispatch and control register 4113.

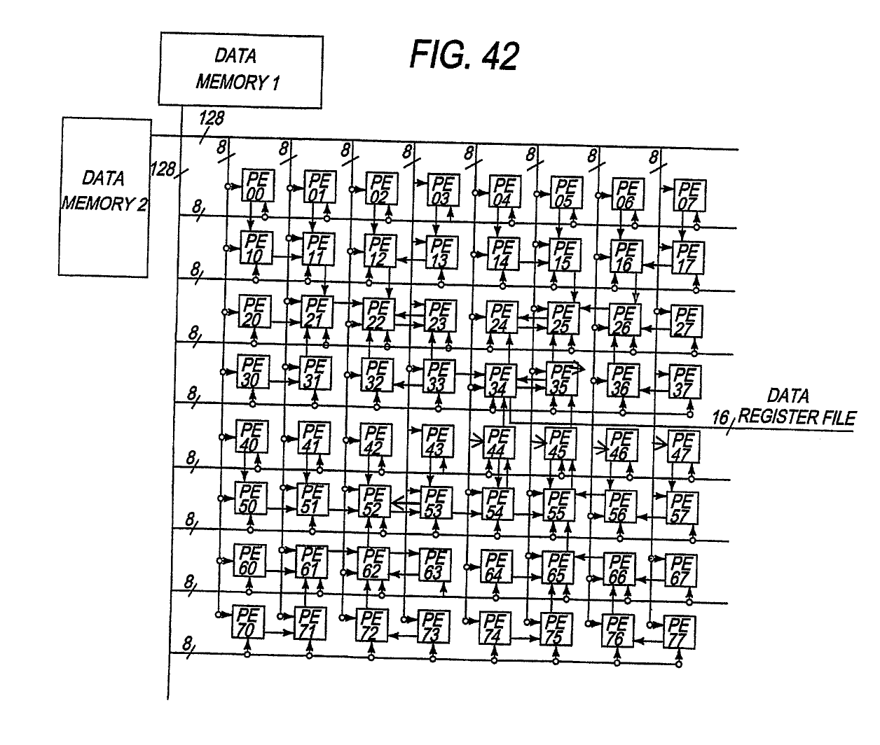

Referring to FIG. 42, a mesh-connected array of processing elements of the abovementioned motion estimation processer is depicted. It contains an 8×8 mesh-connected array of processing elements, which execute instructions issued by the instruction controller. A wide class of low-level image processing algorithms can be implemented efficiently, exploiting inherent fine-grain parallelism of these tasks. When executing image-processing algorithms, a single processing element is associated with a single pixel in the image.

Operationally, each image is divided into frames, which is then divided into blocks, each of which consists of luminance and chrominance blocks using the array of processing elements. Motion estimation is performed only on the luminance block for coding efficiency. Each luminance block in the current frame is matched against the potential blocks in a search area on the reference frame with the help of data memory and register file. These potential blocks are just the displaced versions of original block. The best (lowest distortion, i.e., most matched) potential block is found and its displacement (motion vector) is recorded and the input frame is subtracted from the predicted reference frame. Consequently the motion vector and the resulting error can be transmitted instead of the original luminance block; thus interframe redundancy is removed and data compression is achieved. At the receiver end, the decoder builds the frame difference signal from the received data and adds it to the reconstructed reference frames. The summation gives an exact replica of the current frame. The better the prediction the smaller the error signal and hence the transmission bit rate.

Any appropriate block matching algorithms may be used, including three-step search, 2D-logarithmic search, 4-TSS, orthogonal search, cross search, exhaustive search, diamond search, and new three-step search.

Once the interframe redundancy is removed, the frame difference is processed to remove spatial redundancy using a combination of discrete cosine transformation (DCT), weighting and adaptive quantization.

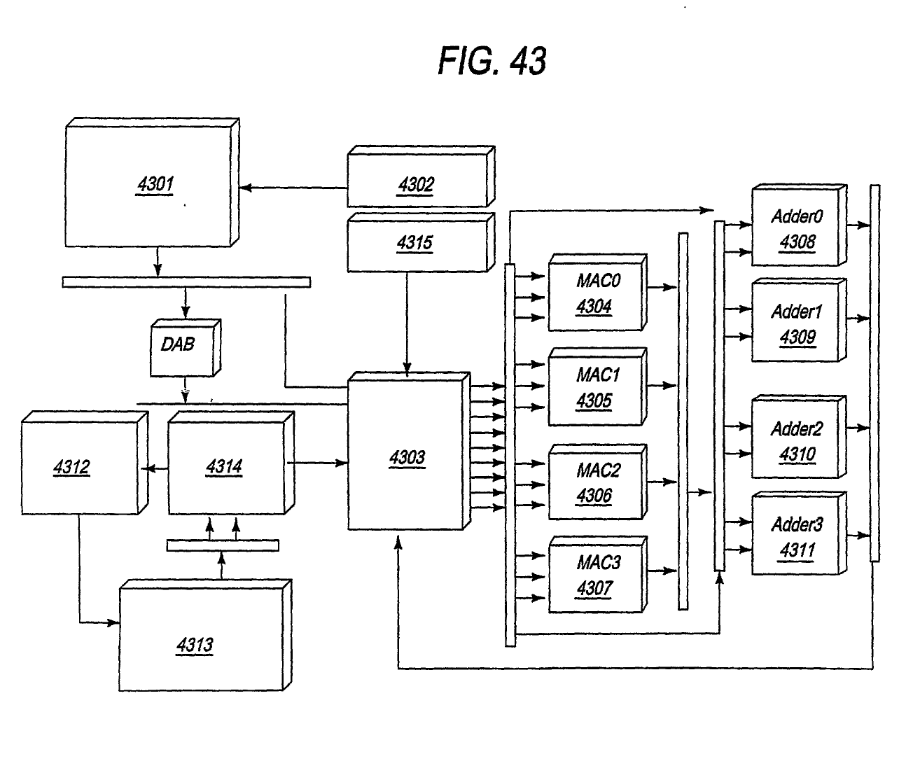

Referring to FIG. 43, a block diagram of the DCT/IDCT processor of the present invention is depicted. The DCT/IDCT processor 4300 comprises of data memory 4301, which is connected to the address generation unit 4302 and register file 4303. The register file 4303 output its data to plurality of multiply and accumulate (MAC) units 4304, 4305 that further transmits data to the adders 4307-4310. The program control 4311, program memory 4312 and instruction dispatch and control 4313 unit are interconnected. The address register 4314 and instruction dispatch and control unit 4313 transfers their output to the register file 4303.

Data Memory 4301 generally incorporates all of the register memories and, via register file 4303, provides addressed and selected data values to the MAC 4304-4307 and adder 4308-4311. The register file 4303 accesses the memory 4301 for selecting data from one of the register memories. Selected data from the memory is provided to both the MAC 4304-4307 and adder for performing a butterfly calculation for DCT. Such butterfly calculations are not performed on the front end for IDCT operations, where the data bypasses the adder.

In order to reduce the bit-rate, 8*8 DCT (discrete cosine transform) is used to convert the blocks into the frequency domain for quantization. The first coefficient (0 frequency) in an 8*8 DCT block is called the DC coefficient; the remaining 63 DCT-coefficients in the block are called AC coefficients. The DCT-coefficients blocks are quantized, scanned into a 1-D sequence, and coded by using LZ77 compression. For predictive coding in which motion compensation (MC) is involved, inverse-quantization and IDCT are needed for the feedback loop. The blocks are typically coded in VLC, CAVLC, or CABAC. A 4×4 DCT may also be used.

The output of the register file provides data values to each of the four and similar MACs (MAC 0, MAC 1, MAC 2, MAC 3). The outputs of the MACs are provided to select logic, which is provided to the input of the register file. The select logic also has outputs coupled to the input of a 4 adder 1608-1611. The outputs of the 4 adder are coupled to the bus for providing data values to the register file 4303.

The select logic of the register file 4303 is controlled by the processor and provide data values from the MACs 4304-4307 to four adders 4308-4311 during IDCT operations, and data values directly to the bus during DCT, quantization and inverse quantization operations. For IDCT operations, respective data bytes are provided to the 4 adder for performing butterfly calculations prior to being provided back to the memory 4301. The particular flow of data and the functions performed depends upon the particular operation being performed, as controlled by the processor. The processors perform the DCT, quantization, inverse quantization and IDCT operations all using the same MACs 4304-4307.

### Graphics and Video Compression

Video can be viewed as a sequence of pictures displayed one after the other such that they give the illusion of motion. For video that gets displayed on a PAL television (720×576 resolution), each frame is 414,720 pixels and if 3 bytes are used for representing color (red, blue, and green), then frame size is 1.2 MB. If the display speed is 30 fps (frames per second), then bandwidth required is 35.6 MB/sec. Such a huge bandwidth requirement would clog any digital network for video distribution. Hence, there is a need for compression solutions to store and transmit large amounts of video.

The analog-to-digital conversion in consumer electronics and the demand for streaming media applications over IP is driving the growth of video compression solutions. Encoding and decoding solutions are currently offered in either software or hardware for MPEG-1, MPEG-2 and MPEG-4. currently, digital images and digital video are always compressed in order to save space on hard disks and to make transmission faster. Typically the compression ratio ranges from 10 to 100. An uncompressed image with a resolution of 640×480 pixels is approximately 600 KB (2 bytes per pixel). A compression of 25 times the image will create a file of approximately 25 KB.

There are many compression standards to choose from. Cameras using still image standards send single images over the network. Cameras using video standards send still images mixed with data containing the changes. This way, non-changing data such as the background is not sent in every image. The refresh rate is referred to as frames per second, fps. One popular still image and video coding compression standard is JPEG. JPEG is designed for compressing either full color or gray-scaled images of “natural”, real-world scenes. It does not work so well on non-realistic images, such as cartoons or line drawings. JPEG does not handle compression of black-and-white (1 bit-per-pixel) images or motion pictures. A compression technique for moving images that applies JPEG still image compression to each frame of a moving picture sequence is referred to as Motion JPEG. JPEG-2000 gives reasonable quality down to 0.1 bits/pixel but quality drops dramatically below about 0.4 bits/pixel. It is based on wavelet, and not JPEG, technology.

The wavelet compression standard can be used for images containing low amounts of data. Therefore the images will not be of the highest quality. Wavelet is not standardized and requires special software. GIF is a standard digitized images compressed with the LZW algorithm. GIF is a good standard for images that are not complex, e.g. logos. It is not recommended for images captured by cameras because the compression ratio is limited.

H.261, H.263, H.321, and H.324 are a set of standards designed for video conferencing and is sometimes used for network cameras. The standards give a high frame rate, but a very low image quality when the image contains large moving objects. Image resolution is typically up to 352×288 pixels. As the resolution is very limited, newer products do not use this standard.

MPEG 1 is a standard for video. While variations are possible, when MPEG 1 is used, it typically gives a performance of 352×240 pixels, 30 fps (NTSC) or 352×288 pixels, 25 fps (PAL). MPEG 2 yields a performance of 720×480 pixels, 30 fps (NTSC) or 720×576 pixels, 25 fps (PAL). MPEG 2 requires a lot of computing capacity. MPEG 3 typically has a resolution of 352×288 pixels, 30 fps with max rate of 1.86 Mbit/sec. MPEG 4 is a video compression standard that extends the earlier MPEG-1 and MPEG-2 algorithms with synthesis of speech and video, fractal compression, computer visualization and artificial intelligence-based image processing techniques.

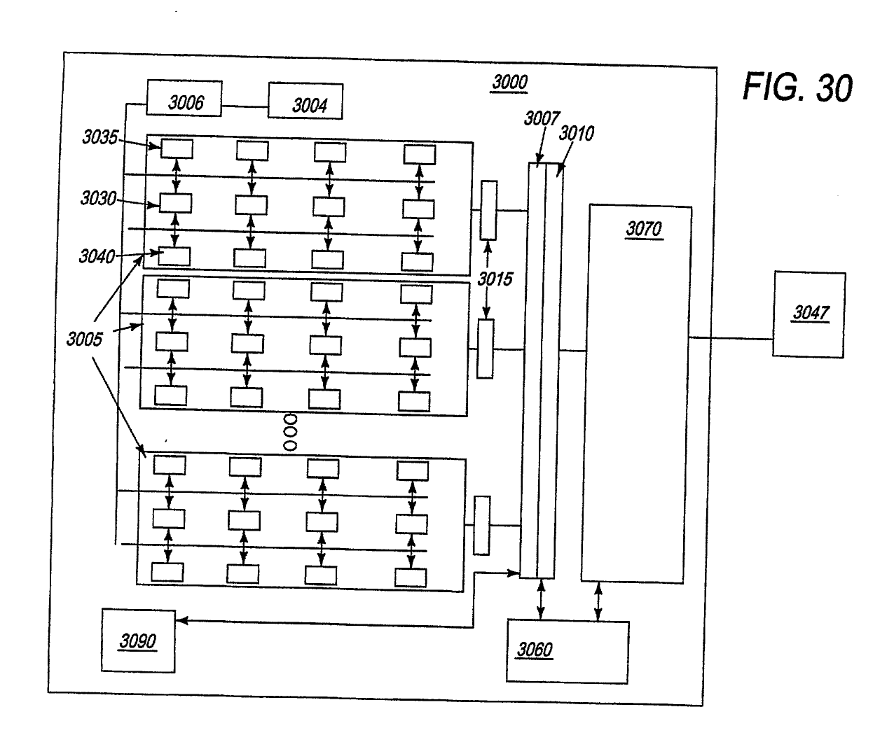

Referring to FIG. 31, another embodiment of the integrated chip applicable for the unified processing of video, text, and graphic data is depicted. The chip comprises of VGA controller 3101, buffer0 3101 and buffer1 3102, configuration and control registers 3104, DMA Channe10 3105, DMA Channe11 3106, SRAM0 3107 and SRAM1 3108 which act as compressor input buffer, KFID and Noise Filter 3109, LZ77 compressor 3110, quantizer 3111, output buffer control 3112, SRAM2 3113, SRAM3 3114 which act as compressor output buffers 3115, MIPS Processor 3116 and ALU 3117. The VGA controller preferably operates in the range of 12-12.5 MHz

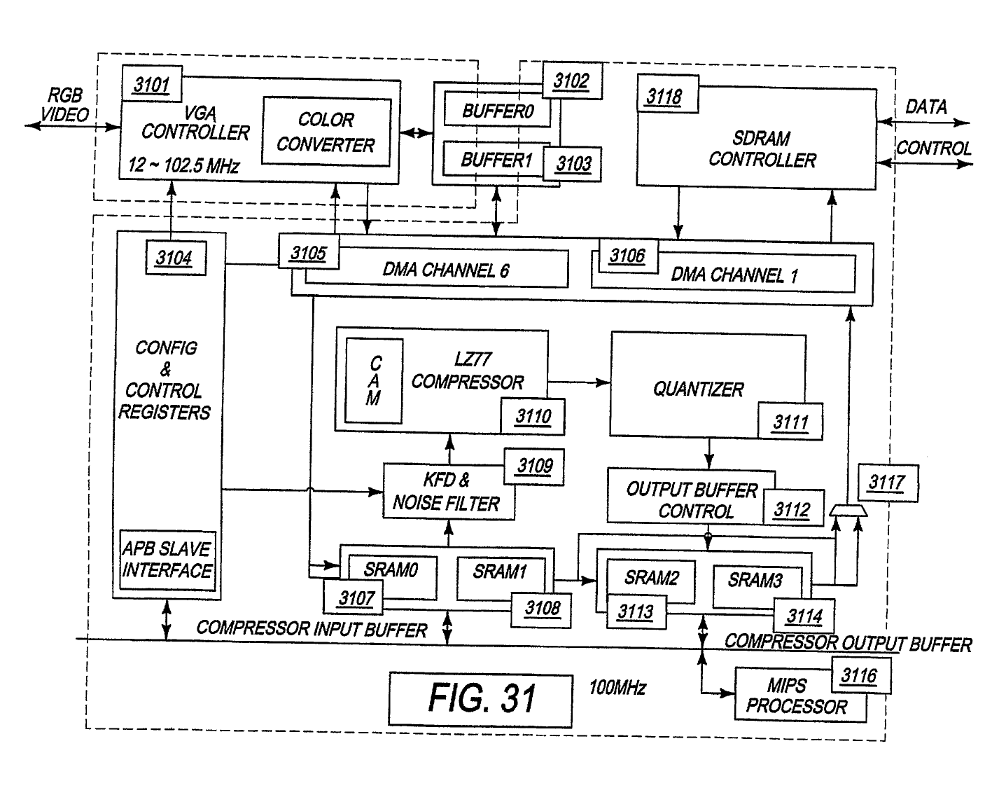

Referring to FIG. 32, a detailed data flow of an exemplary single chip architecture of the present invention is depicted. The RGB video 3201 is received by the VGA controller 3202 and color converter 3203. The data is then sent to the buffer 3206 for temporary storage and at least a portion of the data is then passed to Direct Memory Access (DMA) channel 0 507 and/or to DMA channel 1 3208 at a high speed, preferably without the intervention of the microprocessor. The SDRAM controller 3209 then schedules, directs and/or guides the transfer of at least a portion of the data to the SRAM 0 510d and/or SRAM1 3211. Both SRAM0 3210 and SRAM1 3211 act as input buffer for compressor. The SRAM then transfers the data to the KFD (Kernel Fisher Discriminant) and Noise Filter 3212d where undesired signal and noise is reduced in the input video before it is compressed. Once the unwanted signals are removed the data is then transferred to Content Addressable Memory (CAM) 3213 in combination with a compression unit, preferably a LZ77 based compression unit 3214. Using an appropriate algorithm preferably LZ77 algorithm, the CAM 3213 and compression unit 3214 compress the video data. The quantizer 3215 in accordance with the appropriate voltage levels then quantizes the compressed data. The data is then temporarily stored in the output buffer control 3216 and is then transferred to DMA 3208 via SRAM 3217. The DMA 3208 then transfers the quantized compressed data to the SDRAM controller 3209. The SDRAM controller 3209 then transfers the data to the SRAM 3217 and MIPS Processor 3219.

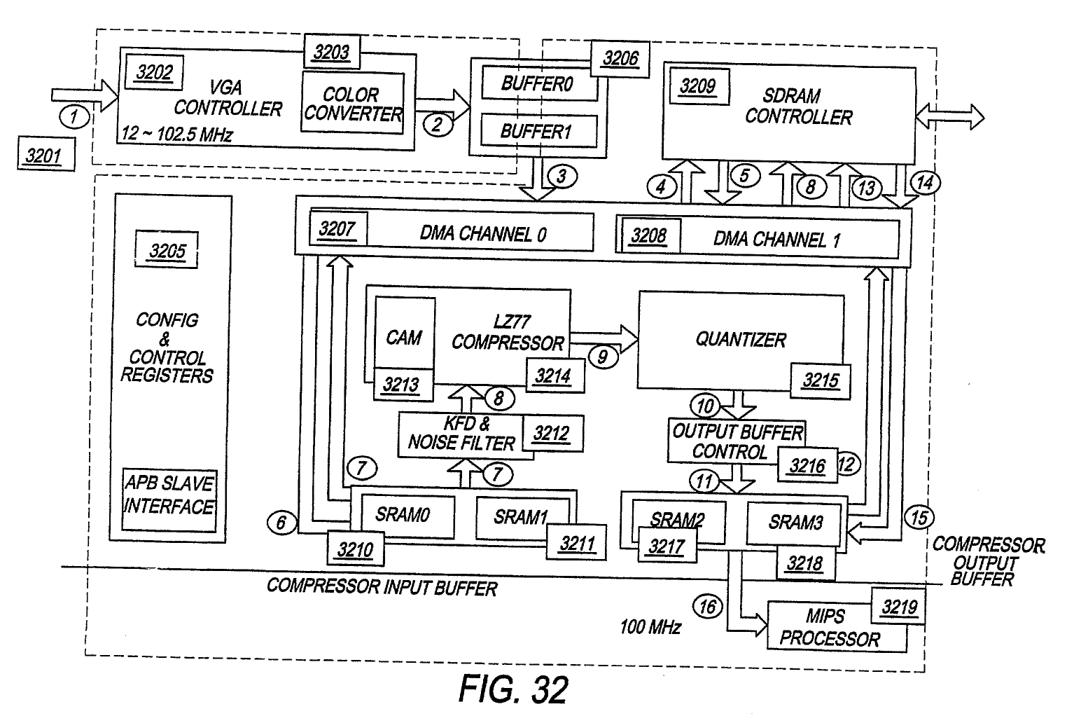

Referring to FIG. 33, a flowchart depicts one embodiment of a plurality of states achieved during the compression of the video in the above-described chip architecture. The video is converted 3301 from analog to digital frames using appropriate A2D (analog to digital converter). Once the frame is enabled 3302 the VGA captures 3303 the frame and converts 3304 the color space via color converter attached to the VGA. The captured frame is then written 3305 to the SDRAM. The previously stored frame and current frames are read 3306 from the SDRAM and, after calculating their difference and removing 3307 their noise, they are made ready for compression. The LZ77 compressor compresses 3308 the frame and the compressed frames are then quantized 3309 by the quantizer. The quantized compressed frames are then finally written 3310 to the SDRAM from where it can be retrieved 3311 for appropriate rendering or transmitted.

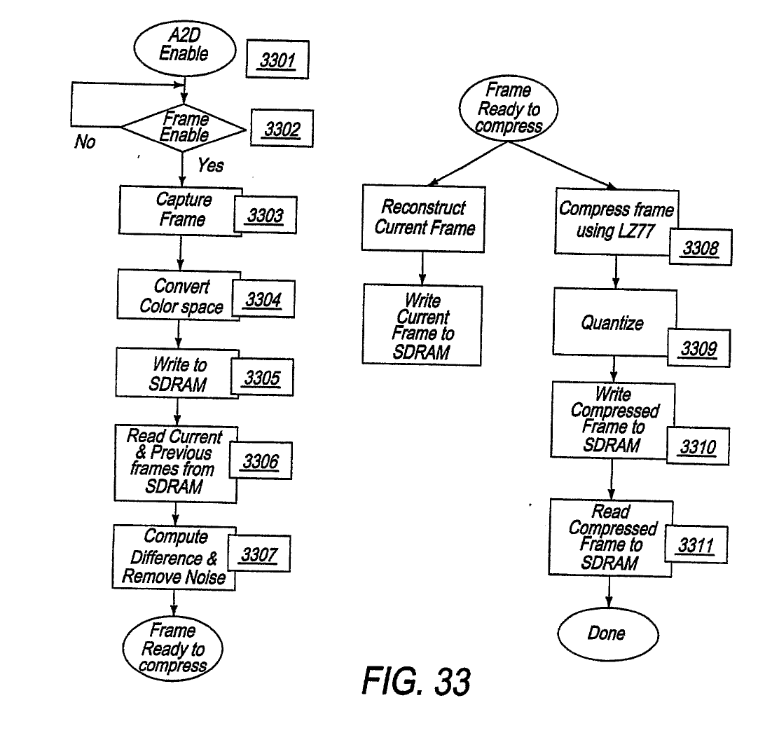

Referring to FIG. 34, a block diagram of one embodiment of the LZQ algorithm is depicted. The LZQ compression algorithm comprises of input video data 3404, key frame difference block 3401 and plurality of compression engine blocks 3402, 3403 where the output of one LZ77 compression engine block is fed to the next compression engine block. The compressed data 3405 is outputted from the nth compression engine block.

Operationally, the key frame difference block receives the video data 3404. The video data is converted into frames using any appropriate techniques known to persons of ordinary skill in the art. The key frame difference block 3401 defines the frequency of a key frame ‘N’. Preferably every 10^{th}, 20^{th}, 30^{th} and so on is taken as the key frame. Once a key frame is defined it is compressed using the LZ77 compression engine 3402, 3403. Generally, compression is based on manipulating information in a time vector and motion vector. Video compression is based on eliminating redundancy in time and/or motion vectors. After compression is done to the first frame, compressed data 3405 is transmitted to the network. At the receiving end or receiver the compressed data is decoded and is made available for rendering.

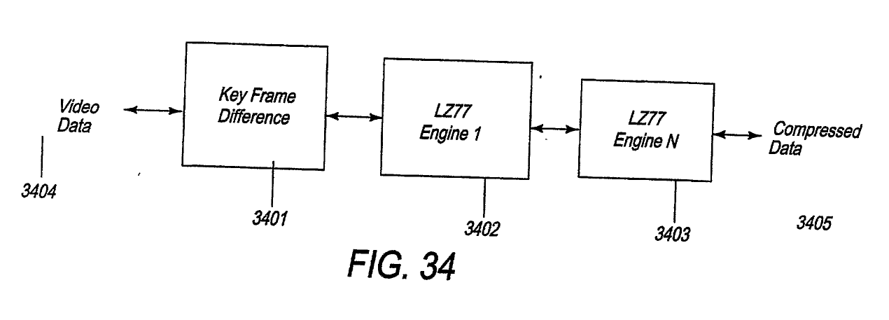

Referring to FIG. 35, a block diagram of the key frame difference encoder of one embodiment of a LZQ algorithm is depicted. The key frame difference encoder 3500 comprises of a delay unit 3501 that delays the frame by a single unit, a multiplexer 3502, a summer 3503, a key frame counter 3504 and an output port 3505. The key frame (fₖ) of the video frame 3506 is directly fed as one of the inputs to the multiplexer 3502 and a preceding frame acts as second input of the multiplexer 3502. The preceding frame is obtained from the video frame 3506 after delaying it using a delay unit 3501. For example, if one of the inputs to the multiplexer 3502 is (fₖ) then the other input is (fₖ−(fₖ₋₁) where fₖ denotes the current key frame that has been already received by the multiplexer 3502 and fₖ₋₁ denotes the preceding frame that has already moved out. The buses carrying the key frame and the delay unit terminates in a summer 3503 where the delayed frame (fₖ₋₁) is subtracted from the key frame (fₖ) resulting in (fₖ−(fₖ₋₁), which is then passed to the multiplexer 3502 as the second input. The first inputs (fₖ) and (fₖ(fₖ₋₁) are fed into the multiplexer under the control of key frame counter 3504. For both the inputs, the multiplexer 3507 provides a single output, which is then transmitted to the LZ77 engine 3507 for compression.

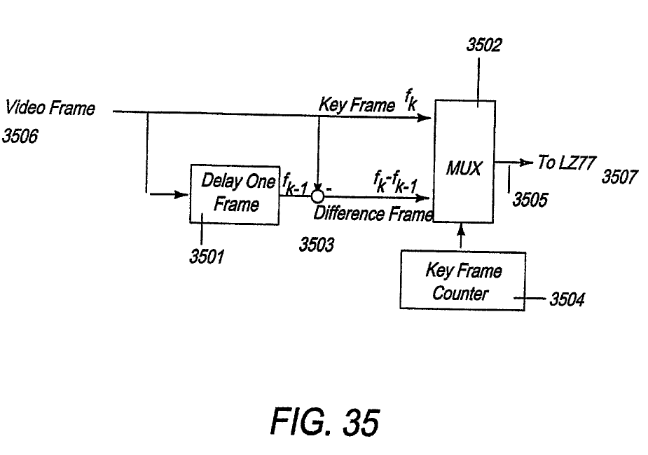

Referring to FIG. 36, a block diagram of the key frame difference decoder block of one embodiment of the present invention is depicted. The key frame difference decoder block 3600 comprises a multiplexer 3601, key frame counter 3602, a delay unit 3603 and a summer 3604. The key frame difference decoder block 3600 receives the data 3606 from the LZ77 compression engine and outputs the decoded frame of video 3605. Operationally, the key frame of the compressed data is fed to the multiplexer 3601 as the first input and the second input is formed by the feedback loop. The feedback loop consists of a delay unit 3603, which takes the decoded frame 3605 and delays it by one frame unit to form a difference frame along with the keyframe 3606 at the summer 3604. The output of the summer 3604 acts as second input to the multiplexer. The first input and second input fed to the multiplexer 3601 under the control of key frame counter 3602 results in the decoded frame.

Another embodiment of the loss-less algorithm is to reduce the amount of computations involved in the compression. This is achieved by sending only those lines that have motion associated with them. In this case, a line from the previous frame is compared against the same line number in the current frame and only the lines that contain at-least one pixel with the different value are coded by using one or more stages of LZ77.

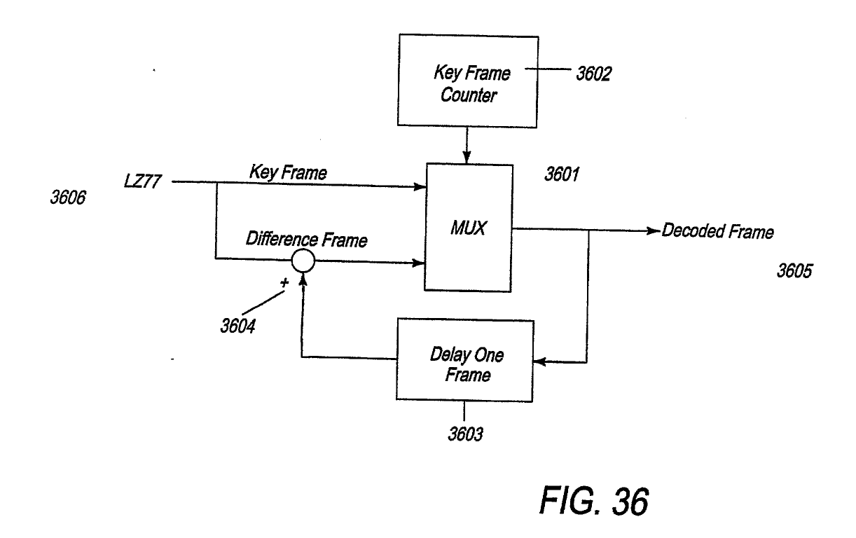

Referring to FIG. 37, a block diagram of a modified LZQ algorithm is depicted. The video data 3701 is fed into the key line difference block 3702. After processing by the key line difference block 3702, it is transferred to the LZ77 compression engine 3703 and the difference data is passed through the contiguous blocks of LZ77 compression engines 3703, 3704, thus outputting compressed data 3705.

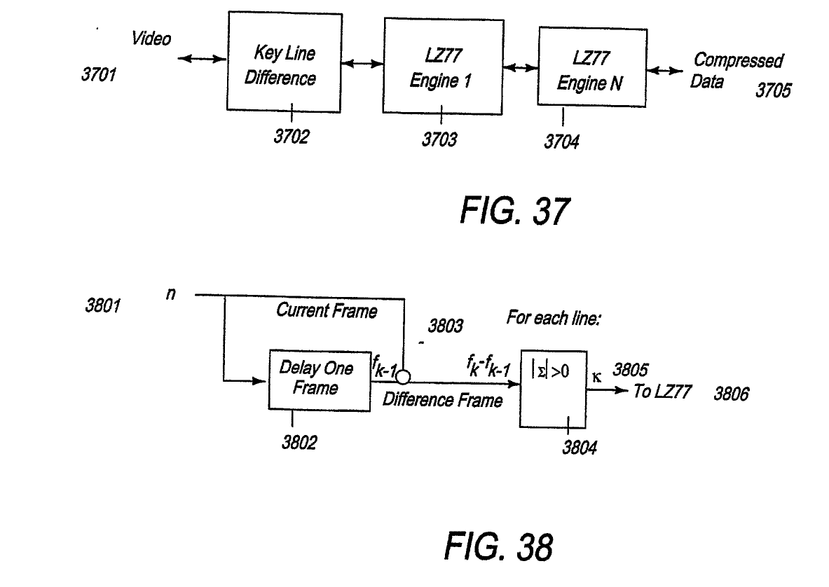

Referring to FIG. 38, a block diagram of the key line difference block used in an exemplary embodiment of the invention is depicted. The key line difference block 3800 comprises of a media input port 3801, delay unit 3802, a summer 3803 and a summation and comparator 3804. The input port 3801 receives the video data captured by the camera or live feed. The current frame of the video data is delayed by a single frame delay unit fₖ₋₁. The delayed frame fₖ₋₁ along with the current frame (fₖ) at the summer 3803 forms the difference frame. The difference frame is then inputted to the summation and comparator block 3804, where the summation of the difference frames is compared, and if it is greater than zero then the Kline 3805 is outputted from the summation and comparator block 3804. The Kline output is then destined to LZ77 contiguous compression engines and is thus compressed.

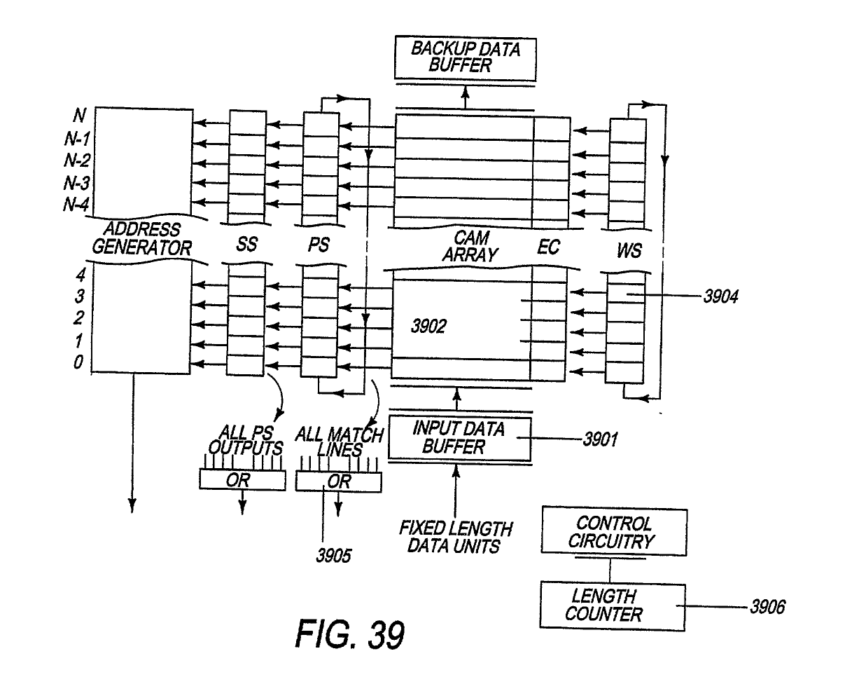

Referring to FIG. 39, compression/decompression architecture used in the present invention is depicted. An implementation of the LZQ algorithm uses content addressable memory (CAM) to compare incoming streams of data with previously received and processed data as stored in the CAM memory and to discard the oldest data once the history becomes full.

The data stored in the input data buffer 3901 is compared with the current entries in the CAM array 3902. The CAM array 3903 includes multiple sections (N+1 sections) with each section including a register and a comparator. Each CAM array register stores a byte of data and includes a single cell for indicating whether a valid or current data byte is stored in the CAM array register. Each comparator generates an active signal when the data bytes stored in the corresponding CAM array register matches the data bytes stored in the input data buffer 3901. Generally, if the matches are found, they are replaced with the codeword, so if multiple occurrences are there same codeword is applied. Higher ratios of compressions are achieved when during the search longer strings are found, which are then accordingly replaced by the codeword resulting in less volume of data.

Coupled to the CAM array is a write select shift register (WSSR) 3904, with one write select block for each section of the CAM array. A single write block is set to a 1 value while the remaining cells are all set to 0 values. The active write select cell, the cell having a 1 value, selects which section of the CAM array will be used to store the data byte currently held in input data buffer 3901. WSSR 3904 is shifted one cell for each new data byte entered into input data buffer 3901. The use of shift register 3904 to select allows the use of fixed addressing within CAM array.

The matching process continues until there is a 0 at the output of the primary selector OR gate, signifying that there are no matches left. When this occurs, the values marking the end points of all the matching strings which existed prior to the last data byte are still stored in secondary selector cells. Address generator then determines the location of one of the matching strings and generates its address. Address generator is readily designed to generate an address using signals from one or more cells of the secondary selector. The length of the matching string is available in length counter.

Address generator generates the fixed address for the CAM array section containing the end of the matching string, while length counter provides the length of the matching string. A start address and length of the matching string is then calculated, coded and output as a compressed or string token.

Evaluations of various size CAM arrays has confirmed that a history size of approximately 512 bytes provides an ideal tradeoff between efficient compression and cost, in terms of such factors as power consumption and silicon area on integrated circuit devices.

Post-Processor

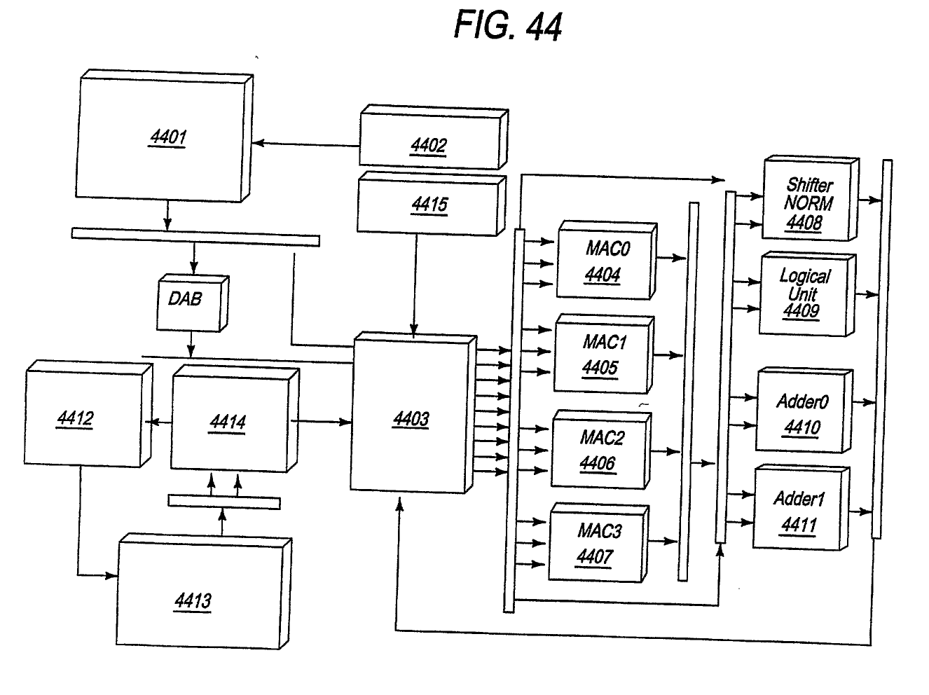

Referring to FIG. 44, a block diagram of the post processor of the present invention is depicted. The post processor 4400 comprises of data memory 4401, which is connected to the address generation unit 4402 and register file 4403. The register file 4403 outputs its data to shifter 4407. Logical unit 4408 and a plurality of multiply and accumulate (MAC) units 4404, 4405, 4406 further transmit data to the adder0 4408 and adder1 4409. The program control 4411, program memory 4412 and instruction dispatch and control 4413 unit are interconnected. The address register 4414 and instruction dispatch and control unit 4413 transfers their output to the register file 4403. The multiply and accumulate unit are 17 bit and can accumulate up to 40 bit.

Once the compressed data has passed through the motion estimation processor, DCT/IDCT processor and post processor, the output from the post processor is subjected to real time error recovery of the image data. Any appropriate techniques including edge matching, selective spatial interpolation and side matching can be used to enhance the quality of the image being rendered.

In one embodiment, a novel error concealment approach is used in the post processing for any block based video codec. It is recognized that data loss is inevitable when data is transmitted on the Internet or over a wireless channel. Errors occur in the I and P frames of a video and result in significant visual annoyance.

For I-frame error concealment, spatial information is used in to conceal errors in a two step process: edge recovery followed by selective spatial interpolation. For P-frame error concealment, spatial and temporal information are used in two methods: linear interpolation and motion vector recovery by side matching.

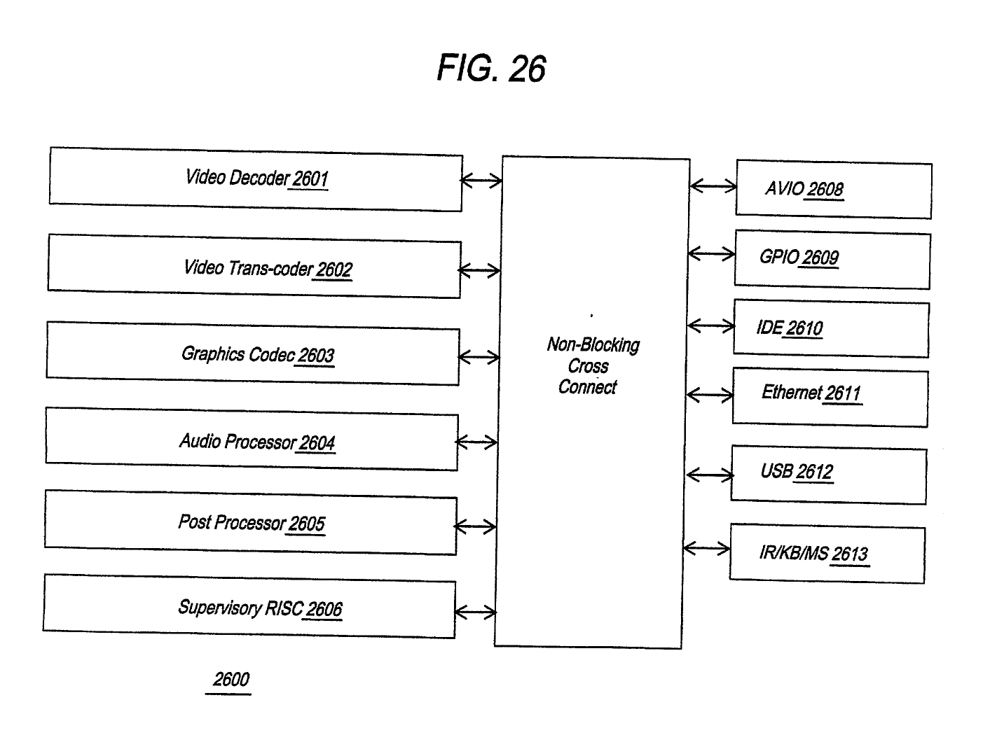

Conventionally, I-frame concealment is performed by interpolating each lost pixel from adjacent Mbits (MB). For example, referring to FIG. 28, pixel P is interpolated from a plurality of pixel values, denoted by pₙ having a distance dₙ between P and pₙ where n is an integer starting from 1. Interpolation of pixel P can be performed using the formula:

P=[p1*(17−d1)+p2*(17−d2)+p3*(17−d3)+p4*(17−d4)]/34

This process yields blurred images if the lost MB contains high frequency components. While fuzzy logic reasoning and projections onto convex sets could help better restore the lost MB, these approaches are computationally expensive for real-time applications.

The present invention uses edge recovery of the lost MB followed by selective spatial interpolation to address I frame error concealment. In one embodiment, multi-directional filtering is used to classify the direction of the lost MB to be one of out 8 choices. Surrounding pixels are converted into a binary pattern. One or more edges are retrieved by connecting transition points within the binary pattern. The lost MB is directionally interpolated along edge directions.

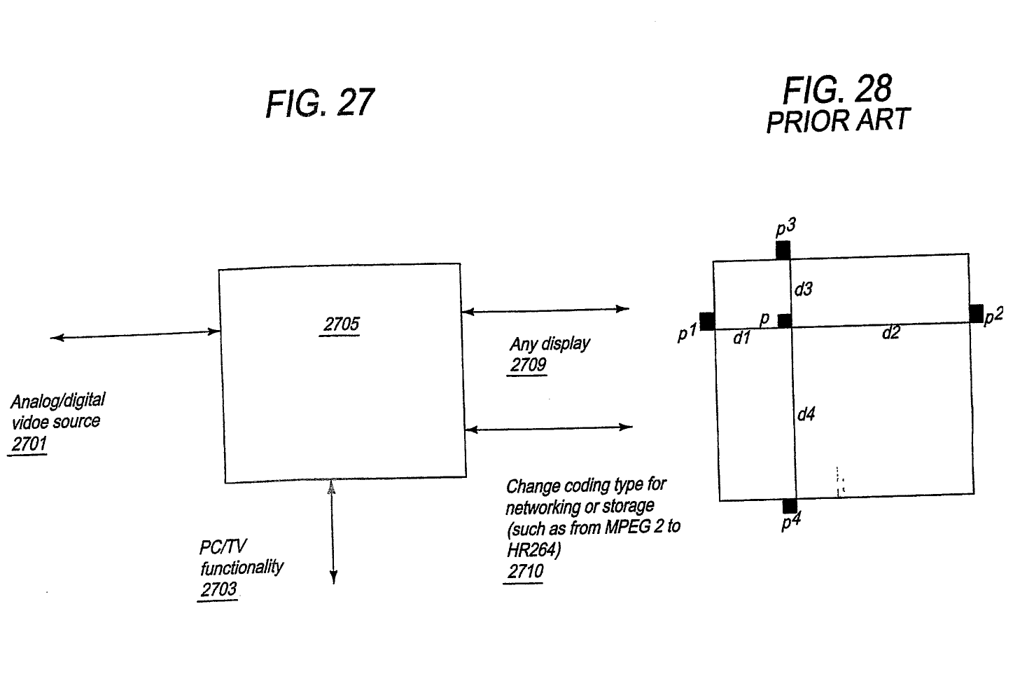

More specifically, referring to FIG. 29a, a corrupted MB 2901 is surrounded by correctly decoded MBs 2905. Detection of those boundary pixels 2905 is performed to identify the edges 2908. Edge points 2910 are identified by calculating local optimum values of gradient above a predefined threshold. Edge points 2910 having a similarity in measurement, in terms of gradient and luminescence, are identified and matched. Referring to FIG. 29b, the matched edge points are then linked together 2911, thereby separating the MB into regions, each of which can be modeled as a smooth area and concealed by selective spatial interpolation.

After edge recovery is performed, referring to FIG. 29c, an isolated edge point 2912 is identified and extended 2909 into the corrupted MB until it reaches a boundary. Pixel 2915 is chosen in one of three regions defined by the edge 2911 and extension 2909. From pixel 2915, boundary pixels are found along each edge direction which, in this case, generates four reference pixels 2918. Two pixels 2918 in the same region as pixel 2915 are identified. The pixels 2918 are used to calculate pixel 2915 using the following formula:

$$p = \frac{\frac{{p}_{1}}{{d}_{1}} + \frac{{p}_{2}}{{d}_{2}}}{\frac{1}{{d}_{1}} + \frac{1}{{d}_{2}}}$$

Where p₁ and p₂ are the two pixels 2918 and d₁ and d₂ are the distances between p₁ and p and p₂ and p, respectively.

With respect to P frame error concealment, motion vector and coding mode recovery is performed by determining the value of the previous frame at the same corrupted MB location and replacing the corrupted MB value with the previous frame value. Motion vectors from the area around the corrupted MB are determined and the average is taken. Replace the corrupted MB value with the median motion vector from the area around the corrupted MB. Using boundary matching, the motion vector is re-estimated. Preferably, the corrupted MB is further divided into small regions and the motion vector for each region is determined. For example, in one embodiment the values of upper, lower, right and left pixels, pᵤ, pₗ, pᵣ, and pₗₜ respectively, relative to the corrupted pixel, P, are used to linearly interpolate P:

$$P = \frac{1}{34} \{ ( 17 - y ) {p}_{upper} + {yp}_{lower} + ( 17 - x ) {p}_{left} + {xp}_{right} \}$$

$$1 \leq x , y \leq 16$$

Side matching can also be used to perform motion vector recovery. In one embodiment, the value of the previous frame at the same corrupted MB location is determined. The corrupted MB value is replaced with that previous frame value. Candidate sides that surround the corrupt MB location are determined and the square error from the candidate sides are calculated. The minimum value of the square error indicates a best match. One of ordinary skill in the art would appreciate the computational techniques, formulae and approaches required to do the aforementioned I frame error concealment and P frame error concealment steps.

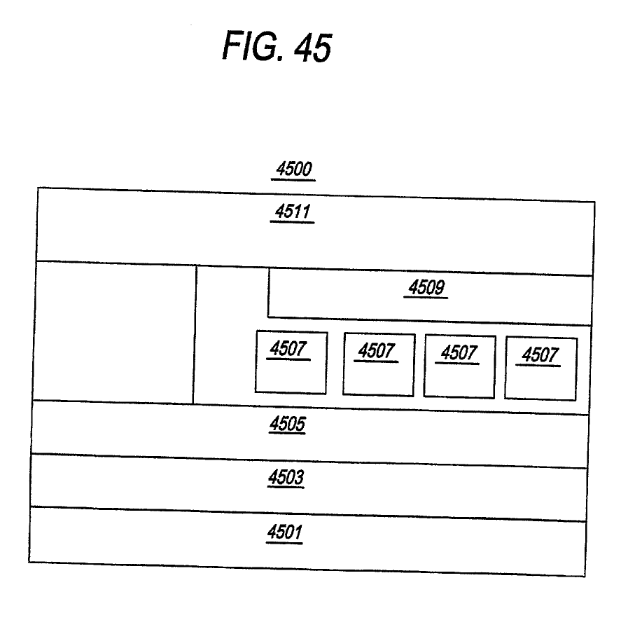

The present invention further comprises a scalable and modular software architecture for media applications. Referring to FIG. 45, the software stack 4500 comprises a hardware platform 4501, real-time operating system and board support package 4503, real-time operating system abstraction layer 4505, a plurality of interfaces 4057, multi-media libraries 4509, and multi-media applications 4511.

The software system of the present invention preferably provides for the dynamic swapping of software components at run time, non-service affecting remote software upgrades, remote debug and development, sleep unused resources for low power consumption, full programmability, software compatibility at the API level for chip upgrades, and an advanced integrated development environment. The software real-time operating system preferably provides for hardware independent APIs, performs resource allocation on call initiation, performs on-chip and external memory management, collects system performance parameters and statistics, and minimizes program fetch requests. The hardware real-time operating system preferably provides for the arbitration of all program and data fetch requests, full programmability, the routing of channels to different PUs according to its data flow, the simultaneous external and local transfer to memory, the ability to program DMA channels, and context switching.

The system of the present invention also provides for an integrated development environment having the following features: a graphical user interface with point and click controls to access hardware debugging options, assembly code development for media adapted processors using single debugging environment, an integrated compiler and optimizer suite for media adapted processor DSP, compiler options and optimizer switches for selecting different assembly optimization levels, assemblers/linkage/loaders for media adapted processors, profiling support on simulator hardware, channel tracing capability for single frame processing through media adapted processor, assembly code debugging within Microsoft Visual C++ 6.0 environment, and C callable assembly support and parameter passing options.

It should be appreciated that the present invention has been described with respect to specific embodiments, but is not limited thereto. In particular, the present invention is directed toward integrated chip architectures having scalable modular processing layers capable of processing multiple standard coded video, audio, and graphics data, and devices that use such architectures.

1. A media processor for the processing of media based upon instructions, comprising:
a plurality of processing layers wherein each processing layer has at least one processing unit, at least one program memory, and at least one data memory, each of said processing unit, program memory, and data memory being in communication with one another;
at least one processing unit in at least one of said processing layers designed to perform motion estimation functions on received data;
at least one processing unit in at least one of said processing layers designed to perform to perform encoding or decoding functions on received data; and
a task scheduler capable of receiving a plurality of tasks from a source and distributing said tasks to the processing layers.

2. The media processor of claim 1 further comprising a direct memory access controller capable of handling data transfers, each of said transfers having a size and a direction, from at least one data memory having an address and a plurality of external memory units, each having an address.

3. The media processor of claim 2 wherein said transfers between at least one data memory and at least one external memory occur by utilizing the address of the data memory, the address of the external memory, the size of the transfer, and the direction of the transfer.

4. The media processor of claim 1 wherein the task scheduler is in communication with an external memory.

5. The media processor of claim 1 further comprising an interface for the receipt and transmission of data and control signals.

6. The media processor of claim 5 wherein the interface comprises an Ethernet compatible interface.

7. The media processor of claim 5 wherein the interface comprises a TCP/IP compatible interface.

8. The media processor of claim 1 wherein at least one processing layer includes a processing unit designed to perform motion estimation functions on received data and a processing unit designed to perform encoding or decoding functions on received data and wherein said motion estimation and encoding or decoding functions are performed in a pipelined manner.
